(19) United States
(12) Patent Application Publication
(10) Pub. No.: US 2025/0154019 A1
(43) Pub. Date: May 15, 2025

(54) MIXED HALIDE PEROVSKITE, MEGALIBRARIES, HETEROSTRUCTURES AND SOLID SOLUTIONS AND METHODS OF FORMING THE SAME

(71) Applicant: NORTHWESTERN UNIVERSITY, Evanston, IL (US)

(72) Inventors: Chad A. Mirkin, Wilmette, IL (US); Doonghoon Shin, Evanston, IL (US); Minliang Lai, Evanston, IL (US)

(21) Appl. No.: 18/840,806

(22) PCT Filed: Feb. 23, 2023
(86) PCT No.: PCT/US2023/013678

§ 371 Date: Aug. 22, 2024

Related U.S. Application Data
(60) Provisional application No. 63/313,148, filed on Feb. 23, 2022.

(51) Int. Cl. C01G 21/16; B82Y 40/00; C01G 17/04; C01G 19/04

(52) U.S. Cl. CPC C01G 21/16; B82Y 40/00; C01G 17/04; C01G 19/04; C01P 2002/34; C01P 2002/60

(57) ABSTRACT

A method of forming a combinatorial mixed halide perovskite library can include depositing an array of halide perovskite particles on a substrate. The method further includes exposing the array of halide perovskites to a laser to from defects in each of or a selected portion of the halide perovskite particles. The exposure conditions are modified across the array to generate a variation of defect concentration in the halide perovskite particles in the array. The defect containing halide perovskites are then exposed to an ion exchange solution and either anion exchanged or cation exchanged to thereby form a mixed halide perovskite particle.

### CROSS-REFERENCE TO RELATED APPLICATIONS

The benefit of priority to U.S. Provisional Patent Application No. 63/313,148 filed Feb. 23, 2022, and U.S. Provisional Patent Application No. 63/333,383 filed Apr. 21, 2022, is hereby claimed and the disclosure are each incorporated herein by reference in their entireties.

### FIELD

The disclosure relates to mixed halide perovskite heterostructures having a lateral morphology, solid-solutions of mixed halide perovskites and methods of making the same.

### BACKGROUND

Mixed halide perovskites consisting of multiple ions that prefer the same lattice site (ABX₃) are an emerging class of semiconductors. Unlike conventional semiconductors, halide perovskite properties can be easily tuned by incorporating different ions within their flexible lattices, and consequently, the design space is particularly rich. Incorporation of multiple ions in the mixed halide perovskites serves as a facile means to tail the bandgap of the perovskite and improve device-relevant properties such as emission and absorption efficiency, exciton binding energy, and carrier lifetime. Designing structures of interest with conventional means is difficult given the soft-lattice and facile ion diffusion that typify halide perovskites.

Metal halide perovskites have excellent optical and optoelectronic properties suitable for next-generation semiconductor device applications¹⁻⁶. The unusual soft ionic lattices of these materials can accommodate multiple ions in the same ABX₃ lattice sites (for example, A=Rb⁺, Cs⁺, CH₃NH₃⁺ (MA), and HC(NH₂)₂⁺ (FA); B=Pb²⁺, Sn²⁺, and Ge²⁺; X=Cl⁻, Br⁻, and I⁻). Therefore, one can mix multiple ions that favor the same site to tune the band structures, crystal phases, or chemical stabilities of these materials. These so-called mixed halide perovskites (MHPs) have enabled improvements to the performance and stability of traditional solar cell devices and light emitting diodes composed of methylammonium lead iodide (MAPbI₃). Given the vast number of combinations of ABX₃ component ions, stoichiometries, and crystal sizes, undiscovered MHPs surely exist, many of which could offer enhanced performance metrics. However, thoroughly studying such a large materials space is untenable with current synthesis and screening methods.

Recent research has shown that optoelectronic performance and stability can be improved by incorporating multiple cations in the A-site of the perovskite chemical formula ABX₃. Indeed, the mixing of formamidinium (FA; CH₂(NH₂)₂) with another cation, such as methylammonium (MA; CH₃NH₃), Cs, or Rb, is an effective way of achieving this tuning.

Among these cation pairs, simulations and experiments have shown that mixed Cs-FA perovskites possess particularly desirable optoelectronic properties that are borne out of final device performance when coupled with certain halide anions. However, the ion distributions in these complex mixed compositions are often not well-defined. For example, separated phases appear uncontrollably from solid-solutions either under an external stimulus or even under ambient conditions. Thus, the ability to predict whether a given composition will result in the presence of separated phases or a solid-solution, and under what external stimuli these phases are stable is critical to delivering on their promise for any practical optoelectronic device.

Understanding how phase morphology is impacted as a function of device operation is also important because although suppression of phase-segregation may be desired under certain circumstances, this is not always the case. In general, they have been obtained by several synthetic strategies, including the ion-exchange method, epitaxial growth, and spontaneous phase separation. However, many of the reported heterostructures eventually suffer from ion mixing due to spontaneous ion diffusion, as well as the lack of stability to external stimuli that promote diffusion (such as heat, light, or electrical field). Indeed, thermodynamically stable ion-separated heterostructures that can suppress such undesired ion diffusion have yet to be synthesized. In addition to the aforementioned synthesis strategies, targeting structures with an ion size mismatch that results in an immiscible gap can be an effective way of generating thermodynamically spontaneous ion-separation, thus yielding robust heterostructures.

Cs_{0.5}FA_{0.5}PbX₃ (X=halide anion) represents compositions with an ion-sized mismatch that leads to immiscibility between Cs and FA in the perovskite structure. However, these structures often exhibit an inconsistent degree of ionic segregation at this mixing ratio. This segregation significantly impacts the stabilities of the corresponding materials and the optoelectronic performance of devices formed from them to overcome the kinetic barrier to mixing. The proposed cation-segregation described in previous reports as a function of material composition may provide mechanistic insight into that factors that control ion segregation and, therefore, lead to a way of deliberately controlling the segregation process thereby yielding paths to heterostructures or solid-solutions (i.e., a structure where phase segregation is suppressed).

Several strategies towards the high-throughput synthesis and screening of MHP compositions have been attempted at the macroscale, including multi-channel inkjet printing, iterative manual¹¹ or robotics-assisted synthesis, and automotive flow synthesis, but the range of compositions and sizes that can be synthesized remains limited. Furthermore, these methods rely on the characterization of inhomogeneous thin films or assembled nanoparticle systems and cannot be used to identify the size, composition, and/or structure of the specific particles with the particular desired properties. Indeed, several challenges to high-throughput combinatorial synthesis persist, and strategies are needed for the: (i) rapid synthesis of diverse MHP compositions and structures; and (ii) large-scale spatial-encoding of single MHP particles with a high packing-density (>1/μm²).

### SUMMARY

Polymer pen lithography (PPL) and ion exchange are promising methods that can be integrated to attain position-encoded compositional gradients of MHPs. PPL, a cantilever-free scanning probe lithography technique, can be used to parallelize the delivery of molecular and material ink precursors to substrates. For instance, this method has been used to facilitate the high-throughput and large-scale synthesis of site-isolated perovskite particles of various sizes, allowing large-scale spatial encoding and subsequent screening¹⁵. However, in an individual experiment, perovskite particles of only a single composition have been prepared, and the high spatial encoding of diverse, mixed composition perovskite particles in a single experiment has not yet been realized. In addition, ion exchange enables the precise modification of specific MHP compositions on demand. In particular, the degree of anion exchange is determined by the interplay between crystal defect concentration and size, and these two parameters provide a path to access a wide compositional landscape within PPL-based particle libraries. However, anion exchange has not yet been used to tune defect concentration and crystal size combinatorically to obtain libraries of compositions without the preparation of iterative batches.

A significant bottleneck in the discovery of new mixed halide perovskite (MHP) compositions and structures is the time-consuming and low-throughput nature of current synthesis and screening methods. In accordance with the disclosure, high-throughput strategy is presented that can be used to synthesize combinatorial libraries of MHPs with deliberate control over the halide mixing ratio and particle size (for example, CsPb(Br₁₋ₓClₓ)₃ (0<x<1) with sizes between ˜100-400 nm). This strategy combines evaporation-crystallization polymer pen lithography (EC-PPL) and defect-engineered anion exchange to spatially encode particle size and composition, respectively. Laser exposure is used to selectively modify the defect concentration of individual particles, and thus the degree of subsequent anion exchange, allowing the preparation for ultra-high-density arrays of distinct compositions (>1 unique particle/μm²). This method was utilized to rapidly generate a library of ˜4000 CsPb(Br₁₋ₓClₓ)₃ particles that was then screened for high-efficiency blue photoemission, which yielded CsPb(Br_{0.6}Cl_{0.4})₃ as the most efficient composition. The combinatorial synthesis and screening strategy provided here, and the mechanistic understanding of the defect-engineering process gleaned from it, will enable the rapid discovery of exceptional MHP optoelectronic materials.

A method of forming a combinatorial mixed halide perovskite library can include depositing an array of halide perovskite particles on a substrate, wherein each halide perovskite particle is a compound of formula ABX¹₃, wherein A is a cation, B is a metal, and X¹ is a first halogen; exposing the array of halide perovskite particles to a laser to form defects in at least a portion of the halide perovskite particles, wherein an exposure condition is modified across the array to generate a variation of defect concentration in the halide perovskite particles in the array; and exposing the array of halide perovskite particles having the defect concentration to an ion exchange solution comprising at least one halogen X² to thereby exchange a portion of X¹ with X² and form mixed halide perovskite particles, each mixed halide perovskite particle being a compound of formula AB(X¹₍₁₋ₙ₎X²ₙ)₃, wherein 0<n<1), and X² is a second halogen different from X¹.

A method of forming a combinatorial mixed halide perovskite library in accordance with the disclosure can include depositing an array of halide perovskite particles on a substrate, wherein each halide perovskite particle is a compound of formula A¹BX₃, wherein A¹ is a first cation, B is a metal, and X is a halogen; exposing the array of halide perovskite particles to a confocal laser to form defects in at least a portion of the halide perovskite particles, wherein an exposure condition is modified across the array to generate a variation of defect concentration in the halide perovskite particles in the array; and exposing the array of halide perovskite particles having the defect concentration to an ion exchange solution comprising at least cation A² to thereby exchange a portion of A¹ with A² and form mixed halide perovskite particles, each mixed halide perovskite particle being a compound of formula (A¹₍₁₋ₙ₎A²ₙ)BX₃, wherein 0<n<1), and A² is a second cation different from A¹.

Phase-uniformity in a solid-solution is desirable in the context of perovskite solar cells and light-emitting diodes, where suppression of photo-induced or electrical bias-induced segregation is key to long-term stability. In contrast, purposefully inducing demixing of ions to form multi-phasic crystals has attracted significant research study, and perovskite heterostructures in particular have shown potential as a means to engineer charge carrier concentration and dynamics and form multi-junction optoelectronic devices. Practically, heterostructure perovskites have been obtained using epitaxial growth, ion exchange and phase separation, but similar to the solid-solution context, reliable control over the degree of ion mixing is challenging due to either spontaneous ion diffusion or ion diffusion under external stimuli such as heat, light, or an electric field.

Cs_{0.5}FA_{0.5}PbX₃ perovskite crystals with crystal sizes ranging from tens of microns to tens of nanometers were synthesized by bulk solution growth and evaporation-crystallization polymer pen lithography (EC-PPL) methods to study heterostructure formation. Cs-FA cation segregation and mixing in lead halide perovskite were systematically investigated as a function of crystal composition, crystal size, and temperature. It was found that as crystal size was decreased (to approximately 60 nm), the fractions became well-mixed and a transition to solid-solution was observed. Without intending to be bound by theory, it is believed that as crystal size decreases, a structural transition from heterostructure to solid-solution could be facilitated by increasing temperature, which promotes the formation of entropically-favored mixed phases. Further, it was observed that photo-induced halide segregation, a key factor in Br/I perovskite instability was significantly suppressed in Cs_{0.5}FA_{0.5}Pb(Br_{1-y}/I_{y})₃ solid-solutions in approximately 60 nm edge length crystals.

A mixed halide perovskite crystal having a lateral heterostructure and being of formula I:

A′₁₋ₓ A″ₓBX₃,
wherein
A′ is a first cation,
A″ is a second cation, wherein A′ and A″ are different cations,
B is a metal,
X is at least one halogen,
0<x<1, and
the lateral heterostructure comprises an A′ rich phase in a central region of the crystal, surrounded partially by an A″ rich phase.

A solid-solution mixed halide perovskite having the formula A′₁₋ₓA″ₓBX₃,
wherein

A′₁₋ₓA″ₓBX₃,
wherein
A′ is a first cation
A″ is a second cation, wherein A′ and A″ are different cations,
B is a metal
X is at least one halogen,
0<x<1, and wherein the crystal size is less than 60 nm.

A method of forming mixed halide perovskite crystals having a lateral heterostructure in accordance with the disclosure can include dissolving at least one first perovskite precursor having the formula A′X′, at least one second perovskite precursor having the formula A″X″ and at least one third perovskite precursor having the formula BX′₂, and at least one fourth perovskite precursor having the formula BX″₂ in a solvent to form a precursor solution, wherein A′ and A″ are each cations and are different cations, B is a metal, and X and X′ are each a halogen and can each be the same or different; depositing the precursor solution onto a substrate; and evaporating the solvent, wherein the halide perovskite crystals form upon evaporation of the solvent, wherein the crystals form as two stages, the first stage being a A′-X′-rich perovskite phase and the second stage being a A″-X″-rich perovskite phase partially surrounding the A′-X′-rich perovskite phase to thereby form the mixed halide perovskite having a lateral heterostructure and being of formula I

A′₁₋ₓA″ₓBX₃,
wherein A′ is a first cation, A″ is a second cation, wherein A′ and A″ are different cations, B is a metal, X is at least one halogen, and 0<x<1.

A method of forming mixed halide perovskite crystal array having a plurality of halide perovskite crystals arranged in a pattern in accordance with the disclosure can include coating an array of pens with a precursor solution comprising at least one first perovskite precursor having the formula A′X′, at least one second perovskite precursor having the formula A″X″, at least one third perovskite precursor having the formula BX′₂ dissolved in a solvent, and at least one fourth perovskite precursor having the formula BX″₂ wherein A′ and A″ are each cations and are different cations, B is a metal, and X and X′ are each a halogen and can each be the same or different; contacting a substrate with the coated pen array to thereby deposit the precursor solution as a pattern of printed indicia on the substrate, wherein: the printed indicia form nanoreactors on the substrate and a mixed halide perovskite crystal nucleates and grows within each nanoreactor in two stages, the first stage being a A′-X′-rich perovskite phase and the second stage being a A″-X″-rich perovskite phase partially surrounding the A′-X′-rich perovskite phase to thereby form the mixed halide perovskite having a lateral heterostructure and being of formula I

A′₁₋ₓA″ₓBX₃,
wherein: A′ is a first cation A″ is a second cation, wherein A′ and A″ are different cations, B is a metal, X is at least one halogen defined by selection of X′, X″, and X′″, and 0<x<1.

### BRIEF DESCRIPTION OF THE DRAWINGS

While color is not shown in the drawings, the observed color of photoemissions and changes thereof are described throughout the description of the drawings and the detailed description.

FIG. 1. Combinatorial synthesis of MHPs libraries. a, Design and operating principle of a combinatorial MHP library prepared via selective laser exposure and rational ion exchange, enabling the synthesis of a size and composition gradient. Varying confocal laser exposure generates a unique defect concentration in each particle, which is correlated with the degree of anion exchange. b, The selectively laser-exposed particles show a significantly decreased PL intensity (middle). c, The PL spectrum of a CsPbBr₃ particle before and after laser exposure. d, Typical PL lifetime decay curves of unexposed (τ˜1.3 ns) and laser exposed (τ˜0.1 ns) particles. e, Confocal PL and SEM imaging of a CsPb(Br₁₋ₓClₓ)₃ combinatorial array. Blue and green channels represent PL emission from 420 to 485 nm and from 485 nm to 550 nm, respectively. f, Representative PL spectra of individual particles of two sizes under exposure conditions (notated as particle 1-4) in the CsPb(Br₁₋ₓClₓ)₃ array. Particle 1: ˜400 nm, unexposed; Particle 2: ˜300 nm, unexposed; Particle 3: ˜400 nm, laser exposed; Particle 4: ˜300 nm, laser exposed (sizes determined via SEM).

FIG. 2. Laser-induced vacancy formation mechanism and its correlation to anion exchange kinetics. a, PL peak position as a function of 473-nm laser delivered energy (notated as power×exposure time) after 1-h anion exchange at 35° C. b, A proposed semiquantitative correlation between laser exposure parameters and V_{X}⁺ concentration, based on the vacancy-assisted diffusion model. V_{X}⁺ concentration is more dependence upon laser power than exposure time. c, The proposed mechanism for a slight increase in V_{X}⁺ concentration under sub-bandgap laser irradiation (hv<E_{g}). Raman-enhanced fluctuations in lattice displacement promote a marginal increase in vacancy concentration (X_{X}→V_{X}⁺+Xᵢ⁻). d, The proposed mechanism for a significant increase in V_{X}⁺ concentration under super-bandgap laser irradiation (hv>E_{g}). The photocarriers produced after laser exposure interact strongly with lattice phonons to promote and stabilize a high V_{X}⁺ concentration lattice (X_{X}+h⁺→V_{X}⁺+Xᵢ⁰). e, Size-dependent changes in PL peak position during exchange (and corresponding Cl/(Br+Cl) concentration) at 35° C. f, Time-dependent evolution of PL peak positions for particles ˜300 nm and ˜400 nm in size either with or without laser exposure

FIG. 3. High-resolution position encoding of mixed anion compositions. a, Confocal PL mapping of a triangle shape immediately after patterning by selective laser exposure. b-d, Confocal PL mapping of the same array after anion exchange. The particles in the triangle pattern are rendered Cl-rich and display blue photoemission. e-f, Confocal PL maps of an inset square and line shapes demonstrating the ability to pattern arbitrary features. g, PL image of a bulk CsPbBr₃ microplate after confocal laser exposure shows the diffusion of defects (or photocarriers that induce defects) beyond the primary exposed region (defect areas >2 μm). h, The corresponding blue PL image after anion exchange. The Cl-rich composition has feature size of >2 μm. i-j, CsPb(Br₁₋ₓClₓ)₃ arrays with 3-μm and 2-μm spacing between different compositions, respectively. k, Demonstration of submicron patterning of distinct compositions using selective laser exposure of individual nanoparticles. I, The corresponding SEM image from panel k. m, Anion exchange with I⁻ rather than Cl⁻ enables access to an I-rich “line” pattern, red in the confocal PL map. The scale bars in a-j, and m are 5 μm. The scale bar in k-l is 1 μm. Blue, green and red channels represent PL emission from 420 to 480 nm, from 480 nm to 550 nm and from 600 nm to 700 nm, respectively.

FIG. 4. High-throughput optical screening of CsPb(BrₓC₁₋ₓ)₃ arrays. a, Confocal PL mapping of 16 individual CsPb(Br₁₋ₓClₓ)₃ arrays, each contributing to a global compositional gradient. b, PL intensity as a function of wavelength from different particles with unique PL emission peaks. The particles in the array with the same composition can be used to provide statistical significance, and the error bars represent 95% confidence intervals. c, A higher resolution composition screen was obtained by measuring the PL spectra of a row of CsPbBr₃ particles centered around the composition obtained from b. The inset is the corresponding confocal PL image. The composition CsPb(Br_{0.6}Cl_{0.4})₃ with a PL peak at ˜470 nm shows the highest PL efficiency within the blue color wavelength range. d, A series of thin films with varying composition imaged with confocal PL. The compositions are: CsPb(BrₓCl₁₋ₓ)₃ (x=0.4, 0.5, 0.6, 0.75). The colors are coded with the peak wavelength. The CsPb(Br_{0.6}Cl_{0.4})₃ thin film shows the strongest PL intensity (PL spectra in FIG. 21). The scale bars are 100 μm in a and d. The scale bar in c is 5 μm.

FIG. 5. An array of as-patterned CsPbBr₃ particles with a position-encoded size gradient by EC-PPL. a, SEM image of a size gradient obtained by varying the extension length from 8 μm to 0 μm (row-wise). The average size varies from ˜400 to ˜100 nm, respectively. b, The corresponding confocal PL image (green channel, 485 to 550 nm).

FIG. 6. The relationship between x in CsPb(Br₁₋ₓClₓ)₃ and PL peak energy. The PL peak measured by confocal scanning microscopy of CsPb(Br₁₋ₓClₓ)₃ increases parabolically with x, which is consistent with previous reports.

FIG. 7. Structural characterization reveals the effect of laser exposure on the CsPbBr₃ nanoparticles. a-b, SEM images of individual patterned CsPbBr₃ before and after confocal laser exposure (25 mW×10 s). The crystal's size and shape were maintained, but the surface becomes less smooth, revealing the likely formation of defects. c, SEM images of unexposed and laser-exposed areas in a bulk CsPbBr₃ microplate. The defect area (>2 μm) is larger than the laser spot-size (<1 μm), likely due to the diffusion of laser-induced defects. d, EDS spectrum of unexposed and defect areas in c.

FIG. 8. Temperature-dependence of the ΔCl/(Br+Cl) ratio after 1 h of exchange at each temperature. Inset: Fitting the data with an Arrhenius equation (ΔCl/(Br+Cl)=Ae−Eₐ/kT) results in an activation energy (Eₐ) of ˜0.22 eV and ˜0.14 eV for unexposed and laser-exposed particles, respectively. ΔCl/(Br+Cl) is the Cl composition change from CsPbBr₃ after 1 h of exchange at each temperature.

FIG. 9. Arrays of CsPbBr₃ particles with uniform size showing the consistency of the EC-PPL approach. a, Typical SEM image of 4×4 CsPbBr₃ arrays. b, Size distribution of the 4×4 CsPbBr₃ arrays (396 nm±25 nm) in a. The error represents the standard deviation. c, Confocal image of a 4×4 CsPbBr₃ array, showing uniform PL emission. The scale bars are 5 μm.

FIG. 10. Resultant PL spectra after laser irradiation with a constant exposure energy (power×time) in CsPbBr₃ arrays. a, PL spectra vary from 0.25 mW×200 s to 25 mW×2 s, for a constant of 50 mJ). b, PL peak position as a function of laser power with exposure time decreasing to maintain a constant total energy.

FIG. 11. Effect of heat treatment on anion exchange kinetics. a, Confocal PL image of a line pattern after anion exchange. b, An array after anion exchange when not exposed to the laser is exposed to global heat treatment of 200° C. for 20 min. c, Only a background signal is observed in the blue channel, ruling out laser-induced heating as the sole mechanism for defect formation and subsequent accelerated exchange. All reactions were performed with Cl⁻ anion exchange for 0.5 h at 35° C. The scale bars are 5 μm.

FIG. 12. Effect of CsPbBr₃ exposure from different laser wavelengths. a, The PL spectrum under 532-nm laser excitation (˜20 mW×200 s, CW). The top row in the inset image shows decreased PL intensity after 532-nm laser exposure (˜20 mW×200 s). b, The PL spectrum under 633 nm laser excitation (20 mW×200 s). The absence of bandgap PL emission confirms that electrons/holes are not involved in the process.

FIG. 13. PL peak positions after anion exchange depending on laser exposure with different laser wavelengths or laser powers. a, Final PL peak position after exposure from different laser wavelengths and anion exchange. Anion exchange reactions were all carried out for 1 h at 35° C. E_{g} is the bandgap of CsPbBr₃. Laser exposure conditions for 532 nm, 633 nm and 785 nm excitation are set to approximately 20 mW×200 s. The PL peak positions are in much higher wavelengths than the 473-nm laser exposure results in FIG. 2a. It suggests the laser-induced vacancies enabled by 532-nm and 633-nm lasers has much lower concentration than by 473 nm. b, PL peak positions after laser exposure from a 633-nm laser at different powers. The error bars in a and b represent the full-width at half maximum (FWHM) of the PL peaks. The blue-to-red shaded areas indicated the level of laser-induced vacancy concentration: low to high from blue to red.

FIG. 14. Raman spectra under different laser wavelengths and power exposures. a, The Raman spectrum of CsPbBr₃ particles under 785-nm laser excitation. The Raman peak can be indexed to the second phonon mode of the Pb—Br octahedron². b, The Raman spectrum of CsPbBr₃ particles under 633-nm and 785-nm laser illumination at the same power. The intensity obtained when the 633-nm laser was used was more than 100 times stronger. c, The power-dependent Raman spectrum of CsPbBr₃ particles under 633-nm laser excitation. d, The PL peak position as a function of 633-nm laser exposure after 1 h of anion exchange at 35° C. The Raman spectra under 532-nm excitation is saturated probably due to the luminescence background.

FIG. 15. Anion composition as a function of crystal size and exchange time. The dependence of the composition x=Cl/(Br+Cl) on exchange time (a) and the crystal size (b) and for the CsPb(Br₁₋ₓClₓ)₃ array.

FIG. 16. PL spectrum evolution toward achieving combinatorial CsPb(Br₁₋ₓClₓ)₃ libraries. a, Two-channel confocal images after anion exchange at 35° C. for 1 h. b, The corresponding SEM image of particle 1-4 after completing 2 h of Cl⁻ anion exchange. c-f, The normalized PL spectrum evolution of particles 1-4 at 0.5 h, 1 h, and 2 h.

FIG. 17. Halide compositional evolution in the combinatorial CsPb(Br₁₋ₓClₓ)₃ array during anion exchange. a-c, The position-encoded composition maps patterned by selective laser exposure result in varying anion compositions after anion exchange for 0.5 h, 1 h, and 2 h. The color bar represents the Br/(Br+Cl) (1-x). d, The size distribution of the array characterized by SEM.

FIG. 18. The laser-induced vacancy diffusion in a single-crystal CsPbBr₃ microcrystal and patterned CsPbBr₃ arrays. a, The bright-field optical image and corresponding PL image after laser exposure on the ends of a microcrystal. The laser-induced vacancy significantly diffused approximately 3 μm along the crystal. b, The PL image of a 2-μm CsPbBr₃ array after the edge row was exposed. Diffusion of laser-induced vacancies were observed because photocarriers are not able to diffuse across free space.

FIG. 19. The spectra of three patterned particles with submicron composition resolution. The different PL spectra represent distinct compositions. The scale bar is 1 μm.

FIG. 20. Patterning a mega library based on a global gradient of CsPb(Br₁₋ₓClₓ)₃ composition. a, Fast and large area laser irradiation is possible by scanning confocal microscopy (Leica SP8). Here, each 17×17 CsPbBr₃ array was individually treated with a distinct set of laser exposure conditions. b, Two-channel confocal image of the 4×4 group of arrays, each consisting of 17×17 CsPb(Br₁₋ₓClₓ)₃ particles after Cl⁻ anion exchange. c, The intensity line profile from the blue and green emission signal along the diagonal direction. The scale bar is 100 μm. The blue and green channels represent PL emission from 420 to 480 nm and from 480 nm to 550 nm, respectively.

FIG. 21. Optical characterization of the spin-coated CsPb(BrₓC₁₋ₓ)₃ thin films. a, Confocal PL images of each of the 4 CsPb(BrₓC₁₋ₓ)₃ thin films (x=0.4, 0.5, 0.6, and 0.75) under the same laser scanning conditions (using the same laser power, scan time, and scan speed). b, The corresponding PL spectra show that the thin film of CsPbBr_{0.6}Cl_{0.4} composition has the strongest PL intensity.

FIG. 22: Ion segregation in mixed Cs-FA lead bromides and chlorides. a, Photoluminescence (PL) emission spectra taken from two different positions on a heterostructure perovskite crystal (laser excitation: 405 nm). The PL peaks from the center and edge are centered at 535 and 538-nm, respectively. Inset: an optical image of the crystal. Scale bar: 5 μm. b, Scanning electron microscopy (SEM) (upper left) and EDS elemental maps (right two columns) of a bulk Cs_{0.5}FA_{0.5}PbBr₃ crystal. Schematic illustrating the observed lateral heterostructure morphology consisting of a Cs-rich phase at the center and a FA-rich phase at the edge (lower left). The red and yellow dashed lines in the EDS images outline the edge and center, respectively. c, Confocal images of micron-scale mixed perovskite Cs_{0.5}FA_{0.5}Pb(Cl_{0.5}Br_{0.5})₃ crystals synthesized using a solution-based growth method. Different areas of the crystals emitted PL at different wavelengths. Left column: merged channels, middle column: blue channel (440-485-nm), right column: green channel (485-540-nm). d, PL spectra from the center and the edge regions of a crystal. e, Schematic illustration of heterostructure formation for Cs₁₋ₓFAₓPb(C_{1-y}Br_{y})₃ that relies on a two-step growth process.

FIG. 23: Size-dependent morphology, PL, and crystal structure of Cs_{0.5}FA_{0.5}Pb(Cl_{0.5}Br_{0.5})₃ nanocrystals. a, Schematic of the Cs_{0.5}FA_{0.5}Pb(Cl_{0.5}Br_{0.5})₃ crystal array via EC-PPL patterning. Top left panel: representative SEM image of an array of halide perovskite crystals. b-c, Multi-channel confocal fluorescence images from the patterned Cs_{0.5}FA_{0.5}Pb(Cl_{0.5}Br_{0.5})₃ crystals. Left: merged channel of the arrays; center: blue channel (440-485 nm); right: green channel (485-540 nm) from heterostructure in panel b and solid-solution in panel c. d, PL spectral evolution as a function of crystal size for the same array as in panel b and c. The green and blue dashed arrows follow the shoulder of each PL peak. e, Low-magnification TEM image of an array of Cs_{0.5}FA_{0.5}Pb(Cl_{0.5}Br_{0.5})₃ crystals on a TEM grid, inset: high-magnification TEM image of a heterostructure. f, HR-TEM image of the segregation-suppressed nanocrystal, with electron beam damage that results in small local differences in contrast. g, Enlarged view of the green square along the [001] zone axis. The different lattices represent the locally segregated domains throughout the entire crystal. h, An experimentally obtained diffraction pattern along the [001] zone axis of the nanocrystal in g. Inset: a simulated diffraction pattern of the dispersed cation perovskite packing (along the [001] zone axis) based on each ground structure, CsPbCl₃(Pnma), CsPbBr₃ (Pnma), FAPbCl₃ (μm3m), and FAPbBr₃ (Pm3m).

FIG. 24: Cation arrangement and size-dependent thermodynamics of mixed perovskites. a, The simulated formation energy (ΔE) of Cs₁₋ₓFAₓPbBr₃ as a function of FA concentration (x=0, 0.25, 0.5, 0.75, and 1) at 0 K. The grey dashed line represents the x-axis (ΔE=0). Blue and green shades represent the phase segregation regime and mixed regime, respectively. b, Schematics illustrating the segregated phases and mixed phase. In mixed phases, different arrangements were investigated, and energy variations occurred depending on cation arrangements as shown in panel a. The layered order represents clusters of FA molecules on the same layer, and this structure is a higher-energy configuration. The columnar and the dispersed arrangements represent the intermediate and lower-energy configurations, respectively. The green, pink, and clustered spheres represent the Cs cations, halide anions, and the FA cations, respectively. c, The final structures can be classified as either entropically favorable (solid-solution) or entropically unfavorable (phase-segregated). Gₛₛ and Gₕₑₜ: Free energies of solid-solution and heterostructure. T^{RT} and T*: Room temperature and critical temperature. d, Left: schematic of estimated miscibility gaps being suppressed as crystal size decreases. Each blue shade inward represent the immiscible regime as crystal size decreases. Right: PL spectra from approximately 100 nm crystals in the array before (bottom) and after annealing (top). Red arrow indicates the annealing process. Inset: confocal images of the particles from the array before and after annealing process.

FIG. 25: Heterostructure and solid-solution crystals and their stabilities under illumination. a, A library of complex halide perovskite heterostructures synthesized using EC-PPL and characterized by confocal microscopy. Top row: false-color schematics of the heterostructure with anions labeled as centerₓ edge_{y}; Subsequent rows: confocal images of the heterostructure library. Scale bars: 5 μm. b, Demonstrating the tunability of the PL of individual heterostructure crystals from the edge and center. c, From panel a and b, composition dependence of PL spectra with; Left column: binary Cl/Br. Right column: binary Br/I. PL spectra from ternary Cl/Br/I could not be obtained due to irreversible anion migration. d, PL evolution as a function of Cs_{0.5}FA_{0.5}Pb(Br_{0.9}I_{0.1})₃ crystal size. The shoulders at 520-nm and 568-nm merge into a single peak at 540-nm for particles approximately 60 nm in size. e, PL evolution as a function of Cs_{0.5}FA_{0.5}Pb(Br_{0.3}I_{0.2})₃ crystal size. The shoulders at 670-nm and 770-nm merge to a single peak at 540-nm for particles approximately 60 nm in size. Insets: optical images of the array, scale bar: 5 μm. f, The changes in the PL spectra as a function of illumination time for the Cs_{0.5}FA_{0.5}Pb(Br_{0.3}I_{0.2})₃ heterostructure. g, Steady-state PL spectra of the same crystal compositions as in panel e and f, where they display limited changes during illumination. Insets: Schematics of hypothesized polaron behavior in heterostructures and solid-solutions.

FIG. 26: The phase segregation trend of mixed cation perovskite. a-b, Photoluminescence (PL) of Cs₁₋ₓFAₓPbBr₃ as a function of FA concentration at room temperature. Black arrows on composition Cs_{0.5}FA_{0.5}PbBr₃ indicate the two PL shoulders, which are evidence of phase separation due to cation inhomogeneities. Some degree of phase segregation also occurs at other compositions, as evidenced by the less-pronounced shoulders at compositions x=0.25 and 0.75. The red circle in panel b represents the separated PL spectra.

FIG. 27: Distributions of constituent ions in Cs_{0.5}FA_{0.5}PbBr₃. a-b, SEM image and EDS ‘point and shoot’ results from heterostructure in Cs_{0.5}FA_{0.5}PbBr₃. Blue dots represent the targeted point along the line. The acceleration voltage was 15 kV. Cs to Pb (blue) and Br to Pb (orange) ratios as a function of position from the crystal center to edge, 3 μm away, within a single crystal. The ratio of Cs to Pb decreases with increasing distance from the center, while the ratio of Br to Pb is generally constant.

FIG. 28: Topology of the lateral heterostructure. a, AFM height images of lateral heterostructure crystals, Cs_{0.5}FA_{0.5}Pb(Cl_{0.5}Br_{0.5})₃, synthesized on a CHF₃-treated Si-wafer. b, Height profiles of the heterostructure when sectioned in each orthogonal direction (upper: blue, bottom: red in panel a). c, Three-dimensional image rendering based on the AFM height map. The edges of the heterostructure are elevated when compared to the center, indicative of an accumulation of the FA-based perovskite. Based on the two-step process (mentioned in the main text) where a Cs-rich then a FA-rich region is crystallized, the large concentration of FA-rich perovskite growing at the edges may arise due to the large number of heterogeneous nucleation sites on the crystal sides as opposed to its top; for example, the interface between the already-grown Cs-rich crystal and the substrate or the corners of the Cs-rich crystal act as such sites. In addition, during FA-rich crystal growth, ripening may induce a preference for redistributing towards overgrowth on the FA-rich ‘seed’ phases present on the crystal sides, leaving the top surface bare.

FIG. 29: X-ray diffraction patterns from heterostructures. a, XRD patterns of CsPbBr_{1.5}Cl_{1.5}, green line (CsPbBr₃, pnma) and blue line (CsPbCl₃, pnma) exported from PDF cards #01-085-6500 and #04-024-6243, respectively. The diffraction peaks from CsPb(Cl_{0.5}Br_{0.5})₃ are only slightly shifted compared to those from CsPbBr₃ and CsPbCl₃, indicating an identical phase with a unit cell size between that of the two phases. b, XRD patterns of FAPb(Cl_{0.5}Br_{0.5})₃, CsPb(Cl_{0.5}Br_{0.5})₃, and Cs_{0.5}FA_{0.5}Pb(Cl_{0.5}Br_{0.5})₃ crystals. The diffraction peaks from Cs_{0.5}FA_{0.5}Pb(Cl_{0.5}Br_{0.5})₃ show a combination of two different sets of reflections, where each set of constituent reflections match those of CsPb(Cl_{0.5}Br_{0.5})₃ and FAPb(Cl_{0.5}Br_{0.5})₃, respectively. This observation along with the single peaks observed in the PL spectra of each pure phase (Supplementary FIG. 5) provide strong evidence that multiple phases occur when both cations are incorporated.

FIG. 30: PL spectra originating from (top) CsPb(Cl_{0.5}Br_{0.5})₃, (middle) FAPb(Cl_{0.5}Br_{0.5})₃, and (bottom) Cs_{0.5}FA_{0.5}Pb(Cl_{0.5}Br_{0.5})₃. While the spectra of the perovskites with a single A-site cation and mixed anions that form homogenous alloys exhibit a single peak, that of the mixed cation perovskite imaged here, Cs_{0.5}FA_{0.5}Pb(Cl_{0.5}Br_{0.5})₃, shows two different PL peaks. These spectra reflect the difference in anion concentration within the heterostructure's core and shell (attributed to the cation separations), as the disparity in anion concentration is responsible for the number of PL peaks observed (approximately 450-nm and 500-nm in the center and edge, respectively). Scale bar: 5 μm.

FIG. 31: Two-step nucleation process of the lateral heterostructure. a-b, Left panels: Schematics of the heterostructure. Purple represents the Cs—Cl-rich perovskite, and green represents the FA-Br-rich perovskite. Right panels: Optical and fluorescence images of the heterostructure during the crystallization process. a, During the first few minutes of solvent evaporation, the perovskite phase rich in the Cs—Cl ion-pair forms, showing blue emission confirmed through florescence microscopy. b, Green emission develops over time and is localized at the edges of the primary crystal, implying that the FA-Br-rich perovskite surrounds the core Cs—Cl-rich perovskite. c, SEM image and EDS mapping results for a Cs_{0.5}FA_{0.5}Pb(Cl_{0.5}Br_{0.5})₃ heterostructure crystal formed by solvent evaporation confirm the same results. The substrate is a Si-wafer, and the imaging acceleration voltage is 15 kV.

FIG. 32: Experimental description of nucleation kinetics based on LaMer crystallization model. a, Precursors for a Cs-based and FA-based perovskite are monitored during solvent evaporation on a base of polymer pen array tips with identical conditions: same ink concentration, roughly the same ink volume, constant temperature, and relative humidity/atmosphere. Equal volumes were deposited via spin-coating the precursor solutions, and some solvent remained anchored at the base of each polymer tip (pyramidal shape). In the images, circles and arrows indicate crystals. b, The crystallization rate of CsPbBr₃ was faster, and thus larger crystals were formed by the time all of the solvent evaporated. In contrast, due to the slower crystallization rate of FAPbBr₃, smaller crystals were observed. Based on the LaMer crystallization model, since the solubility of Cs is much lower than that of FA in DMSO, Cs-rich perovskite quickly exceeds the critical concentration required for nucleation, and the FA-rich perovskite nucleates later. LG(r*): Energy barrier for nucleation, N: #of nucleus, S: Saturation concentration, C_{S}: solubility limit, vin: molar volume, ΔG_{M}: Energy barrier for an atom to migrate, γ: k_{B}: Boltzmann constant, T: temperature.

FIG. 33: Typical size distribution of as-synthesized Cs_{0.5}FA_{0.5}Pb(Cl_{0.5}Br_{0.5})₃ crystals on a Si wafer formed using polymer pen lithography. a, SEM image of decreasing crystal sizes in arrays from a single polymer pen. Crystal sizes can be determined by solution dome size and concentration of a precursor ink per previous reports. b-d, Higher-magnification SEM images from the arrays having different crystal size ranges from micrometers to tens of nanometers.

FIG. 34: Typical size distribution of as-synthesized Cs_{0.5}FA_{0.5}Pb(Cl_{0.5}Br_{0.5})₃ crystals on a Si wafer formed using polymer pen lithography. a, SEM image of decreasing crystal sizes in arrays from a single polymer pen. Crystal sizes can be determined by solution dome size and concentration of a precursor ink per previous reports. b-d, Higher-magnification SEM images from the arrays having different crystal size ranges from micrometers to tens of nanometers.

FIG. 35: Morphology changes of mixed Cs_{0.5}FA_{0.5}Pb(Cl_{0.5}Br_{0.5})₃ crystals ranging from approximately 500 nm to 60 nm in size. Higher-magnification SEM images from the arrays having the different crystal size distribution. This reveals that for larger Cs_{0.5}FA_{0.5}Pb(Cl_{0.5}Br_{0.5})₃ crystal sizes (>100 nm), the shell surrounds the crystal core with a clear phase boundary, resembling the structure of the microcrystal heterostructures synthesized via the bulk solution-based method above. As particle size decreases, boundaries between the center and edge gradually become indistinguishable, as evident from the smallest particle size (approximately 60 nm). PL spectra in FIG. 2d were partially obtained from these crystals in the same array.

FIG. 36: Single-peak emission from CsPb(C_{0.5}Br_{0.5})₃ and FAPb(Cl_{0.5}Br_{0.5})₃ arrays. Both showed stable single peaks in their PL emission spectra, unlike with the mixed cation/mixed anion perovskites where shoulders were observed. Furthermore, considering that the PL results obtained both from EC-PPL and bulk solution-based methods are the same (as seen in Supplementary FIG. 5), this data suggests the two methods are effectively similar.

FIG. 37: HR-TEM images of Cs_{0.5}FA_{0.5}Pb(Cl_{0.5}Br_{0.5})₃ heterostructure. a, High-magnification image of the heterostructure interface. The blue dashed square captures a Cs-rich domain at the particle core, and the yellow-dashed square encompasses a FA-rich phase at the edge region. b-c, fast Fourier transform (FFT) images from each region. Pure CsPbCl₃ is commonly reported as orthorhombic (Pnma), and the center-phase material of our segregated structures appear to match, however complete indexing remains challenging due to local distortions during e-beam exposure and small degrees of ion (FA and Br) mixing at the center. However, the FA-Br-rich region at the edge exhibited a cubic-like structure similar to the reported FAPbBr₃ structure.

FIG. 38: Cs_{0.5}FA_{0.5}Pb(Cl_{0.5}Br_{0.5})₃ size confined solid-solution from the array. a, HR-TEM image from FIG. 3g. b, FFT of locally segregated domains, referring to the orthorhombic and cubic phases, respectively. c, Structural changes in the alloy Cs_{0.5}FA_{0.5}Pb(Cl_{0.5}Br_{0.5})₃ during electron beam exposure. Electron beam damage was monitored over time on a single crystal. During the exposure process, the organic cation likely decomposes, exacerbating the differences in contrast and causing global changes in particle morphology.

FIG. 39: Cs_{0.5}FA_{0.5}Pb(Cl_{0.5}Br_{0.5})₃ size confined solid-solution from the array. a, HR-TEM image from FIG. 3g. b, FFT of locally segregated domains, referring to the orthorhombic and cubic phases, respectively. c, Structural changes in the alloy Cs_{0.5}FA_{0.5}Pb(Cl_{0.5}Br_{0.5})₃ during electron beam exposure. Electron beam damage was monitored over time on a single crystal. During the exposure process, the organic cation likely decomposes, exacerbating the differences in contrast and causing global changes in particle morphology.

FIG. 40: Atomic structure of Cs_{0.5}FA_{0.5}PbBr₃ with dispersed configuration. a, Three-dimensional view in Cs_{0.5}FA_{0.5}PbBr₃. b, Top view in Cs_{0.5}FA_{0.5}PbBr₃. FA molecules and Cs atoms are arranged rock-salt order, where the nearest neighboring A-sites of Cs are all FA molecules. The preferred orientation of FA molecules is determined based on the most stable arrangement of FAPbBr₃.

FIG. 41: Band gap of mixed-halide perovskites as a function of the tolerance factor. Linear fits were performed on the plot of band gap vs. tolerance factor, using bandgaps based on the PL data for (a) Cs₁₋ₓFAₓPbBr₃ and (b) Cs₁₋ₓFAₓPb(C_{0.5}Br_{0.5})₃. a, The anion is pure Br, so CsPbBr₃ and FAPbBr₃ represent the two extremes in tolerance factor. The red solid line is the best-fit with R²=0.974. b, The anions are mixed and set to a constant Cl:Br ratio, while the cations are varied. In this case, CsPb(Cl_{0.5}Br_{0.5})₃ and FAPb(Cl_{0.5}Br_{0.5})₃ represent the two extremes. The red solid line is the best-fit with R²=0.455. The circled two data points were calculated from the heterostructure. the deviation from linear behavior is likely due to anions inhomogeneity in the structure. In contrast, the alloy particle synthesized at a 1:1 ratio of CsPb(Cl_{0.5}Br_{0.5})₃ and FAPb(Cl_{0.5}Br_{0.5})₃ lies perfectly on the line and has a correlation coefficient R²=0.999.

FIG. 42: Cation arrangements in Cs_{0.75}FA_{0.25}PbX₃. a, Geometry of the CH(NH₂)2 (FA) molecule with molecular axes (êₓ, ê_{y}, ê_{z}). b-e, Example cation orders of Cs_{0.75}FA_{0.25}PbX₃. Layered configurations are devised by arranging FA molecules on one atomic layer, which is perpendicular layer to ê_{z} in the supercell. The intra-layer arrangement distinguishes layered (far) and layered (near) orders based on relative distances between nearest FA molecules. Columnar order is constructed by aligning FA molecules along ê_{z} axis, and dispersed order by maximizing distance between FA molecules. The orientation of FA molecules is determined based on the most stable arrangements of FAPbX₃.

FIG. 43: Formation energy (ΔE) of Cs₁₋ₓFAₓPbX₃. Relative energy in (a) Cs₁₋ₓFAₓPbCl₃, (b) Cs₁₋ₓFAₓPbBr₃, and (c) Cs₁₋ₓFAₓPbI₃ were calculated and referenced to tie-lines between orthorhombic CsPbBr₃ and cubic-like FAPbBr₃ structure, as a function of FA concentration (x=0, 0.25, 0.5, 0.75, and 1) at 0 K. Multiple cation arrangements were calculated for each type of ordering (layered, columnar, and dispersed), based on the rules described in Supplementary Text 2. Two different layered orders at x=0.25 and x=0.75 show large a dispersion of formation energy, which implies that the energetics depend on the atomic relaxation induced by cation ordering. The green dashed line represents the quadratic line of best fit based on the average energy for each simulated composition to visually follow the miscibility gap.

FIG. 44: Atomic structure of Cs_{0.75}FA_{0.25}PbBr₃ with two layered configuration. a-b, Layered (far) order hosts FA molecules with checkerboard arrangement within the FA-rich atomic layer. c-d, Layered (near) order is with FA molecules in the FA-rich atomic layer with stripe pattern. The different ordering in FA-rich layer results in changes to the shape of the A-site cage in the Cs-rich layers (cage highlighted by orange circles).

FIG. 45: Atomic structure with different FA orientation in FAPbBr₃. a, All FA molecules are parallel. b, Highlighted FA molecule with a circle is rotated 90° degrees about ê_{z}. c, Additional 90° degree-rotation about êₓ is applied.

FIG. 46: Emission center location vs. annealing time from Cs_{0.5}FA_{0.5}Pb(Cl_{0.5}Br_{0.5})₃ crystals. a, Before annealing: the PL spectra from the center (peak=450-nm) and edge (peak=500-nm). Inset: the merged fluorescence image. b, PL spectral peak positions from the center and edge change somewhat as a function of annealing time, but a single peak is not observed despite 4 h of annealing. c, After annealing at 120° C. for 4 h: the fluorescence images from the confocal microscope. Left panel: merged, Middle panel: 440-485 nm, Right panel: 485-540 nm.

FIG. 47: Heterostructure evolution in the large-sized crystals as a function of annealing time for different compositions. a, For large CsPb(Cl_{0.5}Br_{0.5})₃ crystals, the compositional inhomogeneity observed to occur based on the PL is diminished after annealing at 100° C. for 12 h with both center and edge emitting at approximately 460-nm. This implies that the ion-migration was due to kinetic effects. b, In contrast, the PL peak positions for Cs_{0.85}FA_{0.15}Pb(Cl_{0.5}Br_{0.5})₃ from the centers and edges do not change significantly after annealing at 100° C. for 25 h. This result implies that marginal differences in morphology as driven by differences in nucleation rate between different anions can be overcome by heating. However, if the larger heterostructures form due to cation inhomogeneities between the core and shell, the corresponding anions do not mix, and they remain segregated. Scale bars: 20 μm.

FIG. 48: Ion mixing in smaller Cs_{0.5}FA_{0.5}Pb(Cl_{0.5}Br_{0.5})₃ heterostructure microcrystals after annealing. a-b, Fluorescence images from the confocal microscope and their PL emission spectra. a, For smaller Cs_{0.5}FA_{0.5}Pb(Cl_{0.5}Br_{0.5})₃ crystals, lateral heterostructures exhibiting PL spectra with two different emission centers were observed. b, After annealing at 120° C. for 2 h, two spectra begin to overlap, indicating enhanced mixing driven by heating. For comparison, blue and green dashed lines show where the peak maxima were for the crystals before annealing.

FIG. 49: Cs_{0.5}FA_{0.5}Pb(Cl_{0.5}Br_{0.5})₃ array synthesized at elevated temperature. a, Higher temperatures (353 K) enable rapid solvent evaporation, which causes a nucleation burst event as opposed to the two-step crystallization process. As a result, scattered particles form, with multiple phases present within a single reactor as shown by confocal microscopy. b, PL emission from each particle in the array, showing that the individual crystals are likely Cs—Cl-rich and FA-Br-rich perovskites.

FIG. 50: Confocal images of Cs_{0.5}FA_{0.5}Pb(Cl_{0.42}Br_{0.42}I_{0.17})₃ crystals. a, As-synthesized tri-halide ion heterostructure crystals using bulk growth to form microcrystals. b, As-synthesized tri-halide structures obtained from EC-PPL for smaller crystals.

### DETAILED DESCRIPTION

### Mixed Halide Megalibraries

Methods of the disclosure can be utilized to form libraries of mixed halide perovskite particles with varying size and a laser excitation can be used to toggle the defect concentrations in the nanostructures. The defect concentration of individual particles is dependent on the laser exposure conditions owing to a vacancy formation mechanism induced by strong photocarrier-lattice interactions. The method can further include performing anion exchange in a parallelized manner because the degree of ion exchange of each particle is dependent on its defect concentration and size. The method can enable creation of combinatorial libraries that can be screened for various properties, such as optoelectronic properties.

Methods of making libraries of mixed halide perovskite particles can include depositing an array of halide perovskite particles on a substrate. The halide perovskite particles can be a compound of formula A¹BX¹₃, where A¹ is a first cation, B is a metal, and X¹ is a first halogen. The array can have a variation of size of the halide perovskite particles and/or can have a uniform crystal size. The array can have a variation of composition of halide perovskite particles or particles can each have a uniform composition. For example, the array can include halide perovskite particles of uniform composition but varying crystal size. The crystal size can vary, for example, as a gradient across the array.

The defects are then introduced into the halide perovskite particles using laser excitation. The array is exposed to the laser, for example, a confocal laser, with variation of the exposure conditions to change the defect concentration in at least a portion of the particles in the array based on the changes in exposure conditions. For example, the exposure conditions can be varied in a gradient such that a gradient of defect concentrations is generated. The exposure conditions can be varied selectively such that selected ones of the particles have more or less defect concentration. Additionally, or alternatively, selective ones of the particles can be exposed to the laser while others remain unexposed. As a result, only those selected particles exposed to the laser will ion exchange and form the mixed halide perovskites, thereby resulting in a variation of composition between single anion or cation halide perovskites and mixed anion or cation halide perovskites in the array.

Variation of the laser exposure can include varying one or both of the exposure time and the power of the laser. For example, the exposure time can be about 10 s to about 80 s, about 20 s to about 60 s, about 50 s to about 80 s, about 10 s to about 40 s. Other suitable times can include about 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, and any values therebetween or ranges defined by these values. For example, the power can be about 0.25 mW to about 25 mW, about, about 1 mw to about 10 mW, about 0.25 mW to about 5 mW, or about 15 mW to about 25 mW. Other suitable powers include about 0.25, 0.5, 0.75, 1, 5, 10, 15, 20, 25 mW or any values therebetween or ranges defined by these values.

The variation of the exposure conditions of time and power varies the amount of energy delivered to the particles in the array. The energy can range from about 2.5 mJ to about 2000 mJ. The energy delivered to the particles can be varied across the array. For example, the energy can be varied as a gradient. For example, selected particles can have different energies delivered through the laser exposure. It is also contemplated herein that a uniform exposure can be used to deliver the same amount of energy to each of the particles.

The laser can have a wavelength, for example, in the range of UV to IR wavelength. For example, the laser can have a wavelength of about 300 nm to about 700 nm. For example, the laser can have a wavelength of 473 nm.

The array of halide perovskite particles is then ion exchanged either cation or anion exchanged to form the mixed halide perovskite structure. For example, for anion exchange, the array of halide perovskite particles having the laser-induced defects can be exposed to an exchange solution comprising a second halogen X² that is different than the first halogen X¹. The anion exchange results in a mixed halide perovskite being formed having the formula AB(X¹₍₁₋ₙ₎X²ₙ)₃, where A is the cation, B is the metal, X¹ is a first halogen and X² is a second halogen different from the first halogen. For example, the halogen can be provided as a precursor of formula BX²_{y} for anion exchange. For example, for cation exchange, the array of halide perovskite particles having the laser-induced defects can be exposed to an exchange solution comprising a cation A². The cation exchanges results in a mixed-halide perovskite of formula (A¹₍₁₋ₙ₎A²ₙ)BX₃, wherein 0<n<1) where A¹ is the first cation, A² is a second cation different from the first cation, B is the metal, X is a halogen. For example, mixed cation halide perovskites can include Cs⁺-MA⁺, Cs⁺-FA⁺, Pb²⁺—Sn²⁺ as the cations.

The degree of ion exchange is dependent on the defect concentration and the crystal size. Thus, by varying the crystal size and the defect concentration, the composition of the resulting mixed halide perovskite formed after ion exchange can be controlled. To avoid complete ion exchange, the ion exchange process can be performed at a reduced temperature, for example, about 20° C. to 65° C. to slow the reaction kinetics and thereby allow for partial ion exchange such that a mixed ion halide perovskite composition can be formed.

CsPbBr₃ halide perovskites and resulting mixed anion halide perovskites are discussed herein by way of example only. It should be understood that the example methods described with respect to the Cs—Pb—Br system can be extended to any halide perovskites structure. Generally, the halide perovskite structures used in the methods herein and resulting mixed halide perovskites can have a composition in which A¹ and A² (if present) can be an organic or inorganic cation and are different cations, B is a metal cation, and X¹ and X² (if present) are different halogens. For example, A¹ and A² can be independently selected from one or more of methylammonium, butylammonium, formamidinium, phenethylamine, 3-(aminomethyl)piperidinium, 4-(aminomethyl)piperidinium, cesium, and rubidium. For example, B can be one or more of lead, tin, europium, and/or germanium. For example, X¹ and X² can be independently selected from Cl, Br, F, and I.

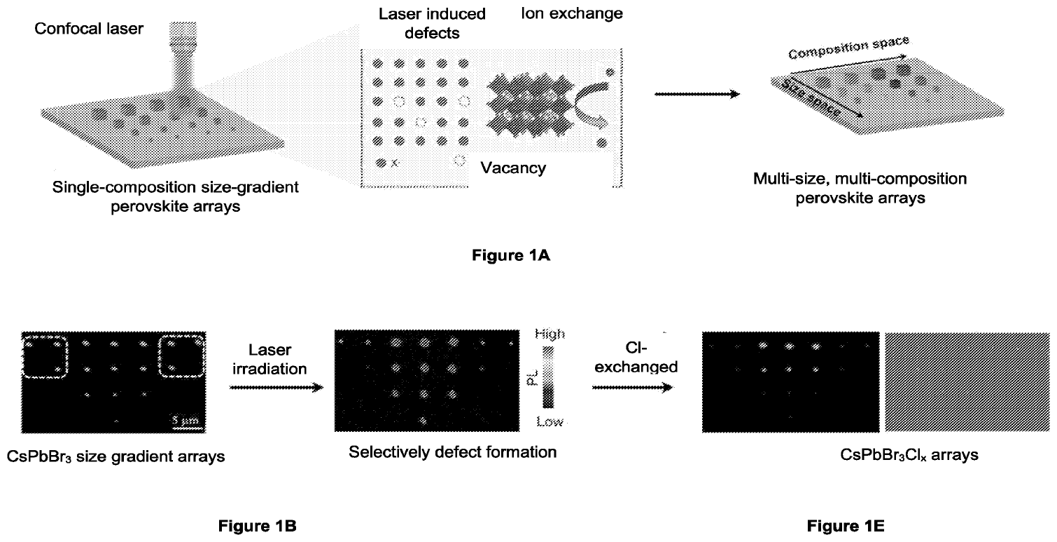

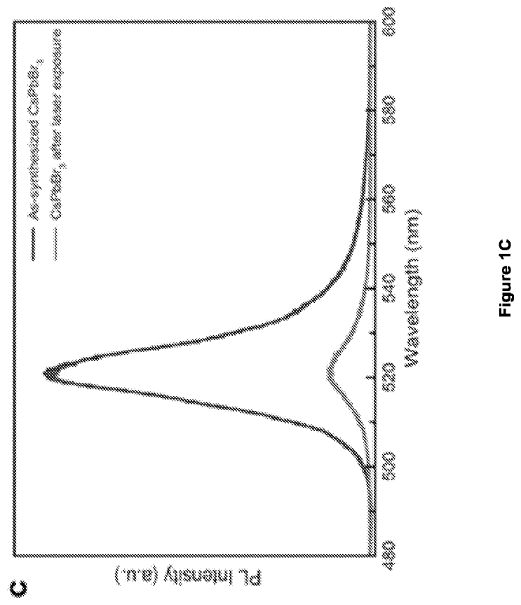

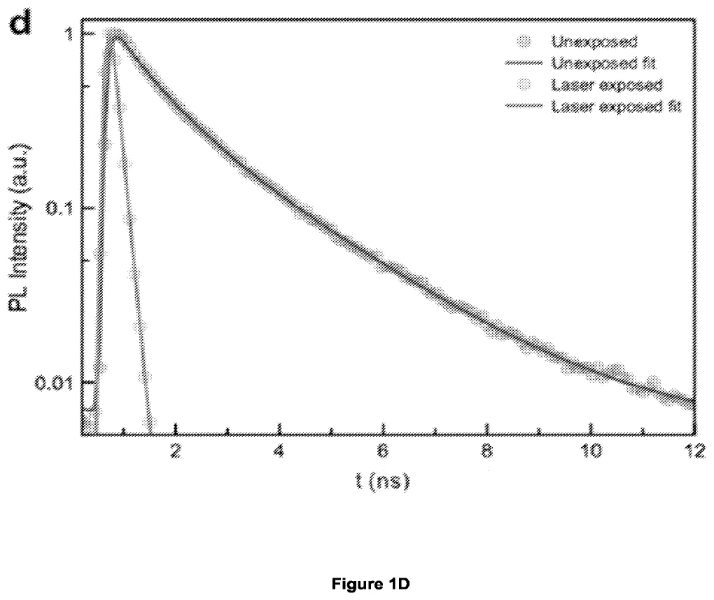

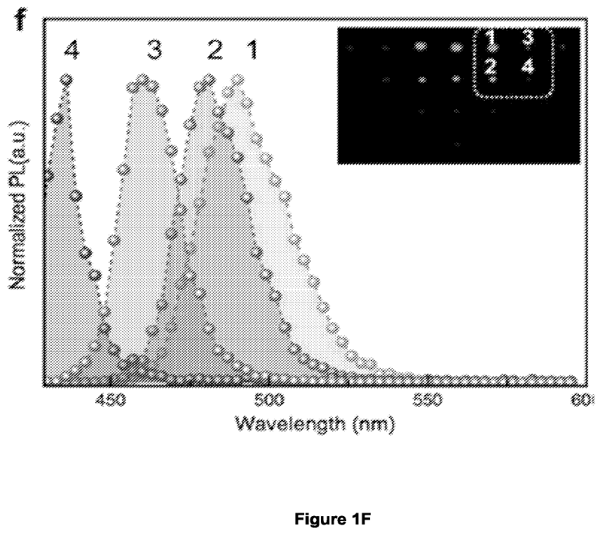

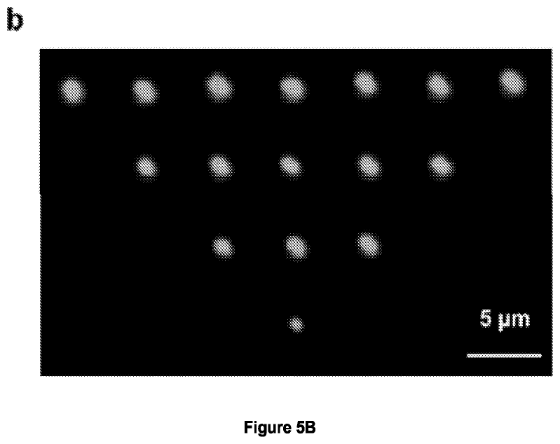

In a typical experiment, halide perovskite CsPbBr₃ arrays for preparing combinatorial libraries of MHP particles were synthesized using a previously reported EC-PPL method, which enables the formation of an array of particles of uniform composition and a gradient of sizes (approximately 100 to 400 nm) (FIG. 5). Next, a focused confocal laser was used to controllably form defects in each perovskite particle, as previously reported with various semiconductor materials. By raster-scanning across the array and modifying the exposure conditions applied to each particle, this technique allows for the formation of a gradient where each particle has a unique defect concentration (FIG. 1 a). Subsequent ion exchange (from CsPbBr₃ to CsPb(Br₁₋ₓClₓ)₃ (0<x<1) and facile Br—Cl exchange kinetics enable access to a wide range of materials with deliberately varied Cl:Br ratios (Cl/(Br+Cl)=x)). This yields a combinatorial two-dimensional library consisting of a size gradient along one axis and a compositional gradient along the other (FIG. 1 a) because the degree of anion exchange is dependent on both the defect concentration and crystal size.

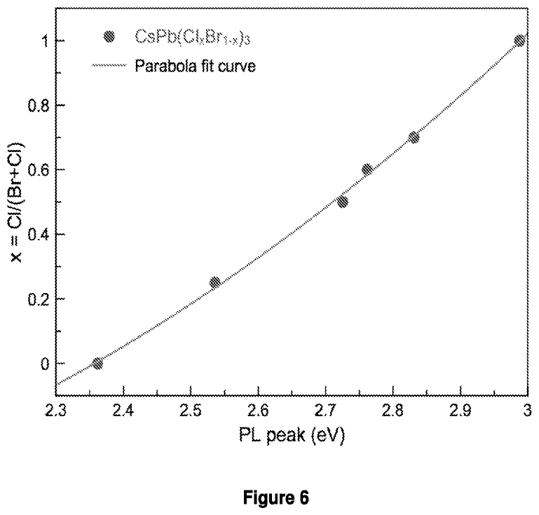

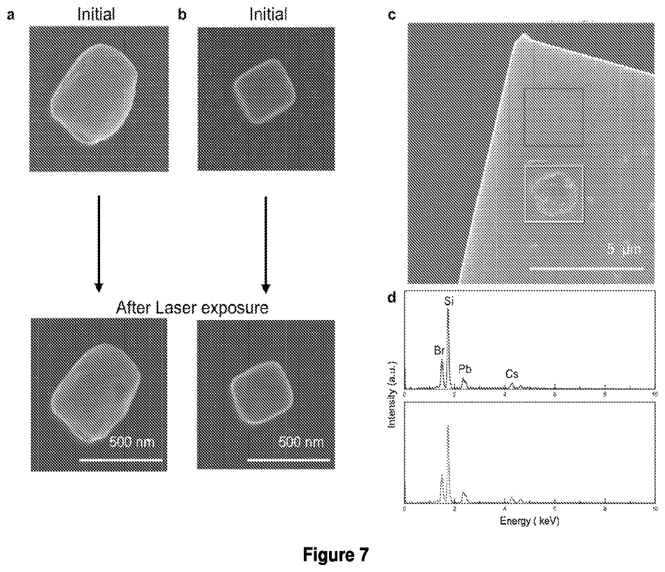

The sizes and compositions of the particles were characterized using scanning electron microscopy (SEM) and photoluminescence (PL) spectroscopy, respectively. The PL peak locations of the CsPb(Br₁₋ₓClₓ)₃a compositions are related to the value of x (FIG. 6), providing a means of rapid and accurate particle characterization and screening. Upon laser-exposure (473 nm, continuous-wave), the PL intensities (FIG. 1b-1c) and lifetimes (˜1.3 to 0.1 ns, FIG. 1d) of the CsPbBr₃ nanoparticles decrease significantly because the defects in halide perovskites typically exist as nonradiative photo-generated carriers. These findings are consistent with an increase in the defect concentration upon laser exposure. Furthermore, the size and shape of the single crystal CsPbBr₃ particles do not change after laser exposure, although the surfaces of the particles roughen (FIG. 7a-7b). Energy dispersive X-ray spectroscopy (EDS) suggests that compositional changes do not occur with the particles in the laser-exposed area (FIG. 7c-7d).

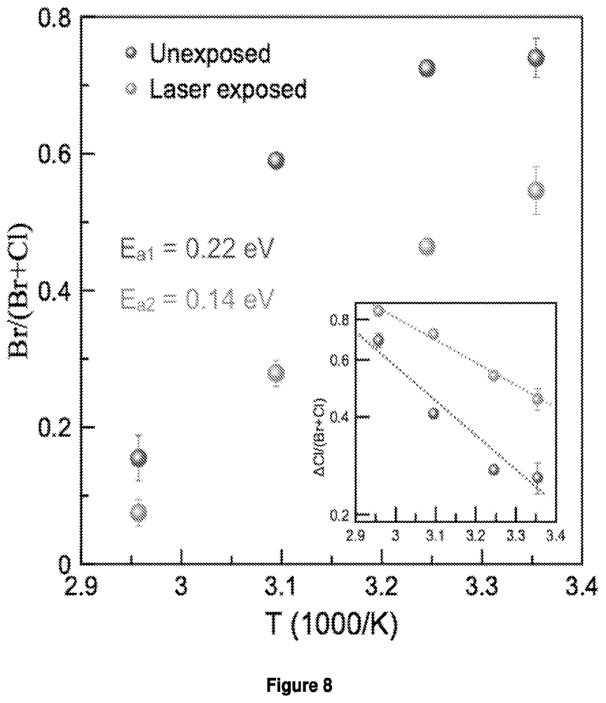

In order to access intermediate CsPb(BrₓCl₁₋ₓ)₃ compositions and avoid complete exchange from CsPbBr₃ to CsPbCl₃, a low reaction solution temperature (20-65° C.), which can allow for slow anion exchange kinetics, was used. Defects in this regime are likely in the form of halide vacancies (V_{X}⁺) because they have the lowest formation energy compared to other defects and promote diffusion. Previously, researchers examined the relationship between vacancy concentration and diffusion in solids, and the vacancy-dependent modification to the diffusion coefficient (D) can be obtained based on the equation: D=αa²ωN_{V}; where N_{V} is the vacancy concentration in the solid, α is a geometric constant, a is the elementary jump distance, and ω is the jump frequency. Laser exposure introduces additional vacancies that proportionally increase with increasing diffusion coefficient (D), which promotes anion exchange. Thus, a significant blue-shift in the PL peak position of laser-exposed particles compared to their unexposed counterparts was observed (˜400 nm particles: 490 nm vs. 460 nm; ˜300 nm particles: 481 nm vs. 436 nm) (FIG. 1e, FIG. 1f), indicative of more anion exchange from Br to Cl⁻. It was also observed a smaller activation energy for anion exchange with the laser-exposed particles as compared to the unexposed 400-nm particles (˜0.14 eV vs. ˜0.22 eV) (FIG. 8), likely because higher vacancy concentrations facilitate anion exchange.

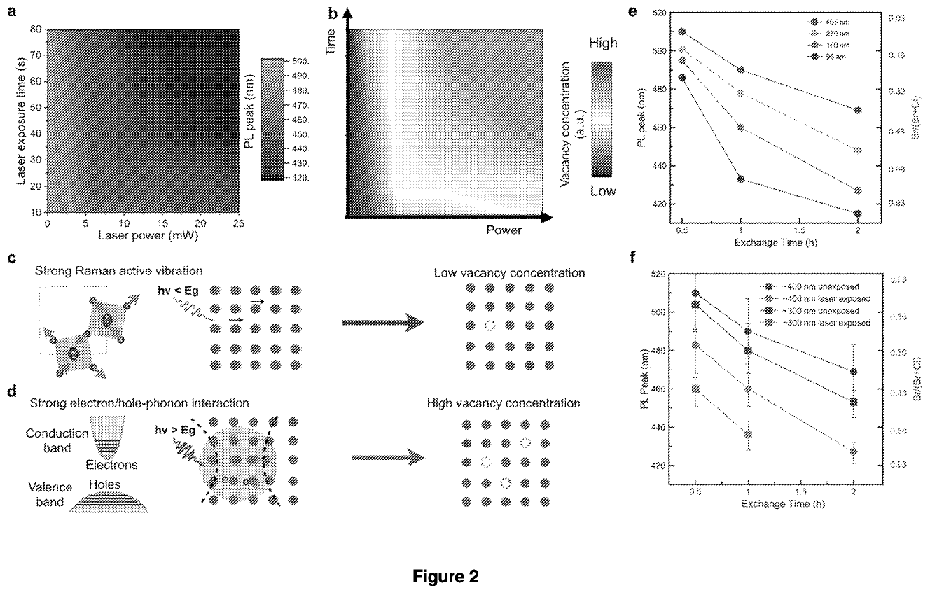

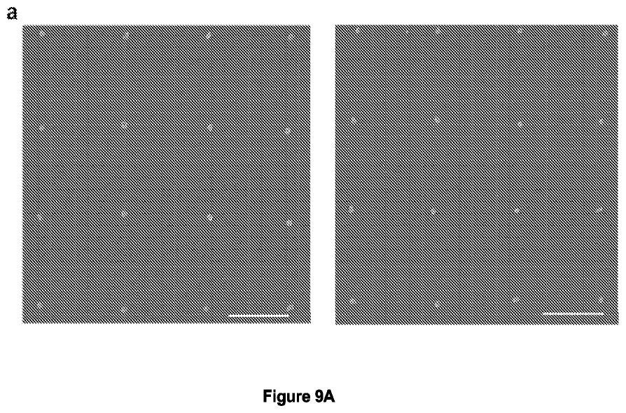

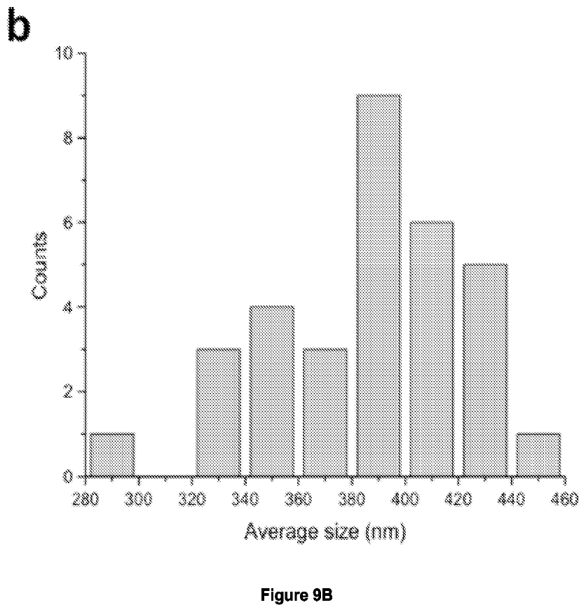

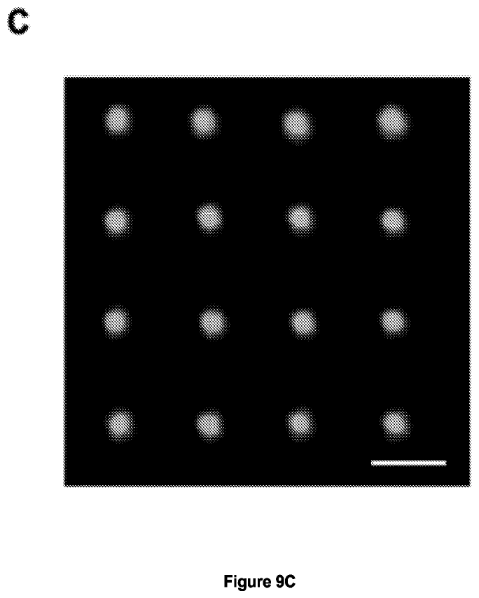

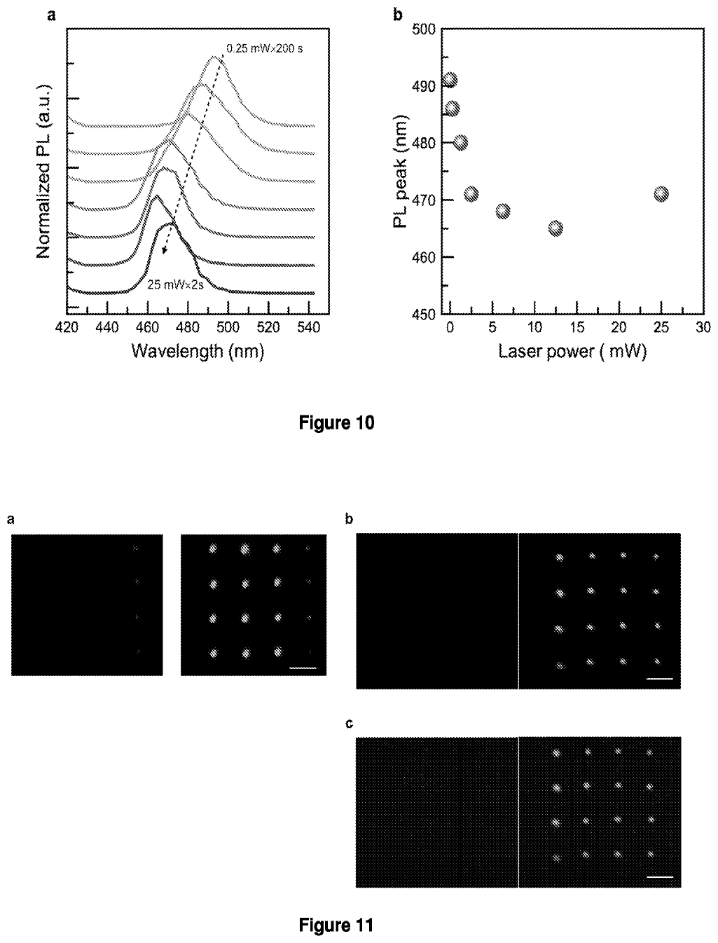

Next, the V_{X}⁺ concentration, and ultimately halide composition, of the particles in the CsPbBr₃ arrays was tuned by adjusting the confocal laser exposure conditions. First, pre-patterned arrays of CsPbBr₃ particles (396 nm±25 nm) were prepared using EC-PPL with an identical 8-μm extension length (FIG. 9). These particles were then exposed to a range of 473-nm laser powers (0.25 mW to 25 mW) for different times (10 s to 80 s) to access a wide range of delivered energies (power×exposure time, 2.5 mJ to 2,000 mJ). Subsequent anion exchange in a—solution of—for 1 h at 35° C., yielded a range of particle compositions with PL emission peaks that uniformly varied in wavelength from approximately 494 to 420 nm (corresponding to a range of compositions: CsPb(Br_{0.75}Cl_{1.25})₃ to CsPb(Br_{0.05}Cl_{0.95})₃) formed (FIG. 2a). In general, higher powers and longer exposure times led to increased anion exchange. Interestingly, the results indicated that the degree of anion exchange was more dependent upon laser power than exposure time. To further confirm this result, the power and time were adjusted to achieve the same total delivered energy, and the PL after anion exchange was measured for each particle in the formerly CsPbBr₃ array (FIG. 10). In general, a blue shift in the PL spectra was observed as a function of increased laser power (from 0.25 mW to 25 mW, total delivered energy=50 mJ). The V_{X}⁺ concentration should have a similar relationship to the laser exposure conditions (FIG. 2b), because the degree of anion exchange is related to V_{X}⁺ concentration given the aforementioned semiquantitative nature of the vacancy-assisted diffusion model (i.e., D=αa²(ωN_{V}).

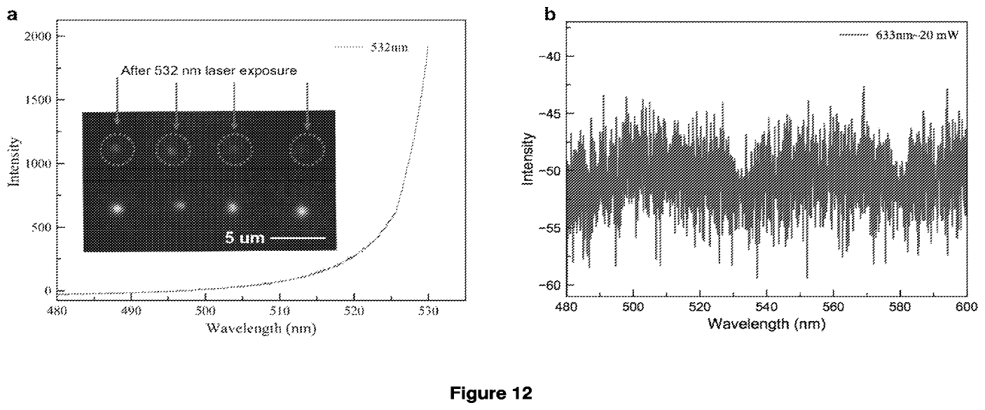

The increased sensitivity of V_{X}⁺ concentration to laser power can be understood by considering the postulated process for laser-induced vacancy formation and its role in the synthetic method described herein. Light-matter interactions that occur during the laser-exposure of CsPbBr₃ include: a local temperature increase due to laser heating and the generation and subsequent interaction of photocarriers with the crystal lattice. Of these, it was hypothesized that laser-induced V_{X}⁺ formation is mainly attributed to strong photocarrier-phonon interactions. Laser-induced heating is unlikely to be relevant here because enhanced anion exchange was not observed in unexposed particles even after annealing at 200° C. for more than 20 min (FIG. 11). The soft ionic lattice of halide perovskites can interact with photocarriers to form exciton-phonon couples or polarons. If incident photons are not of a high enough energy to generate photocarriers, the V_{X}⁺ concentration of the material should not significantly change. Thus, anion-exchanged products of CsPbBr₃ particles were examined after they were exposed to continuous-wave lasers with photon energies below those of the bandgap (785, 633, or 532 nm), where photocarriers were not expected to form (FIG. 11). Indeed, compared to unexposed particles after anion exchange, no substantial blue shift of PL peak position was observed (FIG. 12), indicating no obvious change of V_{X}⁺ concentration even after a lengthy high-power 785-nm laser exposure (20 mW×200 s).

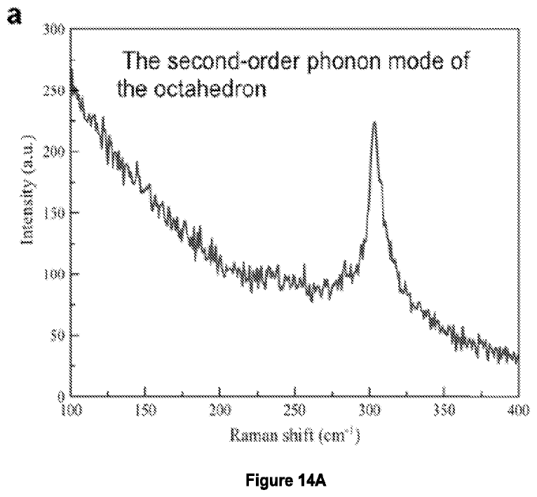

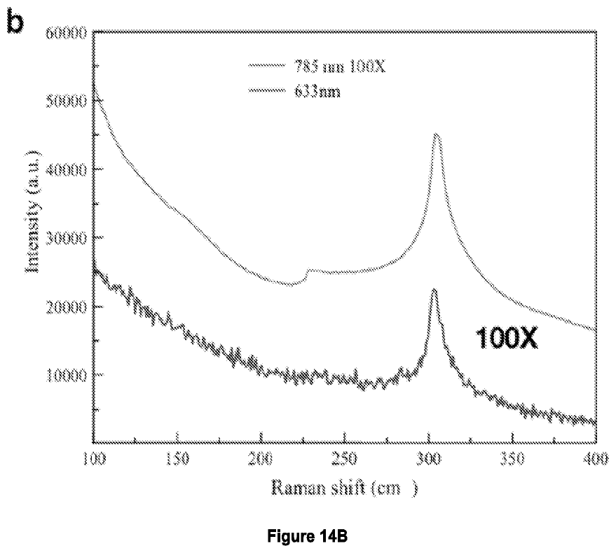

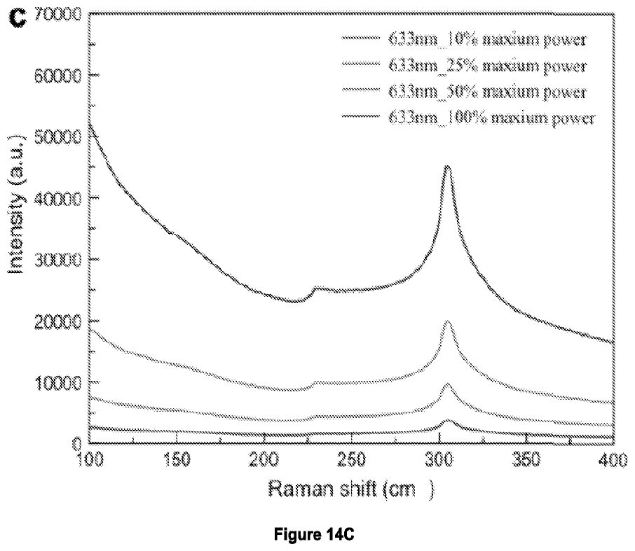

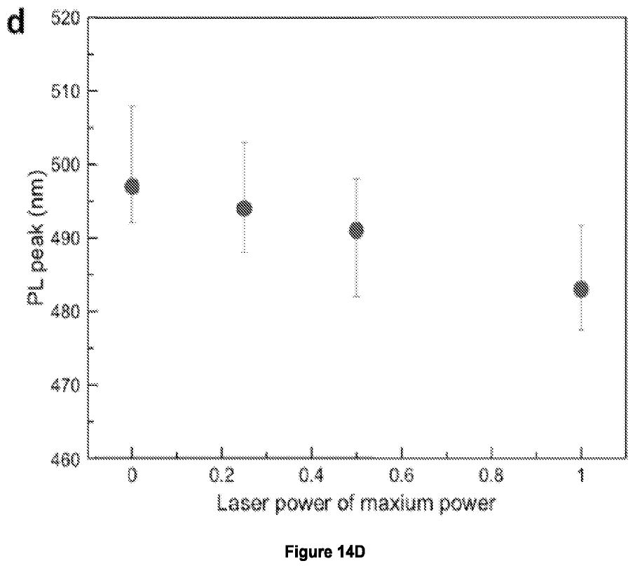

Interestingly though, with intermediate sub-bandgap 532 and 633-nm laser exposure (approximately 20 mW×200 s), the PL peak positions moved to lower wavelengths (FIG. 12), indicating a low concentration of laser-induced V_{X}⁺ formation. This behavior can be explained by a phonon promoted process (FIG. 2c): X_{X}→V_{X}⁺+Xᵢ⁻ where X_{X} is a halide anion in its own crystal site and Xᵢ⁻ is an interstitial halide anion. This mechanism is further supported by the observation of an increase in vacancy formation only with high intensity phonon modes (FIG. 14). Compared to pure phonon excitation, photo-generated holes h⁺ created via 473-nm laser exposure can combine with charged interstitial halide ions Xᵢ⁻ to form stabilized neutral Xᵢ⁰:X_{X}⁰+h⁺→V_{X}⁺+Xᵢ⁰. The strong photocarrier-lattice interactions accurately predict a significant increase of V_{X}⁺ concentration in all-inorganic CsPbBr₃ (FIG. 2d). In addition, because the photo-generated hole concentration is dependent on the input photon flux, this explanation accounts for the increased sensitivity of V_{X}⁺ concentration to laser power (FIG. 2b). It is important to understand these different laser-induced vacancy formation processes because they underpin our ability to finely tune vacancy concentration and ultimately composition after anion exchange in these perovskite materials.

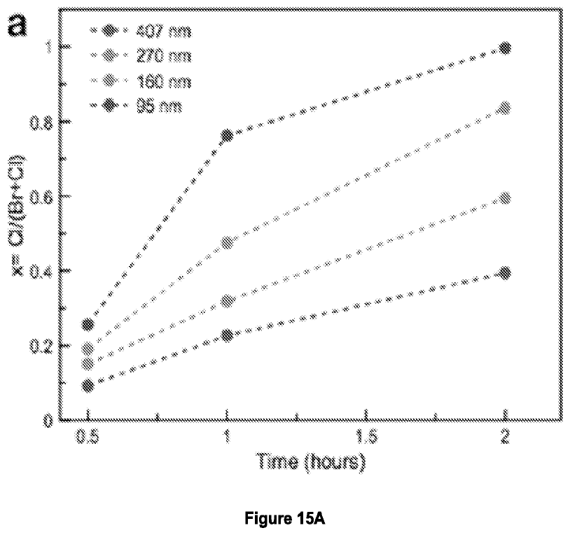

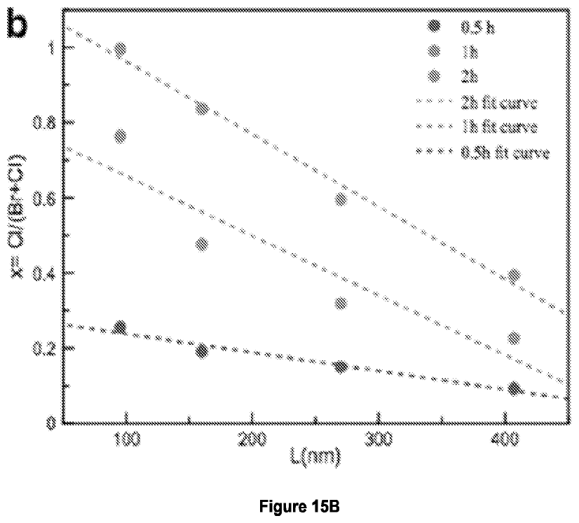

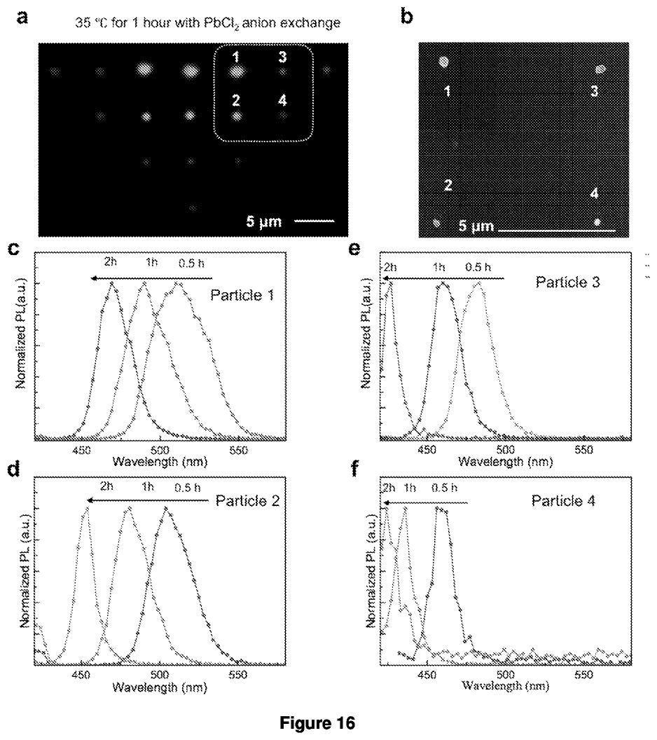

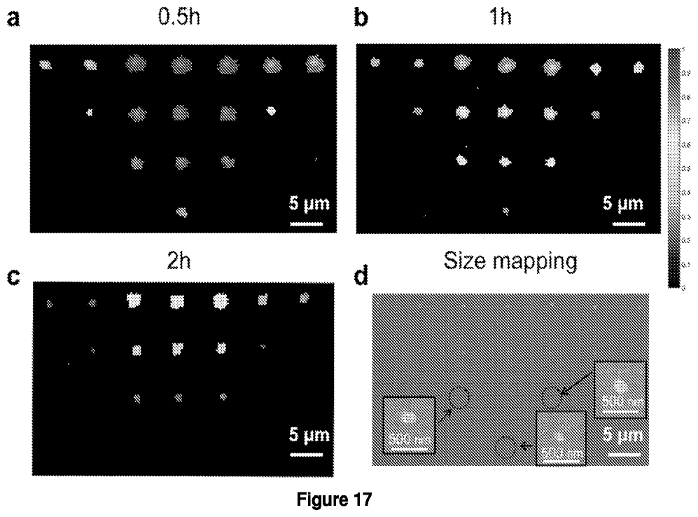

Anion exchange is particle size-dependent (in the ˜100 to ˜400 nm range) in addition to being dependent on laser-induced effects (FIG. 2e, FIG. 2f, FIG. 16). According to an understanding of solid-state diffusion, more anion exchange (to Cl in the example shown) is expected with smaller crystals due to the larger ratio of diffusion length (L) to crystal size (L≅2\sqrt{Dt}, where D is the diffusion coefficient and t is the diffusion time). When the anion exchange time is increased from 0.5 h to 2 h, the compositions of the particles in the array, regardless of size, were shifted towards higher Cl content. Taken together, using a combination of laser exposure- and size-dependent anion exchange kinetics, one can access combinatorial CsPb(Br₁₋ₓClₓ)₃ libraries with gradients of compositions and sizes utilizing this massively parallel, post-synthetic reaction method (FIG. 1e, FIG. 17).

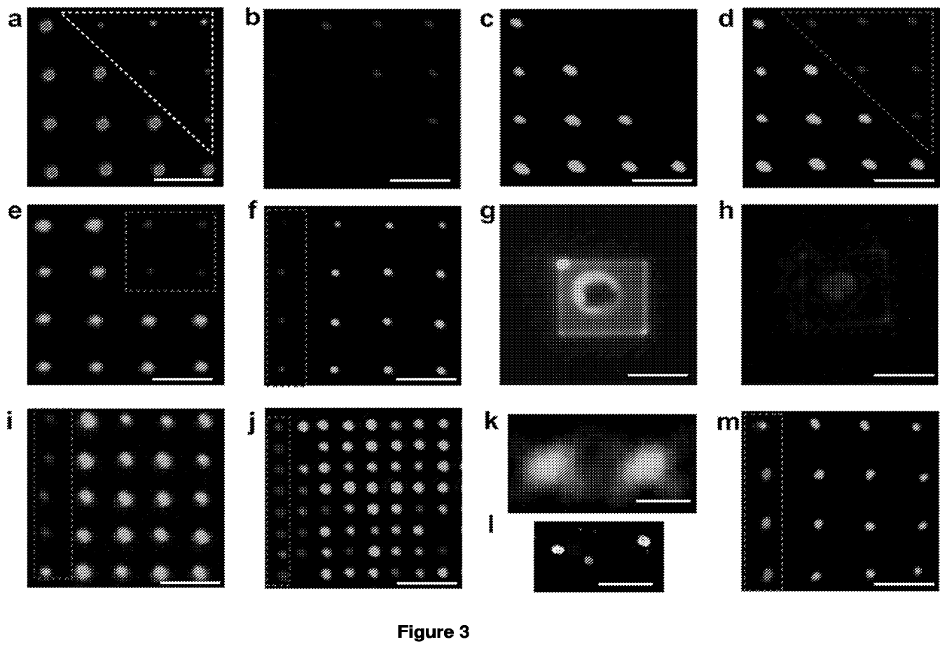

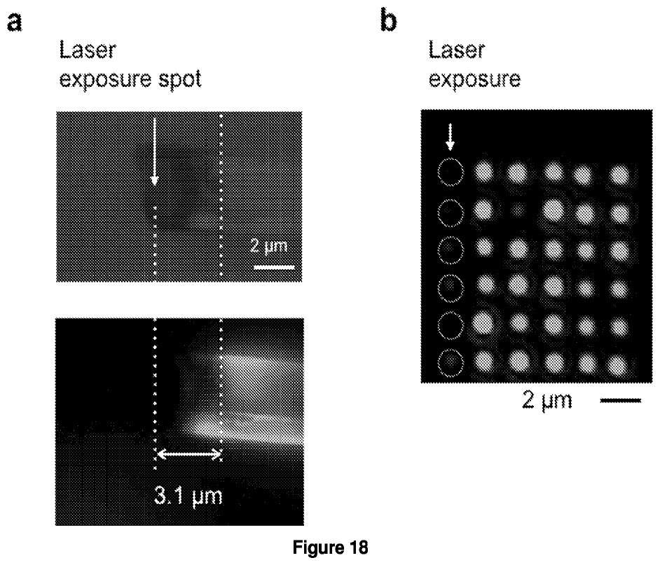

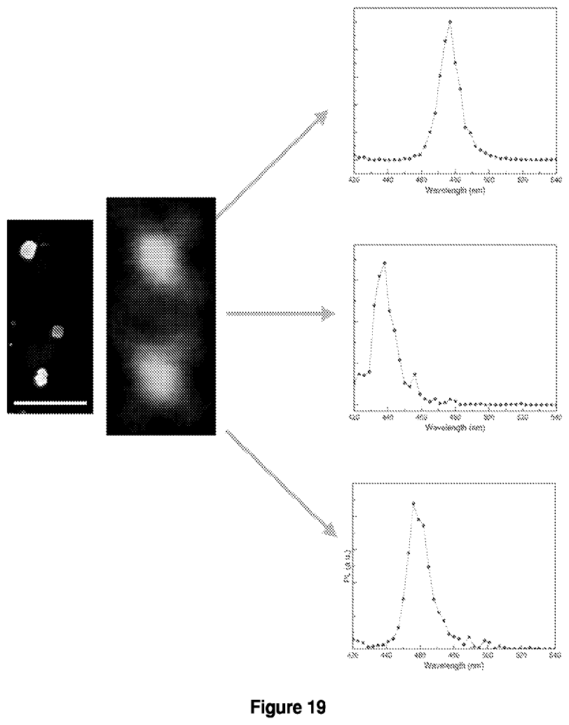

Next, the ability to selectively modify the composition of single particles in a high-density particle array via selective laser exposure was demonstrated (FIG. 3a-3c show such methods with respect to CsPbBr₃). Different patterns of Cl-enriched particles, such as a triangle, an inset square, and a line shape, were observed by confocal PL two-channel imaging after spatially defined laser exposure and anion exchange (FIG. 3d-3f). The defect-containing regions in the CsPbBr₃ microcrystals (>2 μm) (FIG. 3g, FIG. 7) can be larger than the confocal laser spot size (<1 μm), presumably due to facile photo-carrier diffusion in single-crystal lattices that permit laser-induced vacancy diffusion over long distances. Thus, the corresponding Cl-rich feature size with these microcrystals is greater than 2 μm after anion exchange (FIG. 3h). By contrast, photocarrier diffusion between separated particles in the array of the disclosure is unlikely (FIG. 18). Instead, the maximum packing density of unique particles was limited primarily by their spacing and the confocal laser resolution. For example, certain particles in arrays were selectively irradiated to form new Cl-rich pixels (individual particles) with 3- and 2-μm spatial resolution (FIG. 3i-3j). By further decreasing the array spacing, unique features were prepared<1 μm apart (FIG. 3k-3l, FIG. 19). Spatial confinement using small crystals may be a promising strategy to pattern features with a high density of distinct compositions (>1 unique particle/μm²) below the apparent limits defined by diffusion in larger single crystals. In addition, other mixed halide compositions can be spatially encoded with corresponding anion exchange reactions. For example, using an I-exchange solution, mixed CsPb(Br/I)₃ arrays were synthesized with Br-rich and I-rich particles represented by green- and red-channel emission, respectively (FIG. 3m, color not shown).

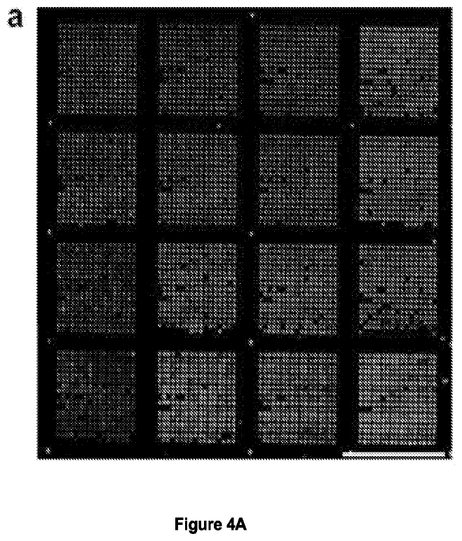

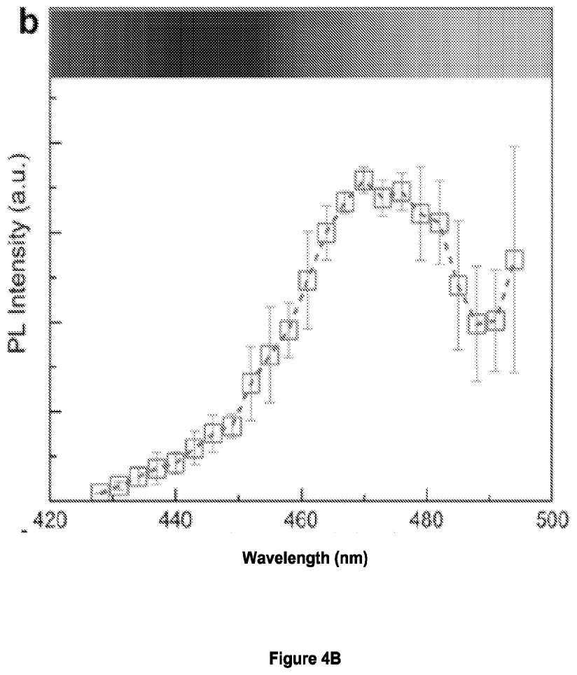

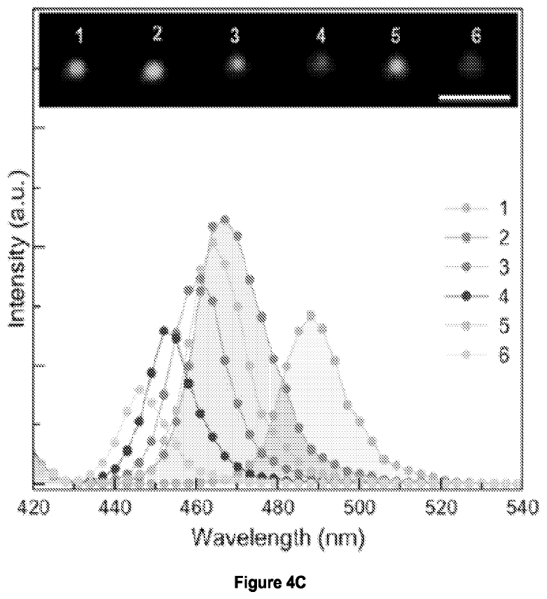

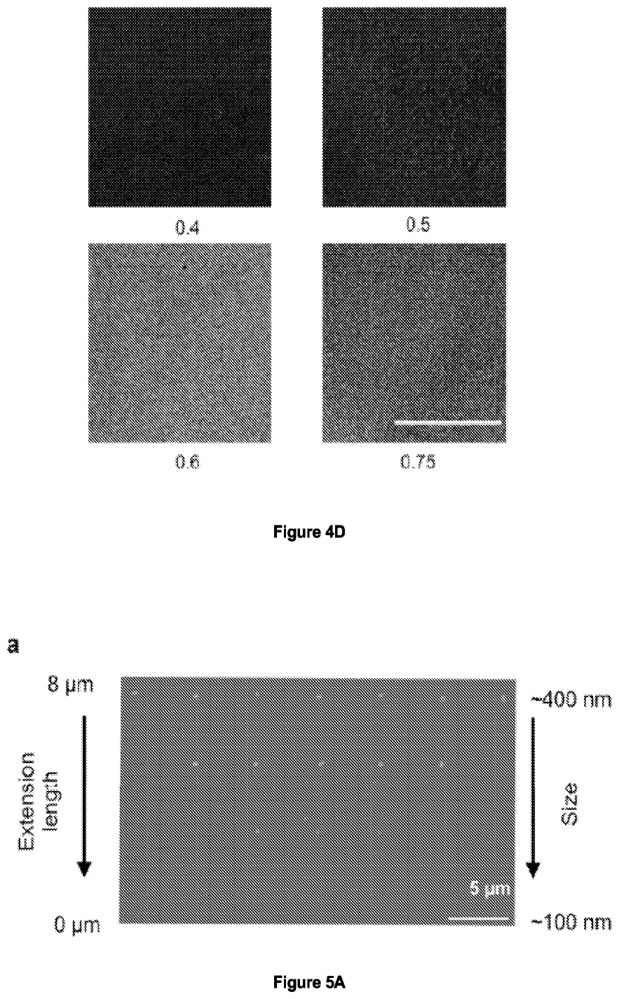

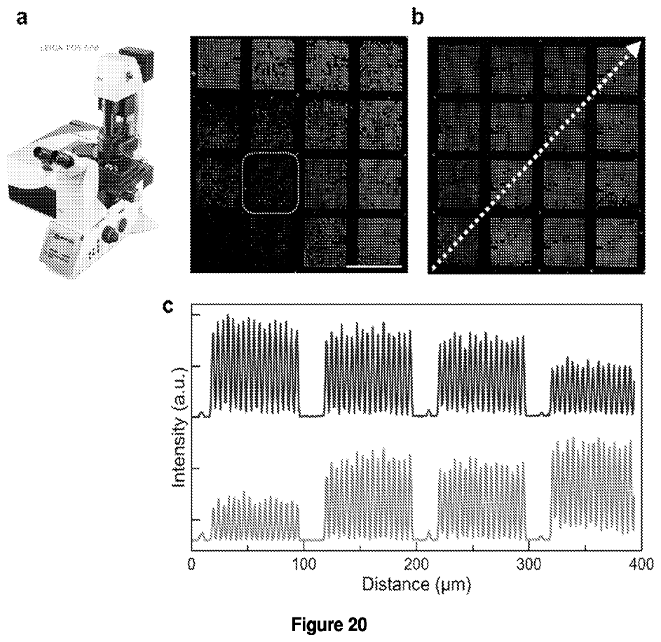

These single-particle MHP combinatorial libraries that encode both composition and size at high spatial resolution are an ideal platform for the rapid screening of particular properties for fundamental studies or applications. The discovery of efficient blue-emitting halide perovskites is a bottleneck to developing all-perovskite full-color displays, and much effort has been devoted to synthesizing blue-emitting MHPs of different compositions, sizes, and structures. However, each new composition is typically discovered via repetitive, synthetic trial-and-error, rather than through single, high-throughput screening experiments. As a proof-of-concept, a CsPb(BrₓCl₁₋ₓ)₃ library was screened for high-efficiency blue photoemission. First, a library of approximately 400-nm CsPbBr₃ particles was generated with 8-μm extension length during the EC-PPL process. Next, these CsPbBr₃ particles were rapidly exposed to a continuous-wave 405-nm laser using scanning confocal microscopy. Vacancy generation was evidenced by the observed decrease in PL intensity (FIG. 20a). After anion exchange, a CsPb(BrₓCl₁₋ₓ)₃ composition gradient formed, consisting of 16 arrays with over 4,000 total particles (FIG. 4a, FIG. 20c). Confocal PL mapping was then used to collect the PL spectra of every particle in the array individually (acquisition time typically <2 min), allowing the average PL intensity as a function of the peak wavelength for the CsPb(BrₓCl₁₋ₓ)₃ particles to be plotted (FIG. 4b). In general, Cl-rich compositions have lower PL peak intensities centered at lower wavelengths (for example, CsPb(Br_{0.12}Cl_{0.88})₃ at 425 nm), consistent with the low PL efficiency of Cl-based perovskites. As the Cl:Br ratio decreased, the PL peak wavelength and intensity increased until a maximum PL intensity was attained for CsPb(Br_{0.60}Cl_{0.40})₃ particles at approximately 470 nm. These screening results imply that this previously sparsely studied composition, CsPbBr_{0.60}Cl_{0.40}, has the highest blue PL intensity among the other compositions in the vast CsPb(BrₓC₁₋ₓ)₃ space. To confirm this result, a finer screen was performed with a smaller range of CsPb(BrₓC₁₋ₓ)₃ compositions. The selected particles (1-6) had PL emission peak locations ranging from approximately 445 to 490 nm (FIG. 4c). Among them, particle 2 (approximately CsPb(Br_{0.60}Cl_{0.40})₃) had the highest PL intensity with a peak centered at approximately 467 nm.

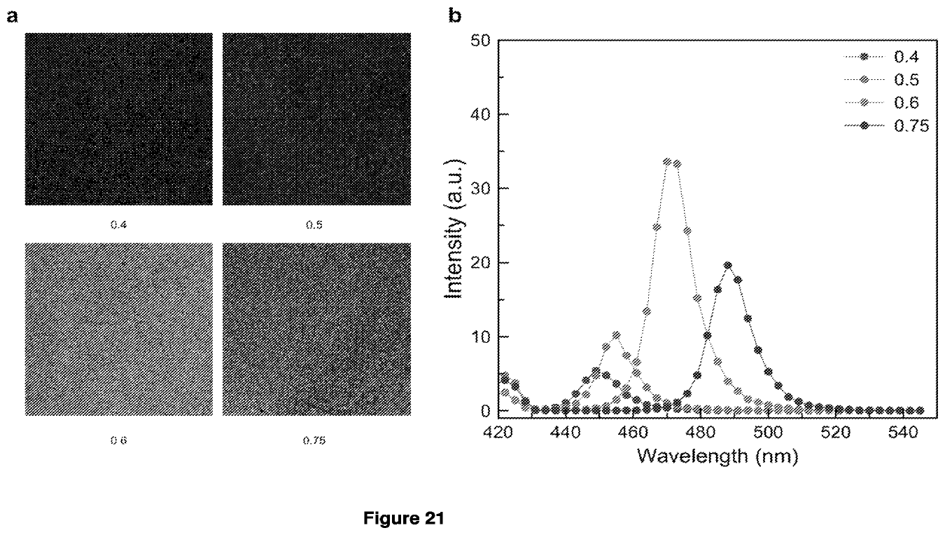

Finally, to investigate whether these results are generalizable, thin-films with compositions of CsPb(BrₓCl₁₋ₓ)₃ (x=0.4, 0.5, 0.6, 0.75) were prepared via spin coating. The emission from the CsPb(Br_{0.60}Cl_{0.40})₃ system showed the most intense PL emission (FIG. 4d). The peak wavelengths and relative intensities of the PL spectra of these thin films (FIG. 21) matched those of the particle compositions in the array (FIG. 4b-4c), demonstrating that this optical screening method is directly applicable to bulk thin film systems as well.

Methods of the disclosure provide a high-throughput combinatorial approach to spatially program the compositions of individual single crystal particles in MHP megalibraries. The halide vacancy concentration can be tuned via laser exposure, due to strong photocarrier-lattice interactions, and along with particle size, can be used to dictate final particle composition after subsequent anion exchange. This new high-throughput screening platform is materials—general, and therefore can be extended to many more unique compositions, sizes, and structures. For example, this technique is amenable to the exploration of new compositions formed by incorporating multiple cations in the A or B site in the ABX₃ structure (such as Cs⁺-MA⁺, Cs⁺-FA⁺, Pb²⁺—Sn²⁺) via cation exchange reactions; other heterostructures and ionic semiconductors also can be formed. This platform is integral to realizing a big-data approach to materials discovery and investigating the vast composition-structure landscape where fundamental insight is currently lacking. And yet, given the high-resolution and high-throughput nature of this technique, and its ability to encode composition with position in an array, this process may indeed be valuable in the creation of practical devices, such as ultrahigh pixel density displays, sensors, and data storage components. As a result, the platform reported here will substantively impact the fundamental study of halide perovskites and their utilization in next-generation optoelectronic devices.

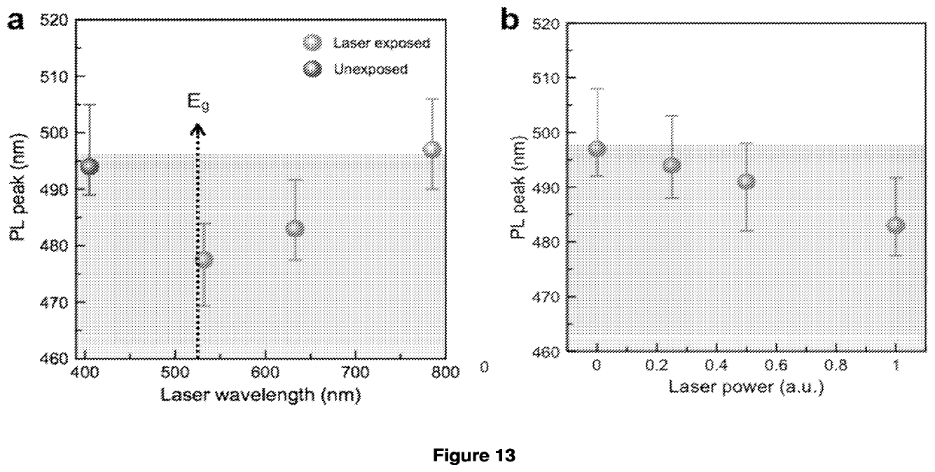

In FIG. 12, no photocarrier recombination was observed in PL spectrum with sub-bandgap laser exposure, but the CsPbBr₃ particles still showed decreased PL intensity, indicating the increased V_{X}⁺ concentration. Based on the PL spectra after anion exchange, a low concentration of laser-induced V_{X}⁺ formation was observed with the intermediate sub-bandgap 532-nm and 633-nm lasers (FIG. 13). This small increase in the V_{X}⁺ concentration without photocarriers can be explained using a phonon-promoted Frenkel defect reaction³ (Eq. 1) known to occur spontaneously in perovskite lattices:

$${X}_{X} \to {V}_{X}^{+} + {X}_{i}^{-} \qquad [ 1 ]$$

where X_{X} is the halide anion in its own crystal site, Xᵢ⁻ is the halide anion in the interstitial space, and V_{X}⁺ is the halide vacancy. According to this mechanism, Raman excitation enhances the magnitude of the displacement fluctuations of X_{X}, which promotes the vacancy formation reaction (Eq. 1). This process results in a relatively small V_{X}⁺ concentration because the charged Xᵢ⁻ has a high formation energy and the accumulated Xᵢ⁻ significantly hinders the formation of more V_{X}⁺. This mechanism is further supported by the observation of an increase in vacancy formation with phonon mode intensity (FIG. 14). Therefore, strong Raman-active vibration results in an increased V_{X}⁺ concentration (FIG. 2c). It is worth noting that the laser-induced vacancies enabled by the 532-nm and 633-nm lasers have much lower concentrations than those enabled by the 473 nm laser. For example, based on the PL spectra after anion exchange, the laser-induced V_{X}⁺ concentration by the 633-nm laser with 20 mW×200 s is almost equivalent to that induced by the 473-nm laser with 0.25 mW×200 s.

Notably, the use of the phonon excitation alone to modify the halide vacancy concentration in CsPbBr₃ has not been demonstrated yet; however, it alone cannot explain the significantly higher vacancy concentrations observed under higher-energy laser illumination.

Without intending to be bound by theory, it is believed that the presence of photocarriers promotes vacancy formation by neutralizing the charged anion, forming Xᵢ⁰ via the combination of photo-generated holes h⁺ with charged interstitial halide ions Xᵢ⁻, in the defect reaction:

$${X}_{X}^{0} + {h}^{+} \to {V}_{X}^{+} + {X}_{i}^{0} \qquad [ 2 ]$$

Per this reaction, a high-density of photo-generated holes favors V_{X}⁺ formation (Eq. 2). In addition, since the maximum stable concentration of uncharged Xᵢ⁰ in the lattice is higher than the concentration of charged Xᵢ⁻ ions, this reaction represents a significant route for accommodating excess vacancies. Further, the potential to form diatomic gas molecules X₂⁰ from neutralized Xᵢ⁰ also promotes V_{X}⁺ formation when the lattice is saturated with Xᵢ⁰ per the following reaction:

$$2 {X}_{i}^{0} \to {X}_{2}^{0} \qquad [ 3 ]$$

The possible escape of gaseous X₂⁰ from the lattice promotes the forward direction of this reaction, and therefore it prevents an excessive build-up of Xᵢ⁰, which in turn favors the forward direction of the preceding reaction (Eq. 2). The strong photocarrier-lattice interactions (Eq. 2 and Eq. 3), and the vacancy formation that is promoted as a result, accurately predict a significant increase in V_{X}⁺ concentration compared to the case where pure phonon excitation was achieved or laser exposure did not occur (FIG. 2d).

A decrease in PL efficiency was observed in MAPbX₃, which was attributed to an increase in the iodide vacancy concentration,⁵ analogous to our observations. However, high-intensity light induced (partial) decomposition to MAX and PbX₂. The intrinsic instability of organic-inorganic hybrid perovskites makes it challenging to control vacancy concentration without laser-induced decomposition as demonstrated with all-inorganic CsPbBr₃.

Without intending to be bound by theory, it is believed that the presence of photocarriers promotes vacancy formation by neutralizing the charged anion, forming Xᵢ⁰ via the combination of photo-generated holes h⁺ with charged interstitial halide ions Xᵢ⁻, in the defect reaction:

$${X}_{X}^{0} + {h}^{+} \to {V}_{X}^{+} + {X}_{i}^{0} \qquad [ 2 ]$$

Per this reaction, a high-density of photo-generated holes favors V_{X}⁺ formation (Eq. 2). In addition, since the maximum stable concentration of uncharged Xᵢ⁰ in the lattice is higher than the concentration of charged Xᵢ⁻ ions, this reaction represents a significant route for accommodating excess vacancies. Further, the potential to form diatomic gas molecules X₂⁰ from neutralized Xᵢ⁰ also promotes V_{X}⁺ formation when the lattice is saturated with Xᵢ⁰ per the following reaction:

$$2 {X}_{i}^{0} \to {X}_{2}^{0} \qquad [ 3 ]$$

The possible escape of gaseous X₂⁰ from the lattice promotes the forward direction of this reaction, and therefore it prevents an excessive build-up of Xᵢ⁰, which in turn favors the forward direction of the preceding reaction (Eq. 2). The strong photocarrier-lattice interactions (Eq. 2 and Eq. 3), and the vacancy formation that is promoted as a result, accurately predict a significant increase in V_{X}⁺ concentration compared to the case where pure phonon excitation was achieved or laser exposure did not occur (FIG. 2d).

A decrease in PL efficiency was observed in MAPbX₃, which was attributed to an increase in the iodide vacancy concentration,⁵ analogous to our observations. However, high-intensity light induced (partial) decomposition to MAX and PbX₂. The intrinsic instability of organic-inorganic hybrid perovskites makes it challenging to control vacancy concentration without laser-induced decomposition as demonstrated with all-inorganic CsPbBr₃.

Based on the aforementioned defect reactions for vacancy formation:

$${X}_{X}^{0} + {h}^{+} \to {V}_{X}^{+} + {X}_{i}^{0} \qquad [ 2 ]$$

$$2 {X}_{i}^{0} \to {X}_{2}^{0} \qquad [ 3 ]$$

Applying a quasi-steady state equilibrium assumption for the reactions during illumination gives the equilibrium constants:

$${K}_{1} = \frac{[ {X}_{i}^{0} ] [ {V}_{x}^{+} ]}{[ {h}^{+} ]}$$

$${K}_{2} = \frac{{X}_{2}^{0}}{{[ {X}_{i}^{0} ]}^{2}}$$

[X_{X}] can be considered to be constant throughout the process. If a constant concentration of Xᵢ⁰ in the solid lattice is considered because of reaction 3, the concentration [V_{X}⁺] is determined by [h⁺].

The photo-generated hole concentration [h⁺] is directly determined by: the input light power, crystal size L (approximately 400 nm), CsPbBr₃ absorption coefficient (a) at the excitation laser wavelength⁷ (α≅1×10⁵ cm⁻¹ at 473 nm in the experiment), and the incident light intensity I₀. According to the Beer-Lambert law, the absorbed photon energy is =I₀(1−exp(−αL)).

Therefore, the photo-carrier generation rate is:

$$G = {I}_{0} ( 1 - exp ( - α L ) ) / h ν .$$

Next, the steady state carrier density n=[h⁺] when

$$\frac{dn}{dt} = 0$$

was considered, because the bimolecular charge recombination and Auger recombination lifetimes are much shorter than the laser exposure time scale in our experiments,⁹.

$$\frac{dn}{dt} = G - {k}_{1} n - {k}_{2} {n}^{2} - {k}_{3} {n}^{3}$$

where k₁ and k₂ are the monomolecular and bimolecular charge recombination rate constants, respectively, and k₃ is the Auger recombination rate constant¹⁰. Therefore,

$${I}_{0} ( 1 - exp ( - α L ) ) / h ν = {k}_{1} n - {k}_{2} {n}^{2} - {k}_{3} {n}^{3}$$

Thus, I₀ determines [h⁺] and is directly correlated with [V_{X}⁺] induced from laser excitation.

The solution Cl⁻ exchange process of CsPbBr₃ arrays involves two steps: (1) solution-surface exchange: Cl⁻ in solution diffuses and reacts on the surface of the particles; (2) solid-solid interdiffusion: Cl⁻ interdiffuses with Br in the solid lattice. Solution-surface exchange is mainly related to Cl⁻ concentration in solution and temperature for mesoscale nanoparticles, and the Cl⁻ concentration in solution and temperature are the same for the entire array during exchange. In addition, solution-surface exchange is much faster than solid-solid interdiffusion. Therefore, without intending to bound by theory, it is believed that that solid-solid interdiffusion dictates anion exchange kinetics. The diffusion coefficient D(x) is dynamic and inversely related to x. The Cl⁻ concentration in solution can be considered constant with x=1. When the Cl concentration in the solid crystal is low, the large concentration gradient offers a high D(x). As the x increased in the solid crystal, D(x) decreased^{11,12} For example, net Cl⁻ diffusion is not expected between the solution and solid when x=1. So, D(1)=0. Here, a diffusion model of Cl⁻ exchange with a certain perovskite cube-shaped crystal (size of L) isotropically from all directions with a semi-infinite model: l≅2\sqrt{D(x)t} was considered. As shown in time space, the concertation change speed (the slope in FIG. 15a) becomes smaller due to the decrease of D(x) as the anion exchange proceeds, regardless of particle size. At a certain time, a higher Cl concentration was expected for a smaller L if considering the same exchanged Cl moles with the a similar diffusion length l. Therefore, x decreases as L increased as shown in crystal size space (FIG. 15b).

It was observed large (>2 μm) feature dimensions under laser exposure of bulk CsPbBr₃ microcrystals (much larger than the laser spot) based on SEM and PL imaging (FIG. 3g, FIG. 7). This parameter significantly limits the composition resolution, or maximum density of unique compositions (FIG. 3h), when using bulk perovskite materials to screen for properties. Without intending to be bound by theory, it is believed that there are two possible reasons for the large feature sizes in bulk materials: (1) photon-generated carrier diffusion during the vacancy formation process; (2) halide vacancy and anion migration after primary carrier formation.

First, photo-carriers in CsPbBr₃ have a remarkably long diffusion length (>2 μm) and high mobility in the crystal lattice. According to the laser-induced vacancy formation mechanism, diffusive photo-carriers induce vacancy formation, resulting in a larger defect area in these bulk crystals. Second, halide vacancies also have fast diffusion kinetics in the lattice, further increasing the region of high vacancy concentration. Therefore, even with high-resolution multi-halide compositions formed in bulk crystals, the fast anion interdiffusion would lead to well-mixed structures as reported for heterostructures previously.

In contrast, the isolated single-particle arrays produced in accordance with the disclosure overcome the resolution limit observed in the bulk system. Photo-carriers and halide vacancies cannot migrate between individual particles due to their spatial confinement. As a result, this process enables submicron composition resolution within the patterned arrays.

### Mixed Halide Solid Solutions

Certain mixed halide perovskites composition, such as mixed Cs-FA based systems have been reported to either mix or phase-segregate without consensus as to the contributing factors for this behavior. Without intending to be bound by theory, it is believed that the behavior may be attributed to the balance between the soft lattice, which accommodates strain and facilitates mixing, and the fact that the large size mismatch between the two cations (R_{Cs}=1.74 Å, R_{FA}=2.77 Å, or (R_{FA}−R_{Cs})/R_{Cs}=59%) creates substitutional strain and free energy penalty for mixing. As detailed herein, it has been observed that varying the synthetic conditions enables modulation of the magnitude of this energy barrier, allowing methods of the disclosure to provide a robust strategy for controlling the resultant degree of ion mixing.

Mixed halide perovskites in accordance with this embodiment of the disclosure are compounds of formula I: A′₁₋ₓA″₁₋ₓBX₃, wherein A′ is a first cation; A″ is a second cation, wherein A′ and A″ are different cations, B is a metal, X is at least one halogen, and 0<x<1. The lateral heterostructure comprises an A′ rich phase in a central region of the crystal, surrounded partially by a″ rich phase.

For example, the mixed halide perovskite of the disclosure can be Cs₁₋ₓFAₓPbX₃, wherein X is one or more of Cl, Br, and I, and 0<X<1. The mixed halide perovskites heterostructures of the disclosure have a lateral structure morphology wherein an A′ phase is concentrated in the center and a″ phase is arranged in the edge regions of the crystal structure. In systems further including a mixed anion, anion segregation was also observed. Mixed halides perovskite heterostructures in accordance with the disclosure can have distinct photoluminescence (PL) signals attributed to the segregation, with a first PL peak in a central region of the crystal and a second PL peak on an edge region. In heterostructures of the disclosure, the central peak can be entirely attributable to the A′ cation perovskite, indicating that no A″ phase is covering the central region. That is, the A″ phase borders and surrounds only a portion of the A′ phase, such as boarding a perimeter portion, but leaving the top portion uncovered.

A′ and A″ can be either organic or inorganic. For example, A′ and A″ can be independently selected from methylammonium, butylammonium, formamidinium, phenethylamine, 3-(aminomethyl)piperidinium, 4-(aminomethyl)piperidinium, cesium, and rubidium.

B can be a metal cation. For example, B can be one or more of lead, tin, europium, and germanium.

In embodiments, X can halogen, including any one or more of F, Cl, Br, and I. The halogen in the precursors can be the same or different depending on the halide structure desired. In mixed halide perovskites having multiple anions, the anions are present in an atomic ratio adding 1. For example, in a two-anion system, for example, the composition can be A′₁₋ₓA″₁₋ₓB(X′_{1-y}X″_{y})₃, where 0<y<1.

Lateral heterostructure of the disclosure can be produced using a two-step solution growth method, which includes depositing the constituent perovskite ions dissolved in a solvent onto a substrate followed by unconfined microcrystal growth during solvent evaporation. For example, a method of forming mixed halide perovskite crystals having a lateral heterostructure in accordance with the disclosure can include dissolving at least one first one first perovskite precursor having the formula A′X′, at least one second perovskite precursor having the formula A″X″ and at least one third perovskite precursor having the formula BX″₂ in a solvent to form a precursor solution, wherein A′ and A″ are each cations and are different cations, B is a metal, and X, X′, X″ are each a halogen and can each be the same or different. The precursor solution is then deposited onto a substrate. EC-PPL can be used for depositing the precursor solution on a substrate. This can be particularly advantageous when forming combinatorial libraries or arrays of the mixed halide perovskites. EC-PPL for forming single cation halide perovskite is described in International Patent Application Publication NO. WO 2021/188168, the disclosure of which is incorporated herein by reference, for single A-site cation perovskites. Conditions and alternatives described therein can be adapted to the methods of the disclosure using the precursor solution described herein. The method then further include evaporating the solvent, wherein the mixed halide perovskites nanocrystal form upon evaporation of the solvent. The crystals form in two stages, the first stage being a A′-X′-rich perovskite phase and the second stage being a A″-X″-rich perovskite phase partially surrounding the A′-X′-rich perovskite phase

When EC-PPL is used, the deposited pattern of indicia form nanoreactors on the substrate and the mixed halide perovskite crystals nucleate and grow within the nanoreactors. Depositing the printed indicial using EC-PPL generally includes contacting a substrate with the coated pen array to thereby deposit the precursor solution as a pattern of printed indicia on the substrate.

In the precursor solution, X′, X″, and X′″ are the same halogen when a single anion mixed halide perovskite is being formed. When a multiple-anion mixed halide perovskite is being formed, the halogens are different and include each of the anions to be included in the final crystal. Each of the different halogens is included in each of the third precursors with the metal (B). For example, in a two-anion system, X′ and X″ are different halogens and the at least one third precursor can include both a precursor of formula BX′ and a precursor of formula BX″.

The solvent can be one or more of one or more of dimethyformamide (DMF), dimethyl sulfoxide (DMSO), y-butyrolactone (GBL), and sulfolane. A combination of solvents can be used, for example, sulfolane and DMSO. For example, the sulfolane and DMSO can be combined in a solvent ratio of about 7:3. The solvent or combination of solvents is selected such that the halide perovskite precursor can be dissolved in the solvent. In embodiments, the solvent or solvent combination is further selected to have a low vapor pressure. Without intending to be bound by theory, it is believed that using solvents with low vapor pressure can improve the crystal quality.

The solvent can have a vapor pressure at 25° C. of 400 Pa or less, 380 Pa or less, or 360 Pa or less. For example, the vapor pressure at 25° C. can be about 50 Pa to about 400 Pa, about 56 Pa to about 380 Pa, about 100 Pa to about 300 Pa, about 50 Pa to about 100 Pa, or about 60 Pa to about 200 Pa. Other suitable vapor pressures at 25° C. can be about 50, 52, 54, 56, 58, 60, 65, 70, 75, 80, 85, 90, 95, 100, 110, 120, 130,140, 150, 160, 170, 180, 190, 200, 210, 220, 230, 240, 250, 260, 280, 300, 310, 320, 330, 340, 350, 360, 370, 380, 390, or 400 Pa.

The solvent can have a viscosity of about 0.9 cP to about 10.1 cP, about 0.9 cP to about 5 cP, about 1 cP to about 8 cP, about 4 cP to about 10 cP. Other suitable amounts include about 0.9, 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, 5, 5.2, 5.4, 5.6, 5.8, 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10, and 10.1 cP

The precursor solution can be printed on any suitable substrate. For example, the substrate can be glass, ITO-coated glass, silicon, silicon oxide thin films, quartz, silicon nitride, or carbon. The substrate can be surface treated in embodiments. For example, the substrate can be surface treated with hexamethyldisiliazne (HMDS), octadecyltrichlorsilane (OTS), or polyvinylcarbazole (PVK). In embodiments, the substrate can be treated with a fluoropolymer. For example, the substrate can be treated with a fluoropolymer by reactive ion etching from CHF₃. The fluoropolymer surface treatment can have one or more repeating units selected from CF, CF₂, and CF₃.

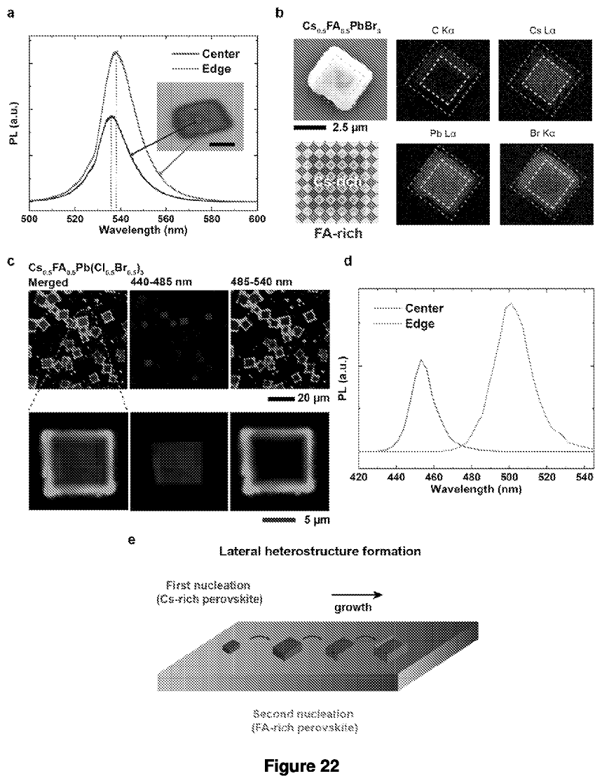

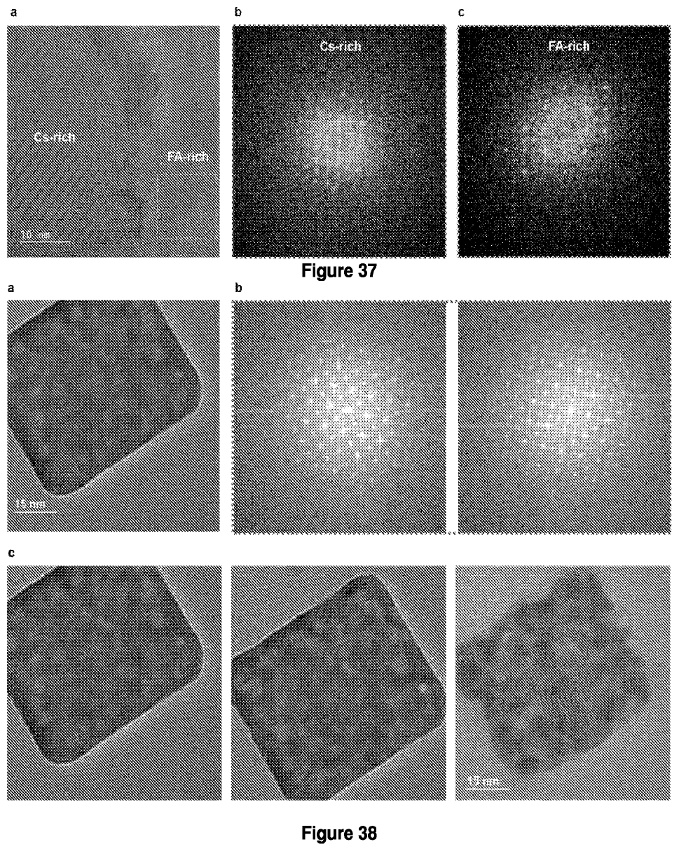

Modifying the ratio of constituent ions can be used to tail the morphology and photoluminescence of the resulting mixed halide perovskite microcrystals. For example, in Cs₁₋ₓFAₓPbBr₃, as relative FA concentration was increased, the emission peak in the PL spectra of the resulting perovskite shifted towards higher wavelengths, which is expected given that FAPbBr₃ has a smaller bandgap than CsPbBr₃. Where segregation is most pronounced (x=0.5), two should were clearly observed in the PL spectrum (FIG. 36). For the x=0.5 sample, we observed that the PL emission peaks were centered at 535-nm and 538-nm for the center and edge of the microcrystal, respectively, and a phase-boundary is optically discernible (FIG. 1A). Since CsPbBr₃ has a larger bandgap than FAPbBr₃, these spectra indicate that Cs was concentrated in the center and FA was at the edge. Elemental maps also revealed a lateral inhomogeneous Cs distribution with high Cs and C concentrations present at the microcrystal center and periphery, respectively (FIG. 22B). As the Br:Pb ratio was stable around 3:1 in both the center and edge regions (FIG. 37), the decreasing Cs:Pb ratio suggests that the FA ions were concentrated at the edges. As far as the crystal shape, the height at the edge of the crystal is slightly taller than at the center as observed by atomic force microscopy (AFM) (FIG. 38).

The perovskites are referred to herein interchangeable as “crystals” or “nanocrystals.” In any of the foregoing embodiments, the heterostructures can have a size of greater than about 60 nm to about 1000 nm, about 100 nm to about 800 nm, or about 60 nm to about 100 nm. Other sizes of nanocrystals include about 60, 65, 70, 75, 80, 85, 90, 95, 100, 150, 200, 250, 300, 350, 400, 450, 500, 550, 600, 650, 700, 750, 800, 850, 900, 950, 1000 nm. Larger crystal sizes than 1000 nm can be formed with the methods of the disclosure. However, the methods of the disclosure are particularly useful in forming small crystal sizes, which cannot be readily achieved with prior halide perovskite formation methods.

Crystal sizes below about 60 nm generally results in solid-solution mixed halide perovskites. For example, solid-solution mixed halide perovskites can have a crystal size of about 20 nm to about 60 nm, about 20 nm to about 50 nm, or about 30 nm to about 40 nm. Other sizes of nanocrystals include about 20, 25, 30, 35, 40, 45, 50, 55, 60 nm.

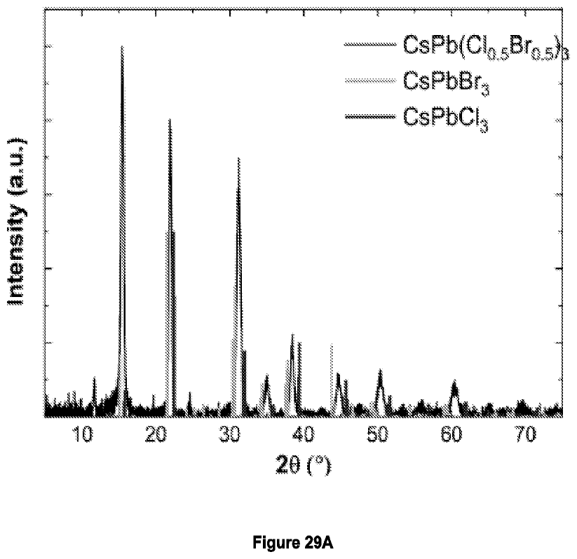

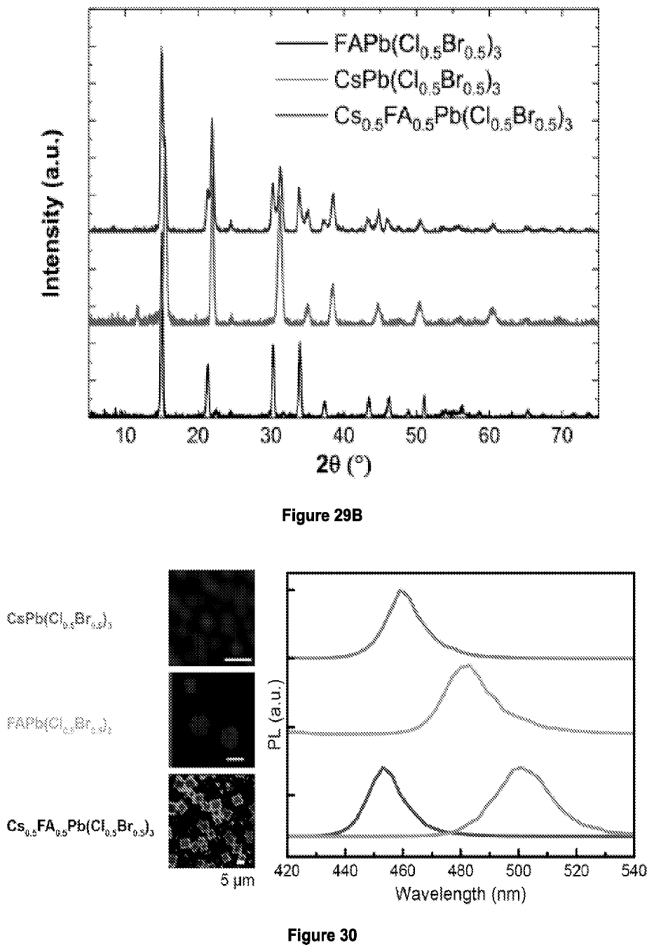

Anion segregation was also observed when a secondary anion was present. When an equal mixture of both cations and anions, Cs_{0.5}FA_{0.5}Pb(Cl_{0.5}Br_{0.5})₃, were incorporated, unique PL emission peaks were observed in Cs_{0.5}FA_{0.5}Pb(Cl_{0.5}Br_{0.5})₃ crystals (>5 mm) from both the center (450-nm) and edge (500-nm) respectively, as resolved via multi-channel confocal imaging (FIGS. 22C and 22D). The large difference in emission wavelength was indicative of anion segregation with a Cl-rich center and a Br-rich edge. X-ray diffraction (XRD) also substantiated the existence of two phases in Cs_{0.5}FA_{0.5}Pb(Cl_{0.5}Br_{0.5})₃ (FIG. 29). In contrast, in microcrystals where a single cation is used, the Cl and Br anions were well-mixed throughout (CsPb(Cl_{0.5}Br_{0.5})₃ and FAPb(Cl_{0.5}Br_{0.5})₃), implying that anion segregation in this system is dependent on A-site cation segregation (FIG. 30). As the A-site cations do not substantially alter the bandgaps of these materials (as also seen in FIG. 22A), the PL peak-shifts can be used to track and interpret the local anion concentrations. Referring to FIG. 22D, while the edge material has a distinct PL, there is no contribution from a phase of that wavelength when the center material is probed, implying there is likely no thin shell film on top of the center material.

Referring to FIG. 22E, the lateral heterostructures of the disclosure follow a step-wise crystal growth produced due to differences in solubility between each phase.

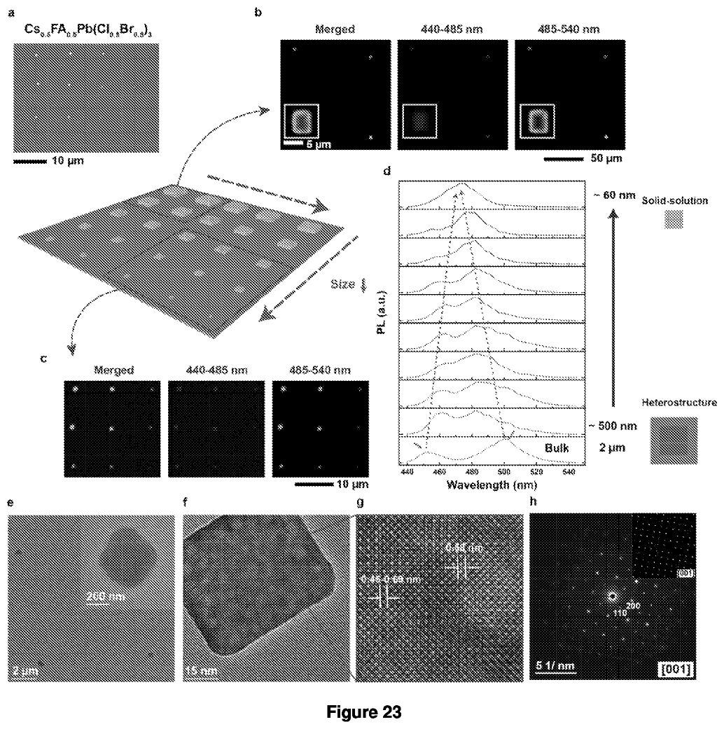

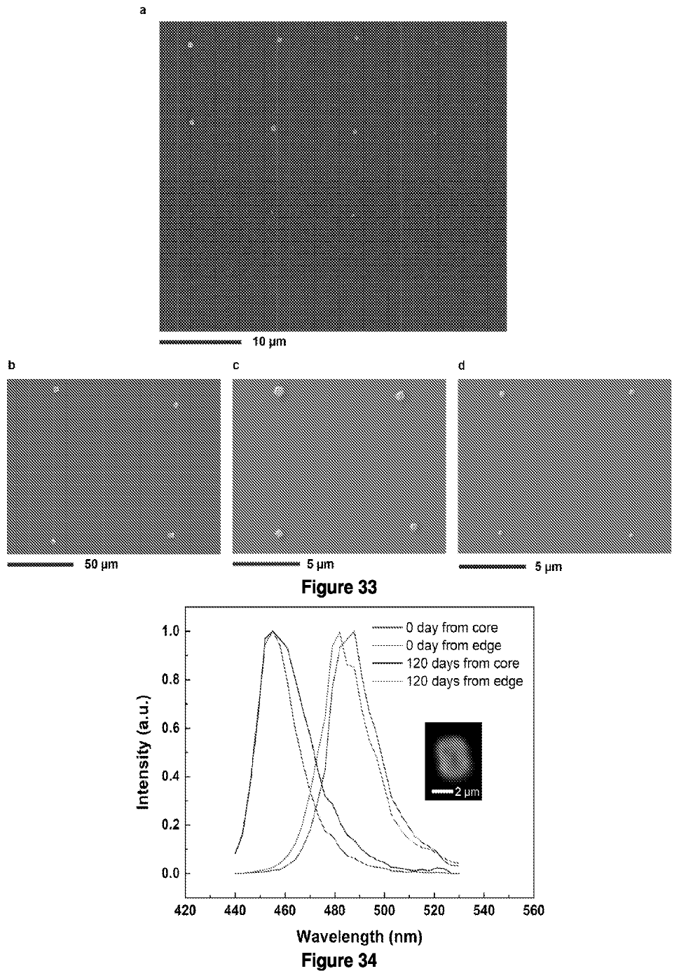

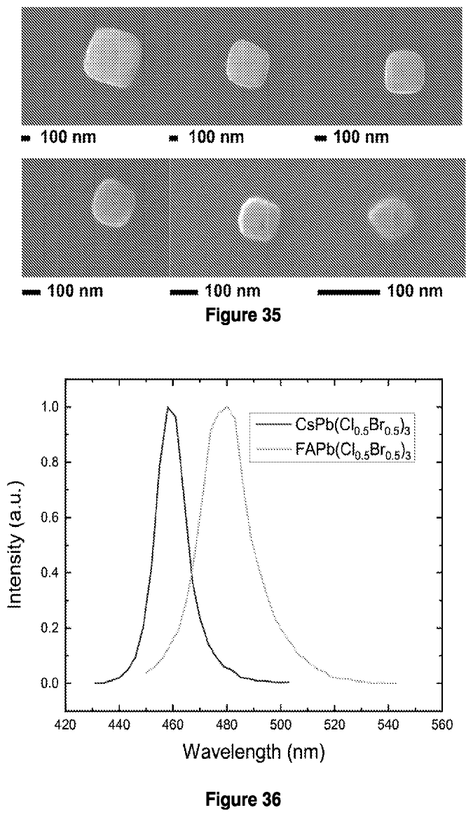

EC-PPL was used herein to generate heterostructure crystals ranging in size from micro- (up to microns) to nano down to tens of nanometers) (FIG. 23A and FIG. 33). As-synthesized Cs_{0.5}FA_{0.5}Pb(Cl_{0.5}Br_{0.5})₃ crystals (˜2 mm) from EC-PPL showed a clear heterostructure morphology (FIG. 23B). The PL observed was persistent, with emission spectra that did not significantly change even after 120 days in ambient conditions, supporting the notion that these heterostructure crystals (˜2 mm) are stable at room temperature without noticeable ion-migration (FIG. 34). As the size of Cs_{0.5}FA_{0.5}Pb(Cl_{0.5}Br_{0.5})₃ crystals decreased, a PL emission transition was observed (FIGS. 23C and 23D) and was correlated with their morphology. For the crystals in this array (approximately 500 nm), two PL peaks were observed (461 and 483-nm), implying that two ion-segregated phases were still present in individual particles. However, these peaks were either slightly red-shifted or blue-shifted compared to those of the larger microcrystal heterostructures (450 and 500-nm in FIG. 22D, respectively), likely because the degree of ion mixing increases with decreasing size. As the crystallite size decreased to approximately 60 nm, a single PL emission peak centered at 474-nm was observed (FIG. 23D), suggesting a gradual transition in morphology from the heterostructure to a well-mixed solid-solution (FIG. 35). In contrast, single-cation arrays from CsPb(C_{0.5}Br_{0.5})₃ or FAPb(Cl_{0.5}Br_{0.5})₃ particles synthesized by EC-PPL exhibited single peaks in their emission spectra for all particle sizes studied, and the observed PL peak wavelengths match reported values (FIG. 36). Given that the entire nanocrystal was excited, it was difficult to probe the local PL emission from the centers and edges of the nanocrystals, as the particles were smaller than the resolution of the confocal microscope and the size of the laser spot.

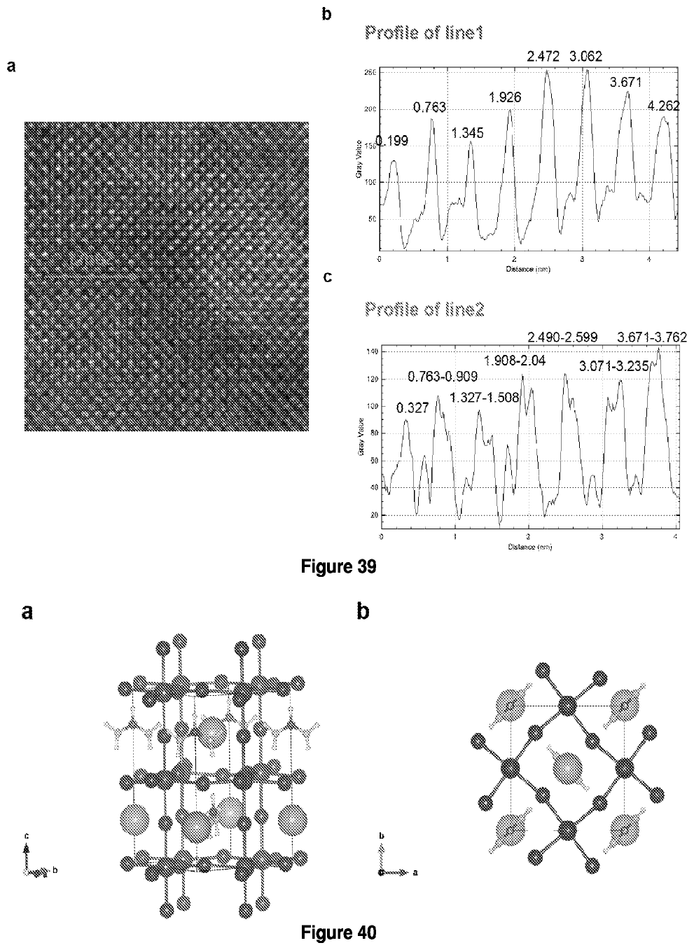

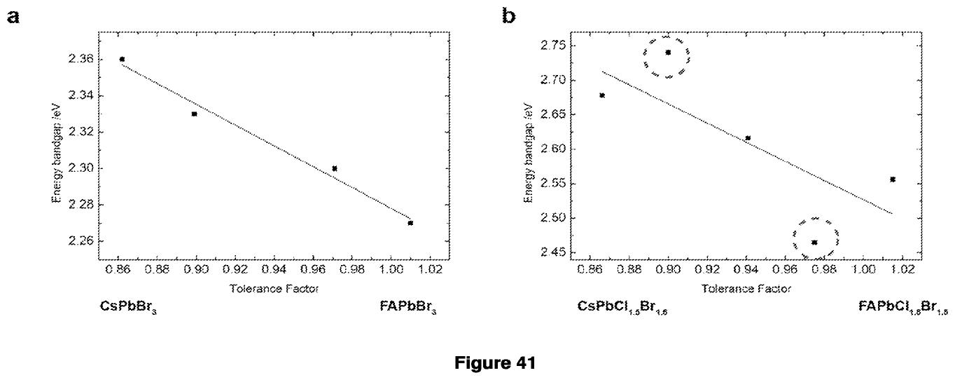

Transmission electron microscopy (TEM) and selected-area electron diffraction (SAED) were used to determine whether structural differences arise between the heterostructure and the solid-solution phases by patterning crystals directly onto a TEM grid (FIG. 23E). The crystalline structure of regions near the edges and centers of the larger heterostructure Cs_{0.5}FA_{0.5}Pb(Cl_{0.5}Br_{0.5})₃ crystals were clearly visible, with unique diffraction patterns as well (FIG. 23F and FIG. 37). Interestingly, for the smaller 60 nm particles, high-resolution TEM (HR-TEM) images show that the lattice spacing is not uniformly homogeneous (FIGS. 23G and 23H). However, rather than unique spacings observed near the center and edge, small localized clusters were observed randomly situated throughout the crystal, typically less than 5 nm in size (FIG. 23G). These localized clusters were distinguishable by their contrast, which changed over time during extended electron dosing (i.e., the organic component of the structure may be damaged by the beam). Given the local fast Fourier transform (FFT) analysis and their lattice parameters (FIGS. 39 and 40), these clusters suggested that Cs and FA were not completely mixed at an atomic level. However, the crystals as a whole display a single diffraction pattern, providing evidence for a global solid-solution morphology as opposed to two superimposed yet distinct phases (FIG. 23H). The microscopic origin of the obtained patterns (FIG. 40) was investigated using density-functional theory (DFT) simulations discussed below. The diffraction data suggested a global orthorhombic or tetragonal-like structure (the two are difficult to distinguish experimentally in this system), although the Goldschmidt tolerance factor suggests a cubic perovskite would be expected (˜0.94, calculated from the end members CsPbCl₃ and FAPbBr₃, FIG. 41). This result reflects the importance of cation-cation interactions in dictating the microscopic crystal arrangement.

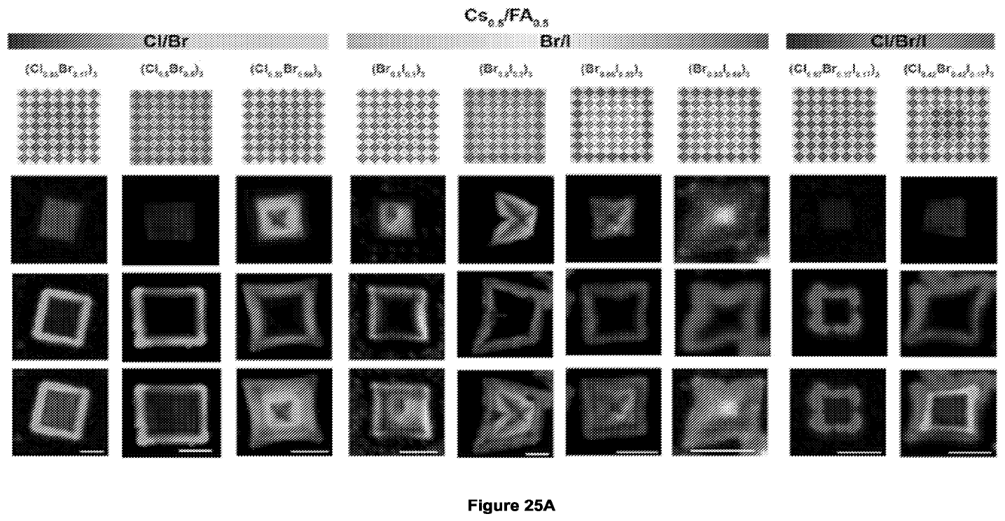

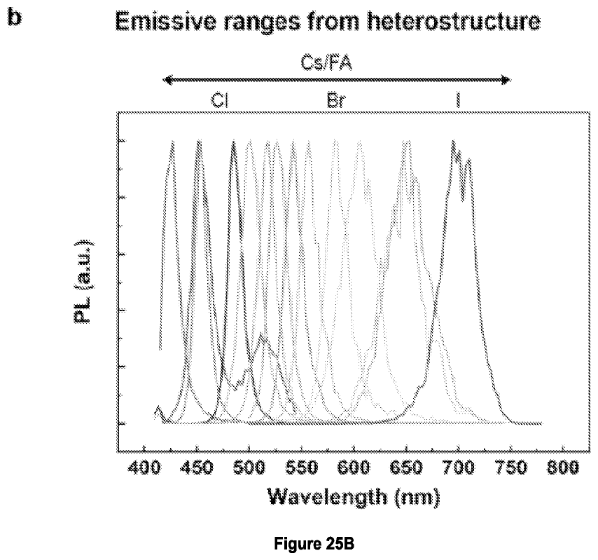

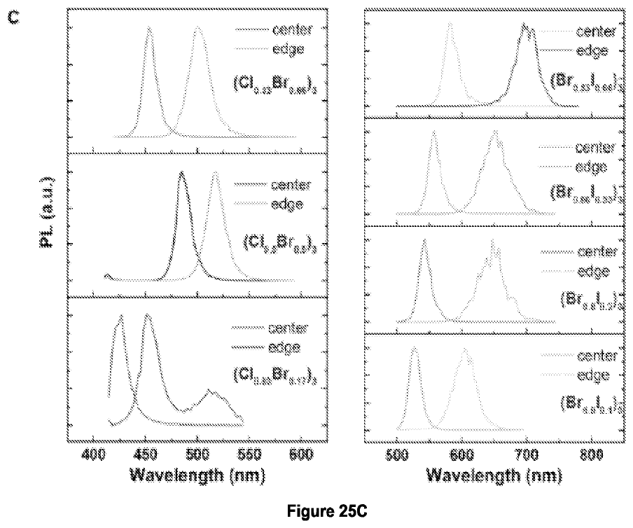

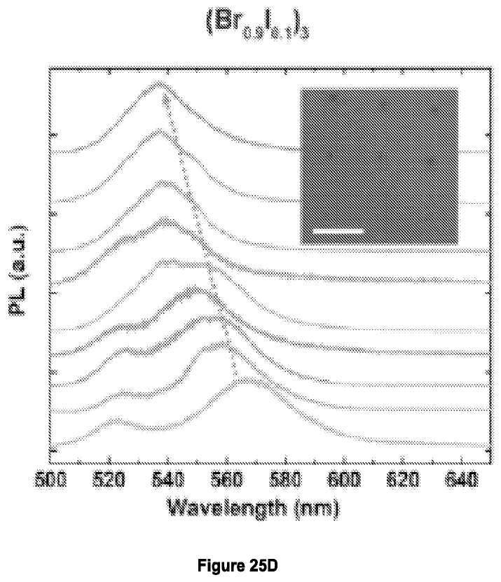

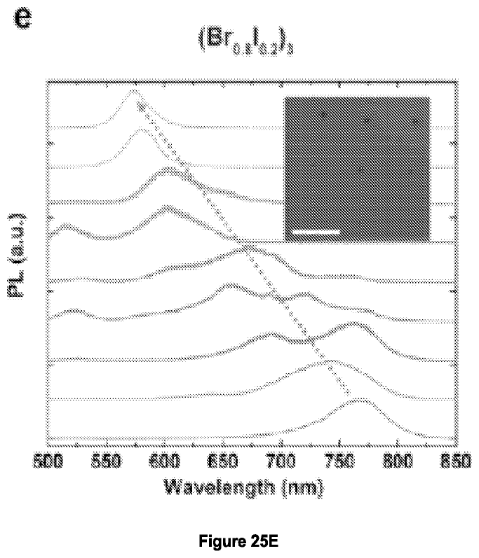

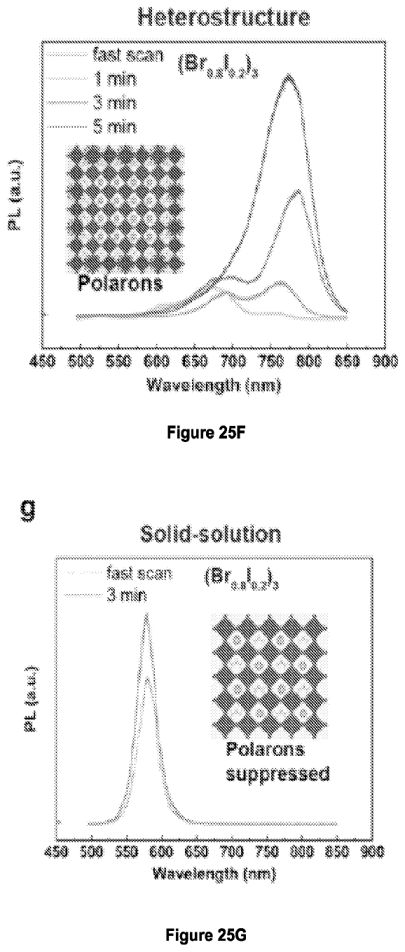

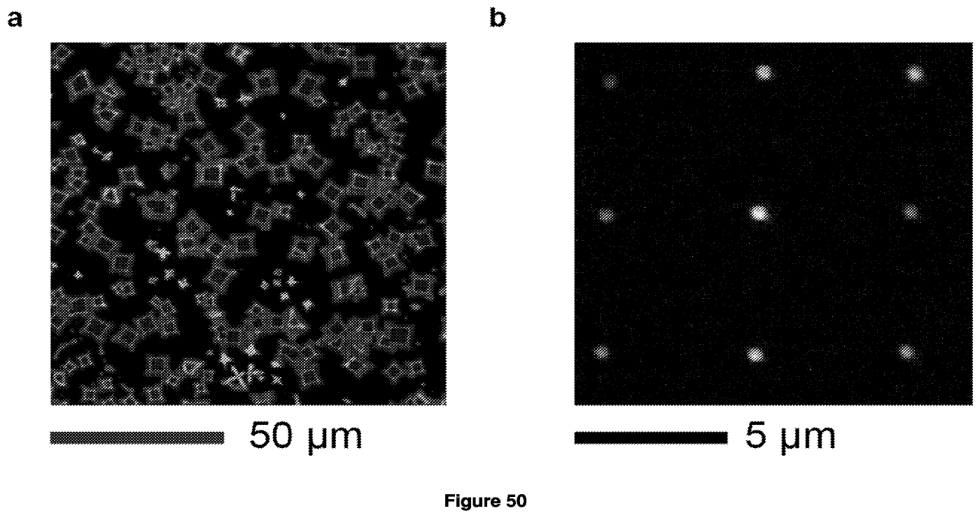

Without intending to be bound by theory, it is believed that physical confinement enabled by EC-PPL can be used for a generalized synthesis scheme for an array of precursor ions and rations. Control over particle size serves as a means of turning the particle morphology, degree of mixing and ultimately the PL. Referring to FIGS. 25A-25C, EC-PPL was used for the synthesis of a combinatorial library of heterostructures and solid-solution perovskites by extrapolating observations on their formation energy as well as varying halide anion concentrations and particle sizes. Synthesis of a variety of unique heterostructures with specific center and edge PL peaks was completed by tuning anion identity or ratios. Broader tunability of the PL peak emission centers from ˜420 to ˜700 nm was achieved. Referring to FIGS. 25D and 25E, observations made with respect to Cl, Br anion mixtures were extrapolated to Br, I mixture: Cs_{0.5}FA_{0.5}Pb(Br_{1-y}I_{y})₃. Larger microcrystals formed a heterostructure with Cs—Br rich center and a FA-I rich periphery. As the particle size decreased, solid-solution was observed optically. Incorporation of all three anions (Cl, Br, and I) in Cs_{0.5}FA_{0.5}Pb(Cl_{0.42}Br_{0.42}I_{0.17}) lead to a unique morphology consisting of a core with a double lateral shell structure. According to the PL emission, it is anticipated that the Cl anions would be present in the center, with Br anions in the inner lateral shell and I anions in the outer lateral shell. The formation energy trend suggests that Cs:FA ratio should decrease from core outwards as shown in the Table 1 below. However, due to increased complexity, precise ion distributions could not be assigned solely from the PL data (FIG. 50).

The difference in formation enthalpy can be used as a proxy to understand the energetics of the various phases available and can be achieved by comparing the energy of the FA- and Cs—phases.

$$Δ H ( F A P b {X}_{3} ) = E ( F A P b {X}_{3} ) - μ ( F A ) - μ ( P b ) - 3 μ ( X )$$

$$Δ H ( C s P b {X}_{3} ) = E ( C s P b {X}_{3} ) - μ ( C s ) - μ ( P b ) - 3 μ ( X )$$

$$Δ H ( F A P b {X}_{3} ) - Δ H ( C s P b {X}_{3} ) = E ( F A P b {X}_{3} ) - E ( C s P b {X}_{3} ) - μ ( F A ) + μ ( Cs )$$

−μ(FA)+μ(Cs) are common terms for different X, thus they can be ignored for relative comparison.

| | | Relative | |
|---|---|---|---|
| X | E(FAPbX₃) − E(CsPbX₃) | difference | |
| Cl | −41.401 eV | 0 | meV |
| Br | −41.433 eV | −28 | meV |
| I | −41.461 eV | −60 | meV |

Photo-induced anion segregation has proven to be a significant barrier to the practical use of mixed anion perovskite systems, because it results in device deterioration, especially in the APb(Br_{1-y}I_{y})₃ (A=MA or FA) compositions where 0.2≤y≤0.7. Cs-FA heterostructures crystals of the disclosure exhibited the same anion migration effect reported to result in device deterioration during photoillumination. When the as-synthesized crystals with an anion composition of y=0.2 were exposed to laser excitation for several minutes, significant red-shifts in the PL peak positions were observed (FIG. 25F), indicating photo-induced iodide-ion segregation occurred. Several models have been reported to explain photo-induced anion segregation, including based on polaron-induced lattice strain. In these heterostructures, it is likely that polarons form due to the incorporation of both Br and I, as well as the expected interfacial strain between the FA-rich peripheral layer and Cs-rich core, which enhances the electron-lattice coupling strength (as suggested in inset FIG. 25F). The polaron-induced strain stabilizes the formation of local iodide-ion enriched domains. Some researchers have reported that incorporating a mixture of organic and inorganic cations in the A-site alleviates this polaron-induced phenomenon by decreasing the degree of electron-phonon coupling, which suppresses anion segregation.

To investigate the effect of polaron-induced segregation at higher mixing fractions, small, alloyed particles with the same composition as the microcrystals, Cs_{0.5}FA_{0.5}Pb(Br_{0.8}I_{0.2})₃, were synthesized. These alloyed particles showed substantially improved stabilities under illumination (3-min accumulation) (FIG. 25G) over its heterostructure counterparts. This result demonstrates that the cation incorporation may serve as a general strategy to mitigate light-induced anion segregation in mixed Br_{y}/I_{1-y} crystals. Above all, these results highlight how rational mixing strategies can enable design of crystals that provide the best combination of stability and performance.

### Density Functional Theory Analysis

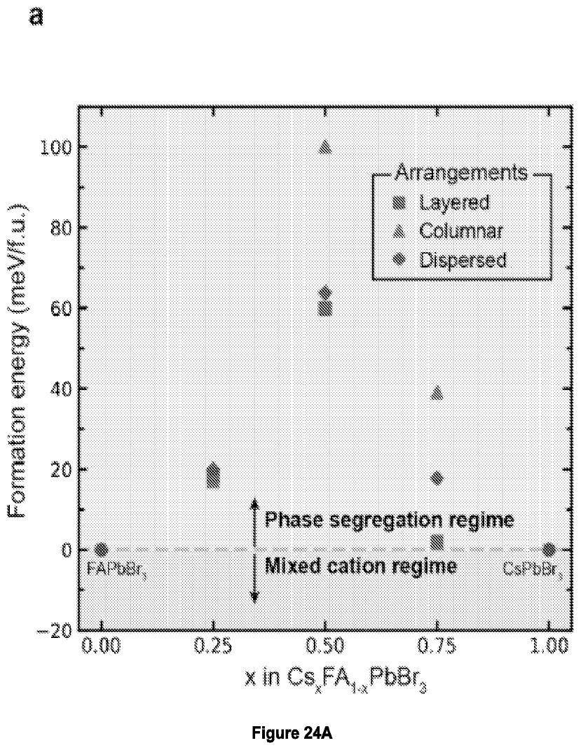

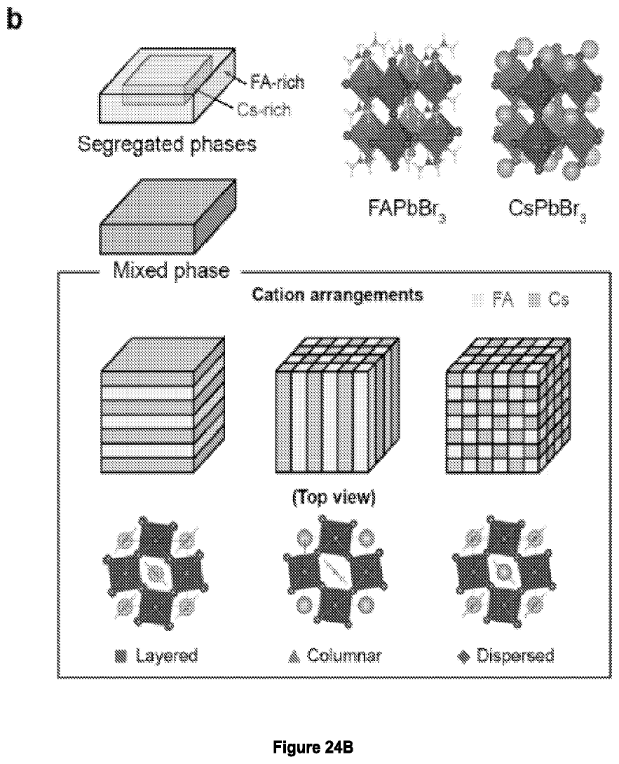

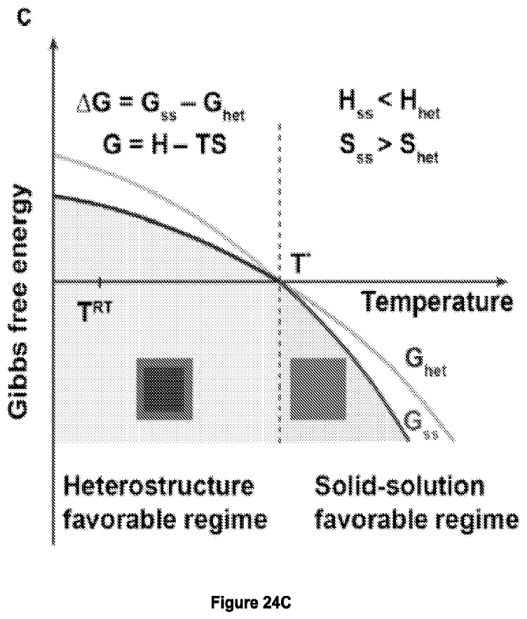

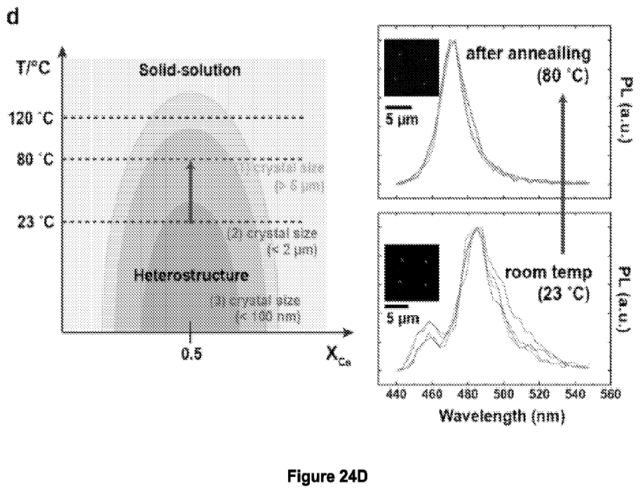

Density functional theory (DFT) calculations were employed to understand the thermodynamics governing the cation segregation observed in the Cs₁₋ₓFAₓPbX₃ (0≤x≤1, X=Cl, Br, I) perovskites. Positive formation energies were found among all surveyed cation arrangements on the A-site (FIG. 3a; ΔE>0 at 0 K). This trend indicates a persistent energetic preference towards cation segregation in Cs₁₋ₓFAₓPbX₃ at the bulk level. This prediction is in agreement with the segregation experimentally observed in the microcrystals described herein. In addition, the formation energy is significantly larger at x=0.5 compared to other compositions, and at x=0.25 there was a considerable variation in formation energy depending on the cation arrangement (FIG. 24B). It was observed that the formation energy was sensitive to the shape and size of the A-site cage formed by the surrounding atoms; indeed, the geometric misfit-strain associated with placing relatively large FA molecules into a smaller A-site cage increases the formation energy. The three cation arrangements at x=0.5 have significantly higher formation energies than the pure separated phases, which suggested that segregation may also be favored in the Cs₁₋ₓFAₓPbX₃ microcrystals as observed experimentally. Another notable feature was the asymmetric energy penalty as a function of composition; mixing FA in Cs-rich regions (x=0.75) was energetically easier than mixing Cs in FA-rich regions (x=0.25). Without intending to be bound by theory, it is believed that this may be due to the fact that the Cs-rich composition exhibits an orthorhombic packing with anisotropic A-site cation pockets within which the FA molecules can more easily fit.

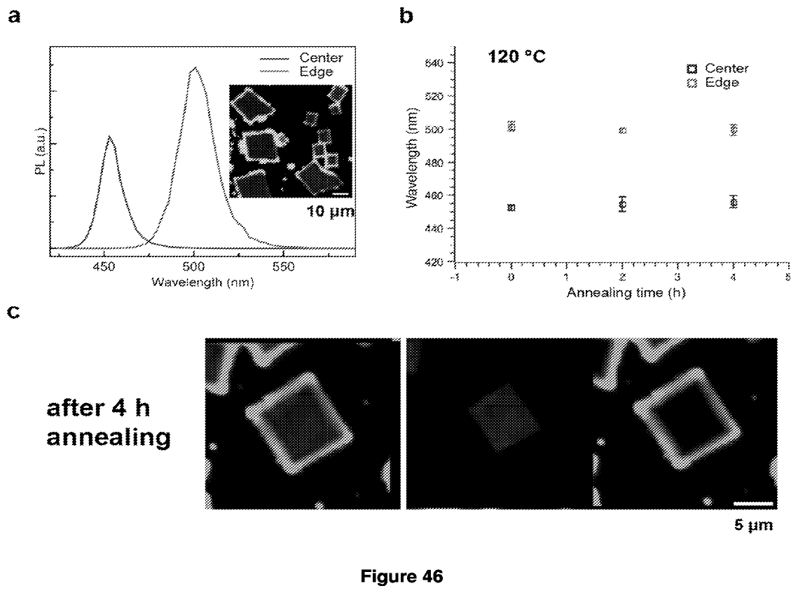

Post-synthetic annealing can promote the mixing of the two phases of the heterostructure, as the entropy of mixing increases. However, despite 12 h of continuous heating at 120° C. (to ensure the organic cation is stable), changes in the PL emission, peripheral layer thickness, and morphology were not observed for the large heterostructure microcrystals (>5 μm, Cs_{0.5}FA_{0.5}Pb(Cl_{0.5}Br_{0.5})₃), FIG. 46). So, the entropic contribution to the free energy of mixing was insufficient to overcome the energy barrier in this context. The halide-separated heterostructure is most likely the thermodynamically preferred phase especially for the larger size crystals (>5 μm) up to at least 120° C. (rather than a kinetically trapped intermediate). In other words, the nucleation kinetics dictate the formation of the heterostructure morphology, and any further modification is exceptionally difficult (FIG. 34). Moreover, even though halide ions move freely through the lattice, given the fact that the anion migration energy is significantly lower than the cation migration energy, they remain segregated with their cation pairs.

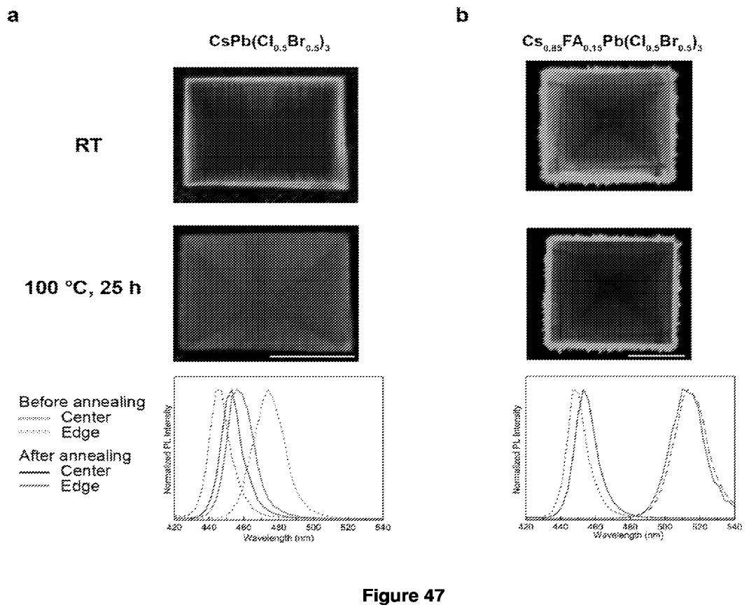

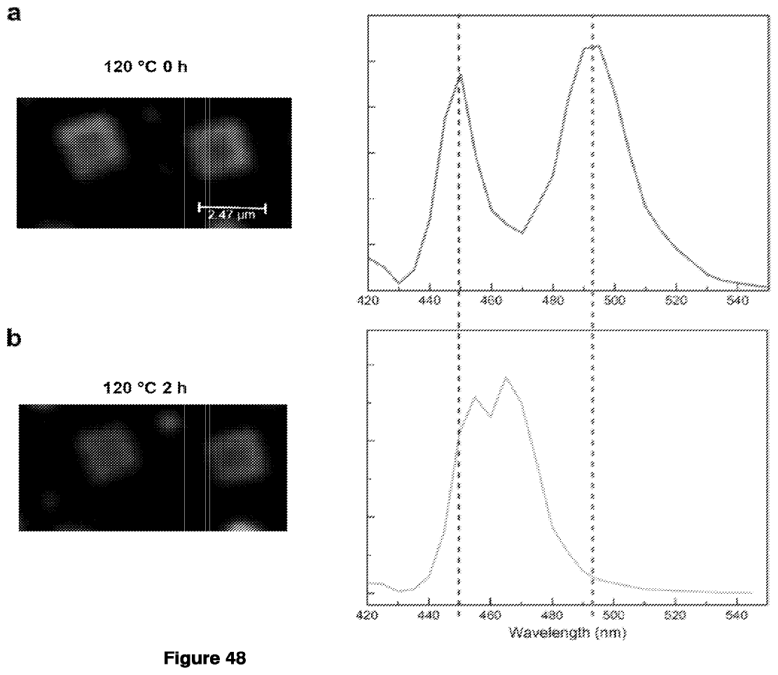

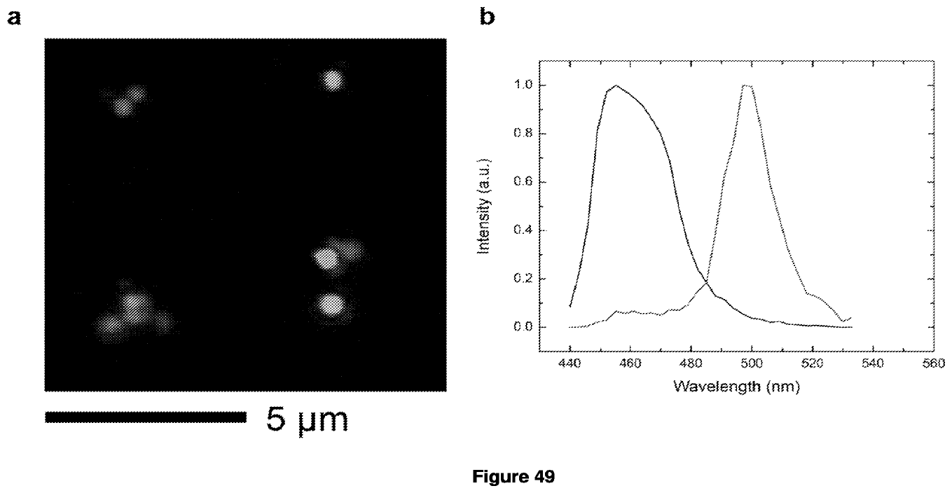

In order to maximize the effect of surface energy, smaller heterostructure crystals were synthesized. Increasing the temperature increases the entropic contribution to the formation free energy (FIGS. 46 and 47). For a smaller microcrystal (˜2 μm), two different PL emissions, indicative of a heterostructure, were observed (FIG. 48A). However, after annealing at 120° C. for 2 h, a single PL emission peak was observed for smaller microcrystals (<2 μm), indicative of the enhanced effect of mixing entropy in the structure (FIG. 48B). Furthermore, since the transition from heterostructure to alloy begins for particles approximately 100 nm in size, crystals in this size-range that still displayed two distinct PL peaks were monitored. Upon annealing at a lower temperature (80° C.), a single PL peak was observed (FIG. 24D). Considering that the centers of the emission peaks from the annealed bulk heterostructure (>5 μm) did not show any obvious changes even at 120° C. (FIG. 46), the temperature at which the transition occurs must be higher (if it occurs at all) with larger sized crystals. The observed trends describe the suppression of the miscibility boundary as a function of temperature and size (FIG. 24D). In addition, in order to confirm the thermodynamic effect, various sized crystals were synthesized with a substrate temperature of 80° C. during patterning. However, the solutions quickly evaporated before the crystals evolved into the single phase, and thus failed to obtain a single individual particle from each solution dome, resulting in the scattered particle phases (FIG. 49).

The DFT results suggest that a large enthalpy barrier (H) leads to the stable cation segregation observed experimentally for larger Cs_{0.5}FA_{0.5}PbX₃ crystals. However, as temperature increases (T>0 K) the entropic contribution (S) to the free energy of formation (G) increases (FIG. 24C). Larger Cs_{0.5}FA_{0.5}Pb(Cl_{0.5}Br_{0.5})₃ crystals (>5 μm) were stable in heterostructure morphologies when annealed at 120° C. for extended periods (FIG. 46). This is because at this size range the enthalpic barrier is too large to be overcome despite the enhanced entropic contribution to the free energy. However, in the case of single cation compositions such as CsPb(Cl_{0.5}Br_{0.5})₃, kinetic heterostructure morphologies formed for exceptionally large microcrystals (>30 μm, FIG. 47), but low temperature annealing (100° C.) was sufficient to induce complete mixing. This corroborates the idea that the Cs-FA enthalpic barrier is a factor for robust heterostructure formation.

As particle size decreases, the roles of surface and interfacial energies become more relevant to determining the thermodynamically preferred structure, and generally these contributions favor mixing. Thus, for the lateral heterostructures of the disclosure, it was believed that the immiscible region of the phase diagram would shrink with decreasing crystal size (FIG. 3d). Indeed, compared to the stable larger Cs_{0.5}FA_{0.5}Pb(Cl_{0.5}Br_{0.5})₃ crystals (>5 μm), Cs_{0.5}FA_{0.5}Pb(Cl_{0.5}Br_{0.5})₃ crystals approximately 2 μm in size showed a transition from a heterostructure to a solid-solution morphology after thermal annealing at 120° C. (FIG. 48). It was further observed a lower transition temperature (80° C.) for approximately 100 nm Cs_{0.5}FA_{0.5}Pb(Cl_{0.5}Br_{0.5})₃ crystals (FIG. 3d). As for the even smaller crystals approximately 60 nm in size, their transition temperature appeared to be below room temperature (23° C.).

### Combinatorial Libraries

Methods of the disclosure can be used to form combinatorial libraries of mixed halide perovskite crystals or nanocrystals. EC-PPL can be particularly useful in forming combinatorial libraries having array of nanocrystals. The array can have a defined pattern and can have nanocrystals of different size, crystal structure, and/or composition. Any combination of features can be used to generate the combinatorial arrays. The arrays can be used in various applications including for example in optoelectronic devices, such as optical displays, photovoltaic devices, such as solar cells, LEDs, lasers, transistors, batteries, in photocatalysis, piezoelectric energy generators, and in screening methods and sensors.

In embodiments, the combinatorial library has mixed halide perovskite nanocrystals having a substantially uniform size. In other embodiments, the combinatorial library has mixed halide perovskite nanocrystals having a gradient of sizes. In still further embodiments, the combinatorial library has halide perovskite nanocrystals having various sizes arranged in a defined pattern.

In embodiments, the combinatorial library has mixed halide perovskite nanocrystals having the same composition. In embodiments, the combinatorial library has two or more different compositions of mixed halide perovskite nanocrystals and/or single cation halide perovskite nanocrystals with mixed halide perovskite nanocrystals.

In any of the foregoing embodiments, combinations of features such as size difference, compositional differences, or patterning can be combined in the combinatorial library.

### EXAMPLES

### Example 1: Synthesis of Mixed (Anion) Halide Perovskite Libraries

Synthesis of CsPbBr₃ Arrays. CsPbBr₃ arrays were synthesized by polymer pen lithography (PPL) based on our previous report. The pyramidal shaped-polymer pen arrays were fabricated based on a published protocol using h-polydimethylsiloxane (h-PDMS, Gelest)³³. The pen array was mounted onto the XYZ motorized piezo scanner of a desktop nanopatterning instrument (TERA-Fab M series, TERA-print, LLC). The pen array was finely leveled parallel to the substrate with two piezo actuators before patterning. The pen array was removed from the instrument, treated with O₂ plasma, and then spin-coated with the ink at a spin speed of 3,000 rpm for 1 min or less depending on the type of ink precursor used. The ink was prepared by fully dissolving 1 mmol PbBr₂ and 1 mmol CsBr in 5 mL of dimethyl sulfoxide (DMSO). The inked pen array in the instrument was brought in contact with the substrate for a few seconds, and then it was retracted from the substrate to deliver small nanoreactors of sample to the surface. The crystal size gradient was tuned by varying extension length with higher extension lengths resulting in larger particles (extension length: 0-8 μm from a contact point against the substrate). Nanoreactors of the ink were formed on the substrate after retraction of the pen array, and these droplets were allowed to evaporate under ambient conditions to form individual halide perovskite nanocrystals.

Laser exposure. The laser exposure of individual crystals in CsPbBr₃ arrays was performed with confocal Raman setup (LabRAM HR Evolution, Horiba) with an optical objective (100×, NA=0.9, dry) at room temperature. The power was controlled by different neutral density filters built into the system. The excitation light source was typically a continuous wave laser (473 nm). To realize a larger area of laser exposure, scanning confocal microscopy (Leica SP8) was used to irradiate different CsPbBr₃arrays at a fast scan speed (400 Hz) with an optical objective (10×, NA=0.4, dry) under high-power 405-nm laser excitation. Laser wavelengths of 532 nm, 633 nm, 785 nm were used to conduct the wavelength-dependent study.

Anion exchange reaction. The anion exchange method was adapted from a previous report¹⁸. Anhydrous cyclohexane (5 mL), PbCl₂ or PbI₂ (0.188 mmol), oleic acid (OA, 90%, Aldrich) (0.5 mL), and oleylamine (OAm, Aldrich, 70%) (0.5 mL) were added to a 20-mL glass vial. The solution was stirred at 100° C. under ambient conditions with the glass vial well-capped. It took several hours for the PbCl₂ to fully dissolve in the solution (solution A). The Cl—anion exchange solution (solution B) was prepared by diluting 0.2 mL solution A with 1.8 mL anhydrous cyclohexane. The substrates with CsPbBr₃arrays were incubated in solution B for a controlled period of time to induce Cl—exchange, with the temperature elevated using a hot plate and monitored using temperature controller. After the Cl-exchange reaction, the substrate was rinsed with anhydrous cyclohexane. For I⁻ exchange, a corresponding PbI₂ solution was used.

Structural characterizations. The morphologies and size distributions of the crystals were imaged by scanning electron microscopy (SEM) on a Hitachi SU8030. The energy-dispersive X-ray spectroscopy (EDS) was based on silicon drift detector (SDD) (X-Max^{N}, Oxford Instruments) equipped on a Hitachi SU8030.

Optical characterization of halide perovskite arrays. Photoluminescence spectra of CsPbBr₃ crystals before or after laser exposure at different wavelength were acquired from a LabRAM HR Evolution (Horiba). Raman scattered photons were dispersed by a 600 g/cm grating and collected by a spectrometer under 785-nm or 633-nm laser excitation at different powers. The spectrum of each particle in the CsPb(BrₓC₁₋ₓ)₃ arrays was acquired via the lambda scan mode in the confocal PL maps under 405-nm laser excitation. The spectral range is typically 420 nm to 550 nm with 3-nm intervals (512×512 per frame, 400 Hz scanning speed). The total acquisition time was within 2 minutes. Multi-channel confocal imaging was used during confocal fluorescence microscopy on a Leica SP8 Confocal (Leica Microsystem). All confocal PL images were acquired with an objective (10×/0.40 NA air; pinhole size=1 AU; 512×512 per frame) with a high-resolution zoom at room temperature under a 405-nm laser diode. The gain of the different channels was adjusted to acquire a strong signal from each. Blue, green and red channels represent PL emission from 420 to 480 nm, from 480 nm to 550 nm and from 600 nm to 700 nm, respectively.

PL lifetime measurements. The PL lifetime measurements were performed using a 20×, 0.55 NA air objective with the Leica DiveB Sp8 Multiphoton confocal laser scanning microscope. The excitation wavelength is 800 nm from a Physics Mai Tai tunable laser (690-1040 nm). The lifetime decay was collected and analyzed using the Leica X software.

Synthesis of bulk microcrystals. The synthesis of bulk CsPbBr₃ microcrystals was adapted from a previous report⁴. A spin-coated PbI₂ film on a glass substrate was mixed and reacted with CsBr in methanol under mild heating and ambient conditions. The CsPbBr₃ microcrystals were then be transferred to a Si substrate for laser exposure treatment and anion exchange in the same manner as described above.

Spin-coated CsPb(BrₓCl₁₋ₓ)₃ thin films. The 0.05 M CsPb(BrₓCl₁₋ₓ)₃ (x=0.4, 0.5, 0.6, 0.75) solutions were prepared by dissolving corresponding combinations of precursors in DMSO. The CsPb(BrₓCl₁₋ₓ)₃ solution was spin-coated onto O₂ plasma-treated Si substrates at 1,500 rpm for 120 s. These thin films were then annealed at 150° C. for 10 minutes. The confocal PL images and corresponding spectra of these thin films were acquired under the same laser scanning conditions with a Leica SP8.

### Example 2: Synthesis of Complex Mixed Halide Perovskite Heterostructure Microcyrstals

All of the chemicals were purchased from Sigma-Aldrich unless otherwise stated. For the Cs_{0.5}FA_{0.5}Pb(Cl_{0.5}Br_{0.5})₃ system, FABr (0.25 mmol), CsCl (0.25 mmol), PbBr (0.25 mmol), and PbCl₂ (0.25 mmol) were dissolved in 10 mL of DMSO. Then the Cs_{0.5}FA_{0.5}Pb(Cl_{0.5}Br_{0.5})₃ solution was drop-casted on O₂ plasma-pre-treated Si substrates. The substrates were heated at approximately 120° C. for approximately 10 min on a hot plate in air. The square-shaped heterostructure microcrystals formed after the solvent fully evaporated.

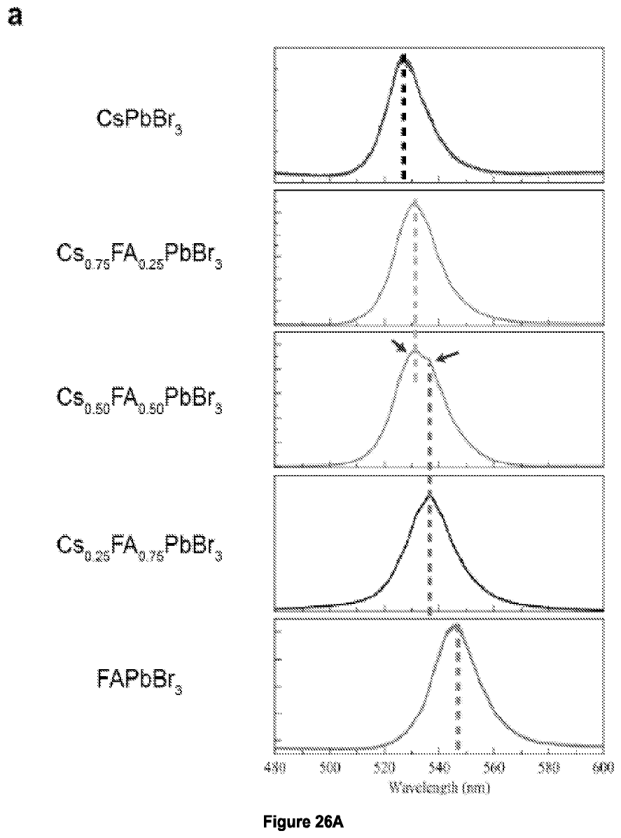

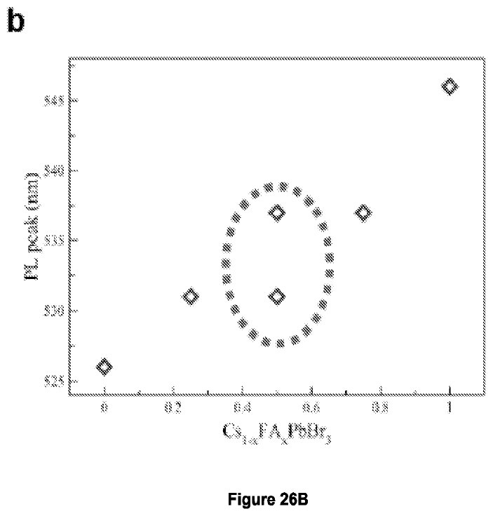

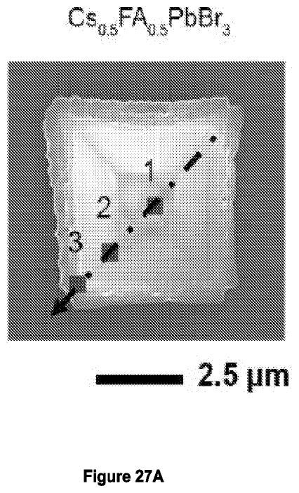

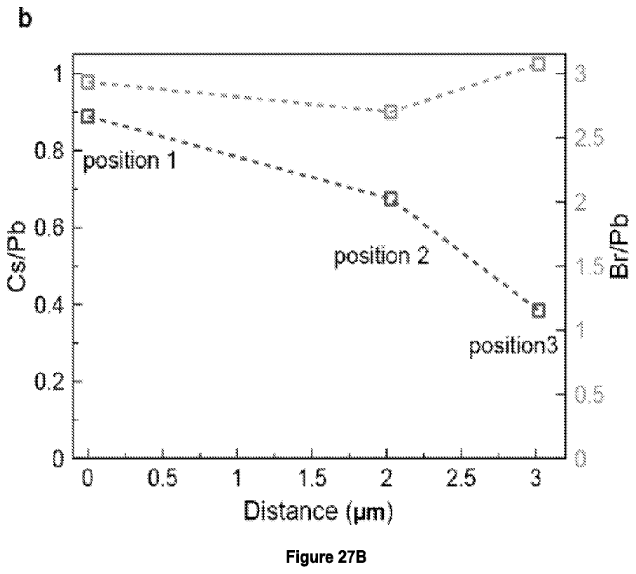

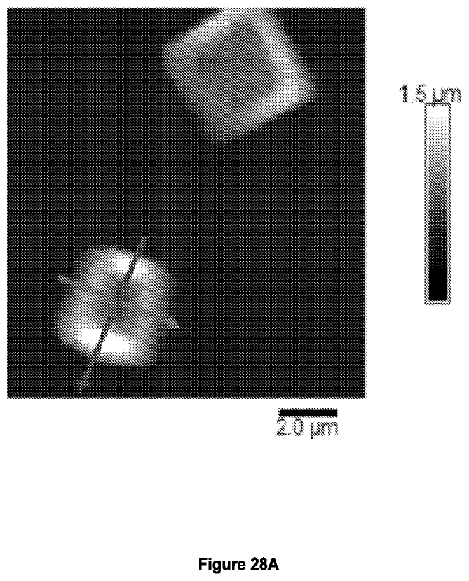

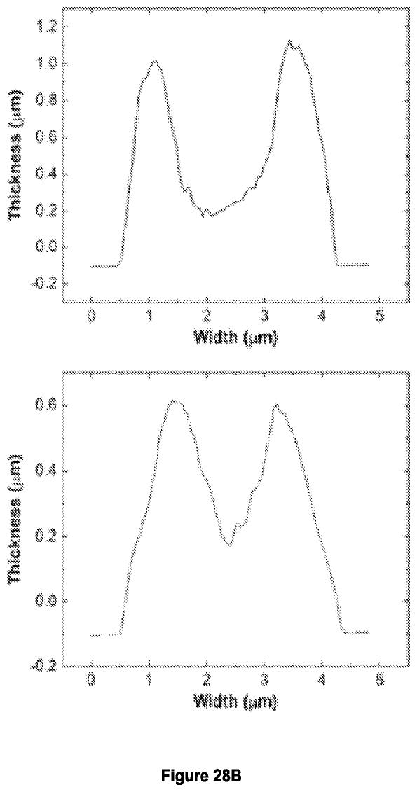

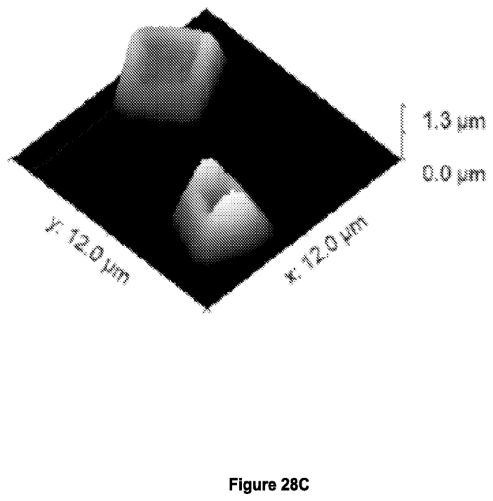

The same process was used for the other mixed-composition perovskites (FIG. 26) (i.e., Cs_{0.5}FA_{0.5}PbBr₃, Cs_{0.5}FA_{0.5}Pb(Cl_{0.83}Br_{0.17})₃, Cs_{0.5}FA_{0.5}Pb(C_{0.33}Br_{0.66})₃, Cs_{0.5}FA_{0.5}Pb(Br_{0.9}I_{0.1})₃, Cs_{0.5}FA_{0.5}Pb(Br_{0.8}I_{0.2})₃, Cs_{0.5}FA_{0.5}Pb(Br_{0.66}I_{0.33})₃, Cs_{0.5}FA_{0.5}Pb(Br_{0.33}I_{0.66})₃, Cs_{0.5}FA_{0.5}Pb(Cl_{0.67}Br_{0.17}I_{0.1})₃, Cs_{0.5}FA_{0.5}Pb(Cl_{0.42}Br_{0.42}I_{0.17})₃). The precursor solutions were prepared with the corresponding ratios of CsX, FAx, and PbX₂ (X=Cl, Br, and/or 1) dissolved in DMSO.

The sizes and shapes of the crystal cores and the shells in the heterostructures were changed by toggling the solution evaporation rate. The overall crystal size was tuned by varying the concentration of precursors in solution and the ratio of solvents. A smaller size Cs_{0.5}FA_{0.5}Pb(Cl_{0.5}Br_{0.5})₃ heterostructure microcrystal was obtained by diluting DMSO using DMF at a DMF:DMSO volume ration of 9:1 (0.5M) (FIG. 36). The as-synthesized crystals were annealed at different temperatures as needed to improve their crystallinities.

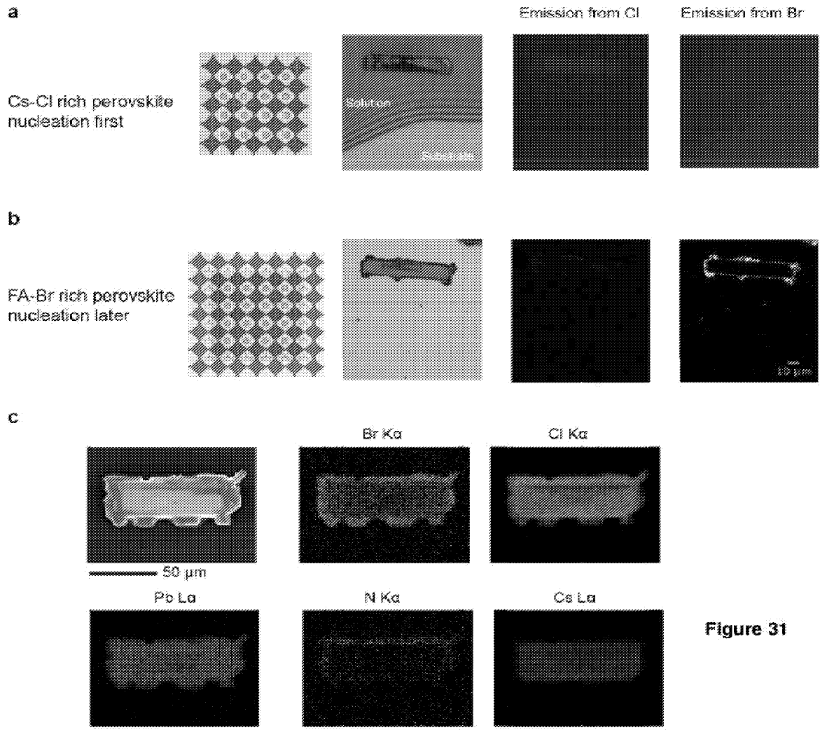

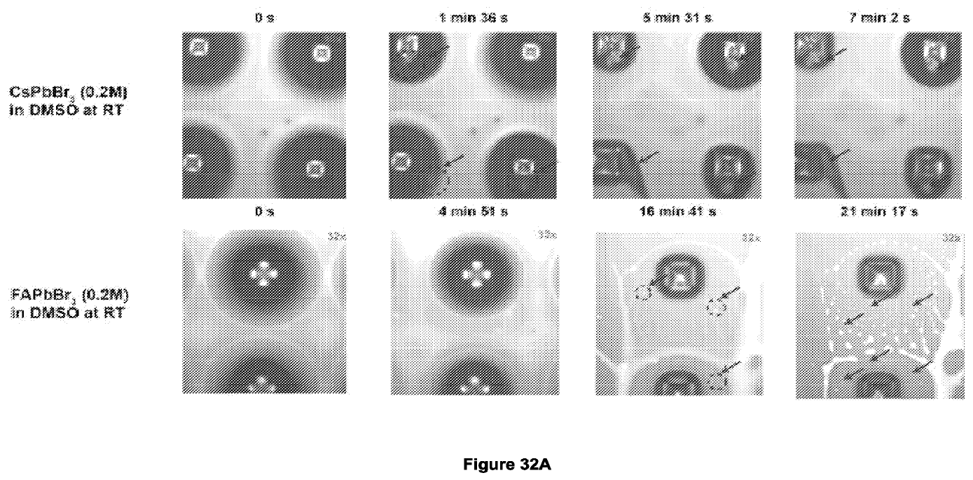

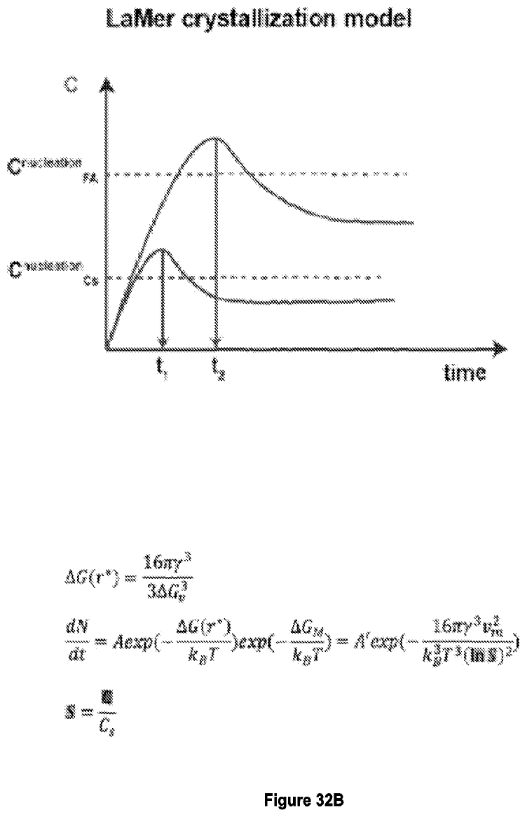

Nucleation and crystallization commence during solvent evaporation, which causes a Cs—Pb—Cl-rich blue-emitting perovskite phase to grow. Without intending to be bound by theory, it is believed that this is attributable to its significantly lower solubility in the solvent (i.e., dimethyl sulfoxide (DMSO) or dimethylformamide (DMF)). The other precursors remain in solution (FIG. 31A). Next, it is believed that the Cs—Pb—Cl-rich crystal (the liquid-substrate-crystal interface) serves as a nucleation site for secondary heterogeneous nucleation of the FA-Pb—Br-rich perovskite. When the solvent has completely evaporated, the FA-Pb—Br-rich phase (green-emitting) grows laterally around the Cs—Pb—Cl-rich phase (FIG. 31B). This step-wise growth can be understood using the LaMer crystallization model. Based on this model, the offset in the concentration necessary for each phase to become supersaturated and nucleate drives the formation of the lateral heterostructure morphology (FIG. 32).

### Example 3: Synthesis of Complex Mixed-Halide Perovskite Arrays

Mixed-halide perovskite arrays were synthesized using EC-PPL. The pyramidal shaped-polymer pen arrays were fabricated following a published protocol using h-polydimethylsiloxane (h-PDMS, Gelest). Eichelsdoerfer et al., Larger-area molecular patterning with polymer pen lithography, 8 Nat. Protec. 2548-60 (2013). The pen arrays were mounted onto the XYZ-motorized piezo scanner of a desktop nanopatterning instrument (TERA-Fab M series, TERA-print, LLC). The pen array was finely leveled parallel to the substrate with two piezo actuators before patterning. The pen array was removed from the instrument, treated with O₂ plasma, and then spin-coated with the ink at a spin speed of 3,000 rpm for 1 min or less depending on the type of ink precursor used. The precursor solutions used in Example 1 were used as the ink. The inked pen array in the instrument was brought into contact with the substrate for a few seconds, and then retracted from the substrate to make small nanoreactors (FIG. 24A).

The crystal size was tuned by modulating dwell time (pen to substrate for 1-10 s) and extension length (0-10 μm from a contact point against the substrate). Nanoreactors of the ink were formed on the substrate after retraction of the pen array, and these droplets were allowed to evaporate under atmospheric conditions to form individual halide perovskite nanocrystals.

To achieve patterning at high-temperature, a micro-heater made of Pt-wires 0.2 mm in diameter was attached below the substrate. Consistent heat was applied to the substrate during patterning. The temperature on the surface of the substrate was measured using a source mete (Keithley-2400).

The time-transient nucleation of Cs_{0.5}FA_{0.5}Pb(Cl_{0.5}Br_{0.5})₃ was imaged using an optical microscope (Zeiss Axio Imager M2) under the bright-field and fluorescence modes with a LED illuminator (X-Cite, Excelitas Tech). For the kinetic comparison between CsPbBr and FAPbBr₃, similar amounts of solution were accumulated onto the pyramidal tips of the uniform pen array by controlling the spin-coating conditions. The nucleation kinetics of CsPbBr₃ and FAPbBr₃ were compared using a CMOS camera (objective 20×) equipped on the TERA-Fab M series instrument.

The morphologies of all the crystals were imaged by scanning electron microscopy (SEM) on both a Hitachi SU8030 and a JEOL JSM-7900FLB equipped with a cold-field emission gun (cFEG) operated at 1 kV to 15 kV. Elemental distributions were confirmed using energy dispersive X-ray spectroscopy (EDS) silicon drift detector (SDD) (X-Max^{N}, Oxford Instruments) equipped on the Hitachi SU8030.

Transmission electron microscopy (TEM) was performed on a JEOL ARM200CF equipped with a cFEG operated at 200 kV. Diffraction patterns were obtained from a Gatan OneView CMOS camera. All images were obtained within a few seconds after the focusing and alignment process to avoid extensive electron beam damage. Simulated electron diffraction data were generated using the SingleCrystal package (SingleCrystal and Crystal Maker Software Ltd.) based on the simulated crystal structures from the DFT results. The structural models were constructed using the VESTA software.

The heights of the heterostructures were defined using atomic force microscopy (AFM, Dimension Icon; Bruker) in tapping mode (probe k=42 N/m) at a scan rate between 0.1-0.2 Hz. The obtained images were analyzed using Gwyddion software).

Grazing incidence x-ray diffraction analysis was performed using a SmartLab Rigaku X-ray operating with Cu Kₐ radiation at 40 kV and 30 mA at room temperature. The scan rate was 2 sec/step with a step size of 0.2°.

Multi-channel crystals were imaged using confocal fluorescence microscopy on a Leica SP8 Confocal (Leica Microsystem). All optical sections were acquired with an objective (10×/0.4NA air; pinhole size=1 AU) with a high-resolution zoom at room temperature. The fluorophores were excited using a solid-state diode laser at 405 nm.

For the resolution-sensitive heterostructure, high-resolution photoluminescence (HRPL) was performed on a modified confocal Raman spectrometer, LabRAM HR Evolution (Horiba), with an excitation wavelength of 473 nm at room temperature.

### Example 4: DFT Simulation

The Vienna Ab-initio Simulation Package (VASP) was used to investigate the electronic structure and relative stability of the halide perovskites. The calculation utilized generalized gradient approximation (GGA) with the Perdew-Burke-Ernzerhof (PBE) functional (PBE). Projector-augmented wave (PAW) potentials were used to describe the core and valence electrons, and the plane-wave basis set employed a kinetic energy cutoff of 550 eV. The tetrahedron method was used along with a 5×4×5 Monkhorst-Pack grids for Brillouin zone integrations and k-space sampling of the Pnma unit cell with four formula units. Changes to the sampling were modified accordingly depending on the size of supercell. The cell volume and atomic positions were relaxed until the forces on each atom were less than 0.03 eV A-¹.

Density functional theory (DFT) calculations were performed to understand the thermodynamics governing the cation-mixing behavior in Cs1-xFAxPbX3 (0≤x≤1, X=Cl, Br, I) perovskites at different Cs:FA ratios. Three possible arrangements for the A-site, with dispersed, columnar, and layered configurations, representative of cation-mixing, were calculated for x=0.5 composition and similar configurations for other compositions. For purposes of the calculation, core and valence electrons were treated with projector-augmented wave potentials using the following configurations: Cs (5s²5p⁶6s¹), C (2s²2p²), N (2s²2p³), H(1 s¹), Pb (6s²5d¹⁰6p²), Cl (3s²3p⁵), Br (4s²4p⁵), I (5s²5p⁵). For structural models of intermediate compositions (x=0.25, 0.5, 0.75), modeling started from the CsPbX₃ structure (Pnma; 4 Pb atoms in the structure) and substituted Pb with FA molecules. For x=0.5, the cation arrangements were made without constructing a supercell, and for x=0.25 and 0.75, a √2×√2×1 supercell was prepared. For these Pnma structure and the supercell, k-mesh grids of 5×5×4 and 4×4×4 were used based on the Monkhorst-Pack grids.

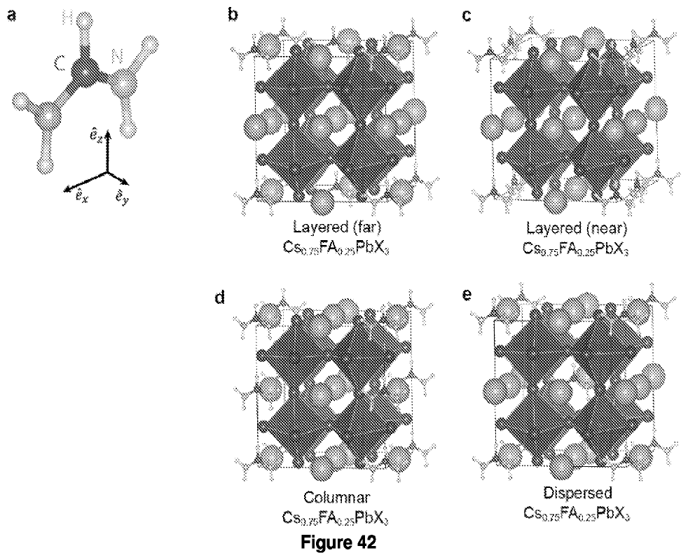

Cation configurations are referred to layered, columnar, or dispersed based on the local cation arrangements of the x=0.5 compositions. Except for the 50% mixing of two cation types, these names do not reflect strictly homogenous cation layers or columns as the different number of cations make is difficult to define ordering wavevectors for each cation type. Given this difficulty, êₓ, ê_{y}, ê_{z} axes for the FA cation were additionally defined as shown in FIG. 42) and labeled cation arrangements in compositions other than x=0.5. The êₓ direction was the long direction, ê_{y} was the single-atom thick short direction, and ê_{z} was the direction parallel to the C—H bond in the FA ion. Columnar arrangements occur when the maximum number of FA ions are aligned along the ê_{z} direction, and layered arrangements occur when the maximum number of FA molecules are present in one layer parallel to êₓ and ê_{y}. Dispersive configurations are referenced when the FA molecule are maximally distributed. Example structures for x=0.25 are shown in FIGS. 42B-E.

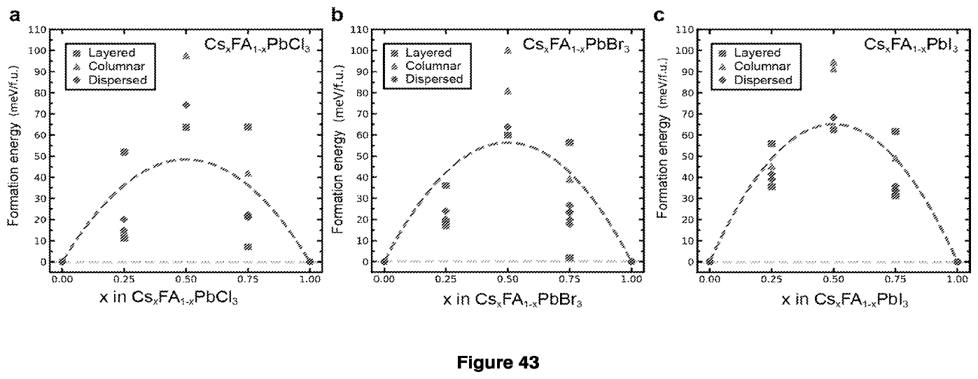

Positive enthalpy of mixing was found for the Cs1-xFAxPbX3 (X=Br, Cl, and I) as shown in FIG. 43. The enthalpy of mixing trend found in the DFT calculations herein were different from some reported DFT calculations. The origin of this opposite trend was attributed to the choice of atomic structure for CsPbX₃ and FAPbX₃, where an appropriate description of atomic structures of these two end compositions recovers the concave shape indicating immiscibility. Specifically, CsPbX₃ exhibited an orthorhombic structure, and the energy difference with respect to the cubic structure was 67.5, 74.4, and 114 meV/f.u. for X=Cl, Br, and I, respectively. These results were consistent with other simulation results. It was observed that the ground structure of FAPbX₃ was more complicated as the relative orientation of the organic molecules considerably affected the energy of the system.

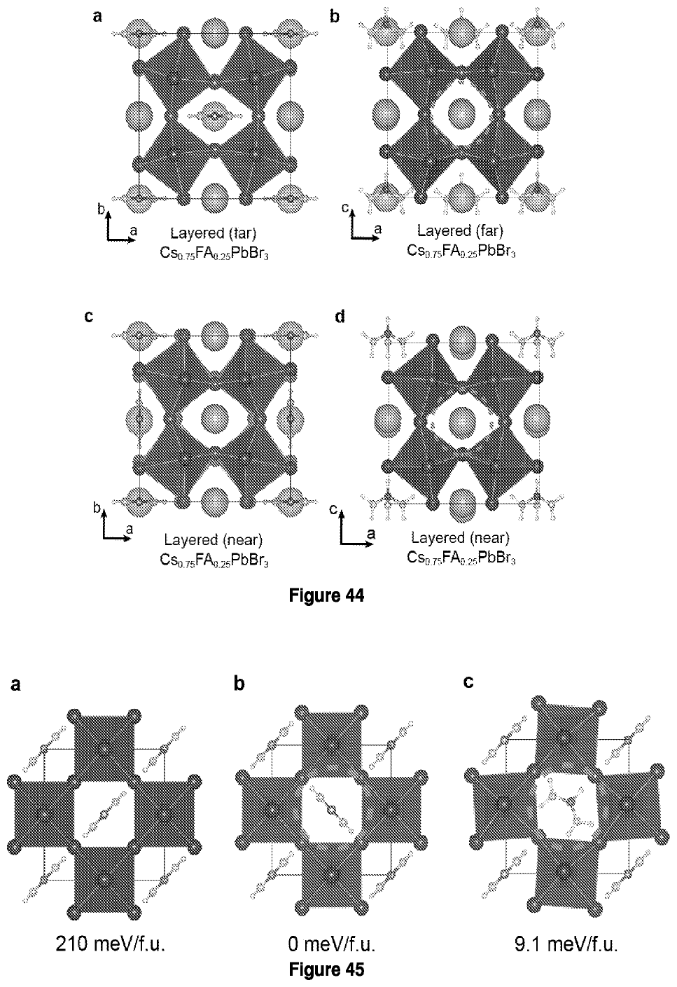

Another observed trend was from the formation energies of C_{S1-x}FAₓPbX₃ was that two different layered-cation configurations exhibited the highest and lowest energy at x=0.25 and 0.75. Without intending to be bound by theory, it is believed that the trend suggests that the energetics in hybrid perovskites are governed by both cation order and secondary local structural distortions induced by the chemical order. Specifically, the layered configurations with dispersed FA molecules (layered (far); FIG. 44B) was the most unstable and the order with neighboring FA molecules (layered (near); FIG. 44C) had the lowest energy.

As shown in FIG. 44, these two orders shared similar distortion patterns on the ab-plane while layered (near) order showed large differences in the rotation angles of the perovskite layers. The view along the b-direction showed different tilting angles around Cs atoms. The layered (far) configuration exhibited much smaller tilting angles than found for the octahedral around the highlighted Cs atoms (highlighted FIG. 44B), which developed a relatively isotropic cavity like cubic perovskites. Given the preference of CsPbX₃ to the orthorhombic structure his feature was energetically unfavorable and made the layered (far) order unstable. The anisotropic geometry of the FA molecules modified the octahedral distortion.

Three different molecule arrangements were calculated to examine the effect of the molecule orientations on the structure stability (FIG. 45). The energetics of FAPbBr₃ with the parallel FA molecules (FIG. 45A) was 210 meV/f.u higher than that with zigzag arrangements of FA molecules (FIG. 45B). For the size of primitive cubic perovskite, with pseudo-cubic lattice parameter of ˜6 Å, a single orientation of all molecules was enforced. The FA molecule was longer than it is wide. Thus, a parallel alignment included significantly shorter inter-molecular distance. This shorter distance induced repulsion, increasing the system's energy. As shown in FIG. 45A, the parallel alignment of the FA molecules inevitably had shorter molecule-molecule distances and the short Columbic interaction costed energy. Given the geometry of the FA molecule, the arrangement in FIG. 45B, yielded relatively homogenous intermolecular distances to minimize the electrostatic penalty. The two arrangements were without noticeable rotation and tilting, and lattice parameters were 6.13 Å and 6.00 Å for FIGS. 45A and 45B, respectively. The lattice features implied that the perovskite frame was expanded to avoid the high instability induced by close intermolecular distance. Thus, the parallel arrangement of FA molecules was disadvantageous because occupancy of anisotropic molecule in a relatively isotropic space (A-cation site).

The molecular arrangement shown in FIG. 45C was also calculated and whose energy was 9.1 meV/f.u. higher than the configuration depicted in FIG. 45B. Though the polar rotation of FA molecules increased energy, it was observed that the energy penalty of this arrangement was relatively small and involved octahedral rotation and tilting compared to other arrangements. Among the molecular arrangements analyzed, the orientation of the FA molecules and their secondary lattice distortions was observed to result in a wider energy range. Specifically, it is known that quasi-random orientations of molecule components and lattice distortions reduce the energy of the system. Thus, it was anticipated that the energy of FAPbX₃ structures would be further lowered by considering various orientations of FA molecules, compared to cation-mixed systems. In such cases, the concave hull of cation-mixing would be deeper, strengthening the presence of positive enthalpy of mixing observed.

The use of “a” or “an” are employed to describe elements and components of the embodiments herein. This is done merely for convenience and to give a general sense of the description. This description should be read to include on or at least one and the singular also includes the plural unless it is obvious that it is meant otherwise.

The Figures depict embodiments for purposes of illustration only. One of ordinary skill in the art will readily recognize from the description that alternative embodiments of the structures and methods illustrated herein may be employed without departing from the principles described herein.

Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation, and details of the methods and structures disclosed herein without departing from the spirt and scope defined in the appended claims.

### REFERENCES

International Patent Application Publication NO. WO 2021/188168
1. McMeekin, D. P. et al. A mixed-cation lead mixed-halide perovskite absorber for tandem solar cells. Science 351, 151-155 (2016).
2 Xu, F., Zhang, T., Li, G. & Zhao, Y. Mixed cation hybrid lead halide perovskites with enhanced performance and stability. J. Mater. Chem. A 5, 11450-11461 (2017).
3 Zhang, M. et al. Composition-dependent photoluminescence intensity and prolonged recombination lifetime of perovskite CH3NH3PbBr(3-x)Cl(x) films. Chem. Commun. (Camb) 50, 11727-11730(2014).
4 Rehman, W. et al. Charge-Carrier Dynamics and Mobilities in Formamidinium Lead Mixed-Halide Perovskites. Adv. Mater. 27, 7938-7944 (2015).
5 Fu, Y. et al. Cation Engineering in Two-Dimensional Ruddlesden-Popper Lead Iodide Perovskites with Mixed Large A-Site Cations in the Cages. J. Am. Chem. Soc. 142, 4008-4021 (2020).
6 Tong, G. et al. Mixed cation perovskite solar cells by stack-sequence chemical vapor deposition with self-passivation and gradient absorption layer. Nano Energy 48, 536-542 (2018).
7 Zhang, X. et al. Hybrid Perovskite Light-Emitting Diodes Based on Perovskite Nanocrystals with Organic-Inorganic Mixed Cations. Adv. Mater. 29, 1606405 (2017).
8 Ruf, F. et al. Temperature-dependent studies of exciton binding energy and phase-transition suppression in (Cs,FA,MA)Pb(1,Br)3 perovskites. APL Mater. 7, 031113 (2019).
9 Cho, H. et al. High-Efficiency Polycrystalline Perovskite Light-Emitting Diodes Based on Mixed Cations. ACS Nano 12, 2883-2892 (2018).
10 Lai, M. et al. Intrinsic anion diffusivity in lead halide perovskites is facilitated by a soft lattice. Proc. Natl. Acad. Sci. U.S.A. 115, 11929-11934 (2018).
11 Jia, C., Li, H., Meng, X. & Li, H. CsPbX3/Cs4PbX6 core/shell perovskite nanocrystals. Chem. Commun. (Camb) 54, 6300-6303 (2018).
12 Zhang, C. et al. Core/Shell Perovskite Nanocrystals: Synthesis of Highly Efficient and Environmentally Stable FAPbBr3/CsPbBr3 for LED Applications. Adv. Func. Mater. 30, 1910582 (2020).
13 Jiang, G. et al. Highly Luminescent and Water-Resistant CsPbBr3-CsPb2Br5 Perovskite Nanocrystals Coordinated with Partially Hydrolyzed Poly(methyl methacrylate) and Polyethylenimine. ACS Nano 13, 10386-10396 (2019).
14 Liu, H. et al. Fabricating CsPbX3-Based Type I and Type II Heterostructures by Tuning the Halide Composition of Janus CsPbX3/ZrO2 Nanocrystals. ACS Nano 13, 5366-5374 (2019).
15 Shi, E. et al. Two-dimensional halide perovskite nanomaterials and heterostructures. Chem. Soc. Rev. 47, 6046-6072 (2018).
16 Dou, L. et al. Spatially resolved multicolor CsPbX3 nanowire heterojunctions via anion exchange. Proc. Natl. Acad. Sci. U.S.A. 114, 7216-7221 (2017).
17 Knight, A. J. & Herz, L. M. Preventing phase segregation in mixed-halide perovskites: a perspective. Energy Environ. Sci. 13, 2024-2046 (2020).
18 Marchezi, P. E. et al. Degradation mechanisms in mixed-cation and mixed-halide CsxFA1-xPb(Bryl1-y)3 perovskite films under ambient conditions. J. Mater. Chem. A 8, 9302-9312 (2020).
19 Chen, L. et al. Toward Long-Term Stability: Single-Crystal Alloys of Cesium-Containing Mixed Cation and Mixed Halide Perovskite. J. Am. Chem. Soc. 141, 1665-1671 (2019).
20 Britnell, L. et al. Strong light-matter interactions in heterostructures of atomically thin films. Science 340, 1311-1314 (2013).
21 Shi, E. et al. Two-dimensional halide perovskite lateral epitaxial heterostructures. Nature 580, 614-620 (2020).
22 Shi, E. & Dou, L. Halide Perovskite Epitaxial Heterostructures. Acc. Mater. Res. 1, 213-224 (2020).
23 Shewmon, N. T., Yu, H., Constantinou, I., Klump, E. & So, F. Formation of Perovskite Heterostructures by Ion Exchange. ACS Appl. Mater. Interfaces 8, 33273-33279 (2016).
24 Pan, D. et al. Visualization and Studies of Ion-Diffusion Kinetics in Cesium Lead Bromide Perovskite Nanowires. Nano Lett. 18, 1807-1813 (2018).
25 Wang, Y. et al. Epitaxial Halide Perovskite Lateral Double Heterostructure. ACS Nano 11, 3355-3364 (2017).
26 Liao, C.-S. et al. Theoretical study on the tunable electronic band structure of Cs2PbI2Cl2/CsPbBr3 halide perovskite heterostructure driven by ferroelectric polarization modulation. J. Colloid Interface Sci. 597, 233-241 (2021).
27 Kong, Q. et al. Solid-state ionic rectification in perovskite nanowire heterostructures. Nano Lett. 20, 8151-8156 (2020).
28 Kennard, R. M. et al. Phase Stability and Diffusion in Lateral Heterostructures of Methyl Ammonium Lead Halide Perovskites. ACS App. Mater. Interfaces 11, 25313-25321 (2019).
29 Hao, M. et al. Ligand-assisted cation-exchange engineering for high-efficiency colloidal Cs1-xFAxPbI3 quantum dot solar cells with reduced phase segregation. Nat. Energy 5, 79-88 (2020).
30 Yi, C. et al. Entropic stabilization of mixed A-cation ABX3 metal halide perovskites for high performance perovskite solar cells. Energy Environ. Sci. 9, 656-662 (2016).
31 Rehman, W. et al. Photovoltaic mixed-cation lead mixed-halide perovskites: links between crystallinity, photo-stability and electronic properties. Energy Environ. Sci. 10, 361-369 (2017).
32 Sutanto, A. A. et al. Pushing the limit of Cs incorporation into FAPbBr3 perovskite to enhance solar cells performances. APL Mater. 7, 041110 (2019).
33 Kubicki, D. J. et al. Phase Segregation in Cs—, Rb—and K-Doped Mixed-Cation (MA)x(FA)1-xPbI3 Hybrid Perovskites from Solid-State NMR. J. Am. Chem. Soc. 139, 14173-14180 (2017).
34 Little, R. B., El-Sayed, M. A., Bryant, G. W. & Burke, S. Formation of quantum-dot quantum-well heteronanostructures with large lattice mismatch: ZnS/CdS/ZnS. J. Chem. Phys. 114, 1813-1822 (2001).
35 Wang, Y. et al. Cation-size mismatch and interface stabilization for efficient NiOx-based inverted perovskite solar cells with 21.9% efficiency. Nano Energy 88, 106285-106295 (2021).
36 Barker, A. J. et al. Defect-Assisted Photoinduced Halide Segregation in Mixed-Halide Perovskite Thin Films. ACS Energy Lett. 2, 1416-1424 (2017).
37 Eperon, G. E., Hörantner, M. T. & Snaith, H. J. Metal halide perovskite tandem and multiple-junction photovoltaics. Nat. Rev. Chem. 1, 1-18 (2017).
38 Chen, Q. et al. Under the spotlight: The organic-inorganic hybrid halide perovskite for optoelectronic applications. Nano Today 10, 355-396 (2015).
39 Berdiyorov, G. R., Kachmar, A., EI-Mellouhi, F., Carignano, M. A. & El-Amine Madjet, M. Role of Cations on the Electronic Transport and Optical Properties of Lead-Iodide Perovskites. J. Phys. Chem. C 120, 16259-16270 (2016).
40 Du, J. S. et al. Halide perovskite nanocrystal arrays: Multiplexed synthesis and size-dependent emission. Sci. Adv. 6, eabc4959 (2020).
41 Song, J. et al. Quantum Dot Light-Emitting Diodes Based on Inorganic Perovskite Cesium Lead Halides (CsPbX3). Adv. Mater. 27, 7162-7167 (2015).
42 Ng, M. & Halpert, J. E. Single crystals of mixed Br/Cl and Sn-doped formamidinium lead halide perovskites via inverse temperature crystallization. RSC Adv. 10, 3832-3836 (2020).
43 Molleman, B. & Hiemstra, T. Size and shape dependency of the surface energy of metallic nanoparticles: unifying the atomic and thermodynamic approaches. Phys. Chem. Chem. Phys. 20, 20575-20587 (2018).
44 Chen, P. C. et al. Interface and heterostructure design in polyelemental nanoparticles. Science 363, 959-964 (2019).
45 Meethong, N., Huang, H.-Y. S., Carter, W. C. & Chiang, Y.-M. Size-Dependent Lithium Miscibility Gap in Nanoscale Li1-xFePO4. Electrochem. Solid-State Lett. 10, A134-A138 (2007).
46 Burch, D. & Bazant, M. Z. Size-dependent spinodal and miscibility gaps for intercalation in nanoparticles. Nano Lett. 9, 3795-3800 (2009).
47 Beal, R. E. et al. Cesium Lead Halide Perovskites with Improved Stability for Tandem Solar Cells. J. Phys. Chem. 7, 746-751 (2016).
48 Hoke, E. T. et al. Reversible photo-induced trap formation in mixed-halide hybrid perovskites for photovoltaics. Chem. Sci. 6, 613-617 (2015).
49 Draguta, S. et al. Rationalizing the light-induced phase separation of mixed halide organic-inorganic perovskites. Nat. Commun. 8, 200 (2017).
50 Bischak, C. G. et al. Tunable Polaron Distortions Control the Extent of Halide Demixing in Lead Halide Perovskites. J. Phys. Chem. Lett. 9, 3998-4005 (2018).
51 Mao, W. et al. Light-induced reversal of ion segregation in mixed-halide perovskites. Nat. Mater. 20, 55-61 (2021).
52 Xiao, Z. et al. Mixed-Halide Perovskites with Stabilized Bandgaps. Nano Lett. 17, 6863-6869 (2017).
53 Duong, T. et al. Light and Electrically Induced Phase Segregation and Its Impact on the Stability of Quadruple Cation High Bandgap Perovskite Solar Cells. ACS App. Mater. Interfaces 9, 26859-26866 (2017).
54 Eichelsdoerfer, D. J. et al. Large-area molecular patterning with polymer pen lithography. Nat. Protoc. 8, 2548-2560 (2013).
55 Kresse, G. & Furthmuller, J. Efficient iterative schemes for ab initio total-energy calculations using a plane-wave basis set. Phys. Rev. B 54, 11169-11186 (1996).
56 Perdew, J. P., Burke, K. & Ernzerhof, M. Generalized gradient approximation made simple. Phys. Rev. Lett. 77, 3865-3868 (1996).
57 Kresse, G. & Joubert, D. From ultrasoft pseudopotentials to the projector augmented-wave method. Phys. Rev. B 59, 1758-1775 (1999).
58 Monkhorst, H. J. & Pack, J. D. Special points for Brillouin-zone integrations. Phys. Rev. B13, 5188-5192 (1976).
1 Hu, H. et al. Nucleation and crystal growth control for scalable solution-processed organic-inorganic hybrid perovskite solar cells. J. Mater. Chem. A 8, 1578-1603 (2020).
2 Kresse, G. & Joubert, D. From ultrasoft pseudopotentials to the projector augmented-wave method. Phys. Rev. B 59, 1758-1775 (1999).
3 Monkhorst, H. J. & Pack, J. D. Special points for Brillouin-zone integrations. Phys. Rev. B13, 5188-5192 (1976).
4 Hao, M. et al. Ligand-assisted cation-exchange engineering for high-efficiency colloidal Cs1-xFAxPbI3 quantum dot solar cells with reduced phase segregation. Nat. Energy 5, 79-88 (2020).
5 Yang, R. X., Skelton, J. M., da Silva, E. L., Frost, J. M. & Walsh, A. Assessment of dynamic structural instabilities across 24 cubic inorganic halide perovskites. J. Chem. Phys. 152, 024703 (2020).
6 Roma, G., Marronnier, A. & Even, J. From latent ferroelectricity to hyperferroelectricity in alkali lead halide perovskites. Phys. Rev. Mater. 4, 092402 (2020).
7 Zhao, X.-G., Dalpian, G. M., Wang, Z. & Zunger, A. Polymorphous nature of cubic halide perovskites. Phys. Rev. B 101, 155137 (2020).
8 Lai, M. et al. Intrinsic anion diffusivity in lead halide perovskites is facilitated by a soft lattice. Proc. Natl. Acad. Sci. U.S.A. 115, 11929-11934 (2018).
9 Eames, C. et al. Ionic transport in hybrid lead iodide perovskite solar cells. Nat. Commun. 6, 7497 (2015).
10 Linaburg, M. R., McClure, E. T., Majher, J. D. & Woodward, P. M. Cs1-xRbxPbCl3 and Cs1-xRbxPbBr3 Solid Solutions: Understanding Octahedral Tilting in Lead Halide Perovskites. Chem. Mater. 29, 3507-3514 (2017).
11 Zhu, H. et al. Screening in crystalline liquids protects energetic carriers in hybrid perovskites. Science 353, 1409-1413 (2016).
1. Burschka, J. et al. Sequential deposition as a route to high-performance perovskite-sensitized solar cells. Nature 499, 316-9 (2013).
2. Dou, L. et al. Solution-processed hybrid perovskite photodetectors with high detectivity. Nat. Commun. 5, 5404 (2014).
3. Zhu, H. et al. Lead halide perovskite nanowire lasers with low lasing thresholds and high quality factors. Nat. Mater. 14, 636-642 (2015).
4. Eaton, S. W. et al. Lasing in robust cesium lead halide perovskite nanowires. Proc. Natl. Acad. Sci. U.S.A 113, (2016).
5. Cho, H. et al. Overcoming the electroluminescence efficiency limitations of perovskite light-emitting diodes. Science 350, 1222-1225 (2015).
6. Lin, K. et al. Perovskite light-emitting diodes with external quantum efficiency exceeding 20 percent. Nature 562, 245-248 (2018).
7. Manser, J. S., Christians, J. A. & Kamat, P. V. Intriguing optoelectronic properties of metal halide perovskites. Chem. Rev. 116, 12956-13008 (2016).
8. McMeekin, D. P. et al. A mixed-cation lead mixed-halide perovskite absorber for tandem solar cells. Science 351, 151-155 (2016).
9. Xu, J. et al. Triple-halide wide-band gap perovskites with suppressed phase segregation for efficient tandems. Science 367, 1097-1104 (2020).
10. Xiao, Z. et al. Mixed-halide perovskites with stabilized bandgaps. Nano Lett. 17, 6863-6869 (2017).
11. Chen, S. et al. Accelerating the Screening of Perovskite Compositions for Photovoltaic Applications through High-Throughput Inkjet Printing. Adv. Funct. Mater. 29, 1905487 (2019).
12. Abdel-Latif, K., Bateni, F., Crouse, S. & Abolhasani, M. Flow synthesis of metal halide perovskite quantum dots: from rapid parameter space mapping to Al-guided modular manufacturing. Matter 3, 1053-1086 (2020).
13. Lignos, I. et al. Synthesis of cesium lead halide perovskite nanocrystals in a droplet-based microfluidic platform: fast parametric space mapping. Nano Lett. 16, 1869-1877 (2016).
14. Huo, F. et al. Polymer pen lithography. Science 321, 1658-1660 (2008).
15. Du, J. S. et al. Halide perovskite nanocrystal arrays: Multiplexed synthesis and size-dependent emission. Sci. Adv. 6, eabc4959 (2020).
16. Nedelcu, G. et al. Fast Anion-Exchange in Highly Luminescent Nanocrystals of Cesium Lead Halide Perovskites (CsPbX3, X═Cl, Br, I). Nano Lett. 15, 5635-5640 (2015).
17. Bekenstein, Y., Koscher, B. A., Eaton, S. W., Yang, P. & Alivisatos, A. P. Highly Luminescent Colloidal Nanoplates of Perovskite Cesium Lead Halide and Their Oriented Assemblies. J. Am. Chem. Soc. 137, 16008-16011 (2015).
18. Zhang, D. et al. Synthesis of Composition Tunable and Highly Luminescent Cesium Lead Halide Nanowires through Anion-Exchange Reactions. J. Am. Chem. Soc. 138, (2016).
19. Van der Stam, W. et al. Highly Emissive Divalent-Ion-Doped Colloidal CsPb1-xMxBr3 Perovskite Nanocrystals through Cation Exchange. J. Am. Chem. Soc. 139, 4087-4097 (2017).
20. Roy, C. R. et al. Anion Exchange of Ruddlesden-Popper Lead Halide Perovskites Produces Stable Lateral Heterostructures. J. Am. Chem. Soc. 143, 5212-5221 (2021).
21. Seo, S.-Y. et al. Writing monolithic integrated circuits on a two-dimensional semiconductor with a scanning light probe. Nat. Electron. 1, 512-517 (2018).
22. Li, J. et al. General synthesis of two-dimensional van der Waals heterostructure arrays. Nature 579, 368-374 (2020).
23. de Quilettes, D. W. et al. Impact of microstructure on local carrier lifetime in perovskite solar cells. Science. 348, 683-686 (2015).
24. Kim, G. Y. et al. Large tunable photoeffect on ion conduction in halide perovskites and implications for photodecomposition. Nat. Mater. 17, 445-449 (2018).
25. Eames, C. et al. Ionic transport in hybrid lead iodide perovskite solar cells. Nat. Commun. 6, 7497 (2015).
26. Shi, E. et al. Two-dimensional halide perovskite lateral epitaxial heterostructures. Nature 580, 614-620 (2020).
27. Miyata, K. et al. Large polarons in lead halide perovskites. Sci. Adv. 3, e1701217 (2017).
28. Bischak, C. G. et al. Tunable Polaron Distortions Control the Extent of Halide Demixing in Lead Halide Perovskites. J. Phys. Chem. Lett. 9, 3998-4005 (2018).
29. Tian, W., Zhao, C., Leng, J., Cui, R. & Jin, S. Visualizing carrier diffusion in individual single-crystal organolead halide perovskite nanowires and nanoplates. J. Am. Chem. Soc. 137, 12458-12461 (2015).
30. Gao, M. et al. Scaling Laws of Exciton Recombination Kinetics in Low Dimensional Halide Perovskite Nanostructures. J. Am. Chem. Soc. 142, 8871-8879 (2020).
31. Jiang, Y. et al. Spectra stable blue perovskite light-emitting diodes. Nat. Commun. 10, 1-9 (2019).
32. Ren, Z., Wang, K., Sun, X. W. & Choy, W. C. H. Strategies Toward Efficient Blue Perovskite Light-Emitting Diodes. Adv. Funct. Mater. 2100516 (2021).
33. Eichelsdoerfer, D. J. et al. Large-area molecular patterning with polymer pen lithography. Nat. Protoc. 8, 2548-2560 (2013).
1. Kong, Q. et al. Solid-state ionic rectification in perovskite nanowire heterostructures. Nano Lett. 20, 8151-8156 (2020).
2. Cha, J.-H. et al. Photoresponse of CsPbBr3 and Cs4PbBr6 perovskite single crystals. J. Phys. Chem. Lett. 8, 565-570 (2017).
3. Barboni, D. & De Souza, R. A. The thermodynamics and kinetics of iodine vacancies in the hybrid perovskite methylammonium lead iodide. Energy Environ. Sci. 11, 3266-3274 (2018).
4. Motti, S. G. et al. Controlling competing photochemical reactions stabilizes perovskite solar cells. Nat. Photonics 13, 532-539 (2019).
5. Kim, G. Y. et al. Large tunable photoeffect on ion conduction in halide perovskites and implications for photodecomposition. Nat. Mater. 17, 445-449 (2018).
6. Juarez-Perez, E. J. et al. Photodecomposition and thermal decomposition in methylammonium halide lead perovskites and inferred design principles to increase photovoltaic device stability. J. Mater. Chem. A 6, 9604-9612 (2018).
7. Song, J. et al. Ultralarge all-inorganic perovskite bulk single crystal for high-performance visible-infrared dual-modal photodetectors. Adv. Opt. Mater. 5, 1700157 (2017).
8. Li, Q., Yang, Y., Que, W. & Lian, T. Size- and morphology-dependent auger recombination in CsPbBr3 perovskite two-dimensional nanoplatelets and one-dimensional nanorods. Nano Lett. 19, 5620-5627 (2019).
9. Aneesh, J. et al. Ultrafast exciton dynamics in colloidal CsPbBr3 perovskite nanocrystals: Biexciton effect and Auger recombination. J. Phys. Chem. C 121, 4734-4739 (2017).
10. Herz, L. M. Charge-carrier dynamics in organic-inorganic metal halide perovskites. Annu. Rev. Phys. Chem. 67, 65-89 (2016).
11. Lai, M. et al. Intrinsic anion diffusivity in lead halide perovskites is facilitated by a soft lattice. Proc. Natl. Acad. Sci. U.S.A 115, (2018).
12. Koscher, B. A., Bronstein, N. D., Olshansky, J. H., Bekenstein, Y. & Alivisatos, A. P. Surface- vs Diffusion-Limited Mechanisms of Anion Exchange in CsPbBr3 Nanocrystal Cubes Revealed through Kinetic Studies. J. Am. Chem. Soc. 138, 12065-12068 (2016).
13. Yettapu, G. R. et al. Terahertz conductivity within colloidal CsPbBr3 perovskite nanocrystals: remarkably high carrier mobilities and large diffusion lengths. Nano Lett. 16, 4838-4848 (2016).
14. Zhang, Y. et al. Quantitative imaging of anion exchange kinetics in halide perovskites. Proc. Natl. Acad. Sci. U.S.A 116, (2019).
15. Pan, D. et al. Visualization and Studies of Ion-Diffusion Kinetics in Cesium Lead Bromide Perovskite Nanowires. Nano Lett. 18, 1807-1813 (2018).

What is claimed is:

1. A method of forming a combinatorial mixed halide perovskite library, comprising:
depositing an array of halide perovskite particles on a substrate, wherein each halide perovskite particle is a compound of formula ABX¹₃, wherein A is a cation, B is a metal, and X¹ is a first halogen;
exposing the array of halide perovskite particles to a laser to form defects in at least a portion of the halide perovskite particles, wherein an exposure condition is modified across the array to generate a variation of defect concentration in the halide perovskite particles in the array; and
exposing the array of halide perovskite particles having the defect concentration to an ion exchange solution comprising at least one halogen X² to thereby exchange a portion of X¹ with X² and form mixed halide perovskite particles, each mixed halide perovskite particle being a compound of formula AB(X¹₍₁₋ₙ₎X²ₙ)₃, wherein 0<n<1), and X² is a second halogen different from X¹.

2. The method of claim 1, wherein the array of halide perovskite particles is deposited using evaporation-crystallization polymer pen lithography.

3. The method of claim 1 or 2, wherein the array of halide perovskite particles has a gradient of crystal size of the halide perovskite particles across the array.

4. The method of any one of the preceding claims, wherein the halide perovskite particles have a crystal size of about 100 nm to about 400 nm before laser exposure.

5. The method of any one of the preceding claims, wherein the exposure condition of the laser is varied such that a gradient of defect concentration is generated across the array of halide perovskite particles.

6. The method of any one of the preceding claims, wherein ion exchange is performed at a temperature of about 20° C. to about 65° C.

7. The method of any one of the preceding claims, wherein ion exchange is performed by exposing the array of halide perovskite particles having the defect concentration to a solution comprising a perovskite precursor BX²₂, cyclohexane, oleic acid, and oleylamine.

8. The method of any one of the preceding claims, wherein X¹ and X² are independently selected from Cl, Br, F, and I.

9. The method of any one of the preceding claims, wherein B is one or more of lead, tin, and/or germanium.

10. The method of any one of the preceding claims, wherein A is one or more of methylammonium, butylammonium, formamidinium, phenethylamine, cesium, and rubidium.

11. The method of any one of the preceding claims, wherein varying the exposure conditions comprises varying the exposure time.

12. The method of claim 11, wherein the exposure time is about 10 s to about 80 s.

13. The method of any one of the preceding claims, wherein varying the exposure conditions comprises varying the laser power.

14. The method of claim 13, wherein the laser power is about 0.2 mW to about 25 mW.

15. The method of any one of the preceding claims, wherein the exposure conditions comprise delivering an energy in a range of about 2.5 to about 2000 mJ.

16. The method of claim 15, wherein the delivered energy is varied as a gradient across the array of halide perovskite particles.

17. The method of any one of the preceding claims, wherein the laser has a wavelength from about 300 nm to about 700 nm.

18. The method of claim 17, wherein the wavelength is 473 nm.

19. A mixed halide perovskite crystal having a lateral heterostructure and being of formula I:
A′₁₋ₓA″ₓBX₃,
wherein
A′ is a first cation,
A″ is a second cation, wherein A′ and A″ are different cations,
B is a metal,
X is at least one halogen,
0<x<1, and
the lateral heterostructure comprises an A′ rich phase in a central region of the crystal, surrounded partially by an A″ rich phase.

20. The mixed halide perovskite of claim 19, wherein A′ and A″ are independently selected from methylammonium, dimethylammonium, ethylammonium, butylammonium, formamidinium, phenethylamine, and cesium.

21. The mixed halide perovskite of claim 20, wherein A′ is cesium and A″ is formamidinium with a ratio A′/A″=1.

22. The mixed halide perovskite any one of claims 19 to 21, wherein X is one of Cl, Br, and I.

23. The mixed halide perovskite of any one of claims 19 to 21, wherein X is a combination of two or more anions selected from Cl, Br, and I.

24. The mixed halide of claim 23, comprising a first anion X and a second anion X″ present in a ration X′:X″=(1-y)/y, wherein 0<y<1.

25. The mixed halide perovskite of claim 23 or 24, wherein X is Br and I.

26. The mixed halide perovskite of claim 23 or 24, wherein X is Cl and Br.

27. The mixed halide perovskite of claim 23 or 24, wherein X is Cl, Br, and I.

28. The mixed halide perovskite of any one of claims 19 to 27, wherein B is selected from lead, tin, and/or germanium.

29. The mixed halide perovskite of any one of claims 19 to 28, wherein 0.25≤x≤0.75.

30. The mixed halide perovskite of any one of claims 19 to 29 comprising a crystal size of at least 60 nm.

31. The mixed halide perovskite of any one of claims 19 to 30, wherein the A″ rich phase surrounds a perimeter of the A′ rich phase, leaving at least a portion of the A′ rich phase exposed.

32. The mixed halide perovskite of any one of claims 19 to 31, wherein the X is Br and I, and the lateral heterostructure comprises an A′-Br rich phase in the center surrounded partially by an A″-I rich phase.

33. The mixed halide perovskite of any one of claims 19 to 32, wherein the mixed halide perovskite crystal is selected from Cs_{0.5}FA_{0.5}Pb(Cl_{0.5}Br_{0.5})₃, Cs_{0.5}FA_{0.5}PbBr₃, Cs_{0.5}FA_{0.5}Pb(C_{0.83}Br_{0.17})₃, Cs_{0.5}FA_{0.5}Pb(C_{0.33}Br_{0.66})₃, Cs_{0.5}FA_{0.5}Pb(Br_{0.9}I_{0.1})₃, Cs_{0.5}FA_{0.5}Pb(Br_{0.8}I_{0.2})₃, Cs_{0.5}FA_{0.5}Pb(Br_{0.66}I_{0.33})₃, Cs_{0.5}FA_{0.5}Pb(Br_{0.33}I_{0.66})₃, Cs_{0.5}FA_{0.5}Pb(Cl_{0.67}Br_{0.17}I_{0.1})₃, Cs_{0.5}FA_{0.5}Pb(C_{0.42}Br_{0.42}I_{0.1}7)₃).

34. A solid-solution mixed halide perovskite having the formula A′₁₋ₓA″ₓBX₃,
wherein
A′₁₋ₓA″ₓBX₃,
wherein
A′ is a first cation
A″ is a second cation, wherein A′ and A″ are different cations,
B is a metal
X is at least one halogen,
0<x<1, and wherein the crystal size is less than 60 nm.

35. A method of forming mixed halide perovskite crystals having a lateral heterostructure, comprising:
dissolving at least one first perovskite precursor having the formula A′X′, at least one second perovskite precursor having the formula A″X″ and at least one third perovskite precursor having the formula BX′₂, and at least one fourth perovskite precursor having the formula BX″₂ in a solvent to form a precursor solution, wherein A′ and A″ are each cations and are different cations, B is a metal, and X and X′ are each a halogen and can each be the same or different;
depositing the precursor solution onto a substrate; and
evaporating the solvent, wherein the halide perovskite crystals form upon evaporation of the solvent, wherein the crystals form as two stages, the first stage being a A′-X′-rich perovskite phase and the second stage being a A″-X″-rich perovskite phase partially surrounding the A′-X′-rich perovskite phase to thereby form the mixed halide perovskite having a lateral heterostructure and being of formula I
A′₁₋ₓA″ₓBX₃,
wherein
A′ is a first cation
A″ is a second cation, wherein A′ and A″ are different cations,
B is a metal
X is at least one halogen,
0<x<1.

36. A method of forming mixed halide perovskite crystal array having a plurality of halide perovskite crystals arranged in a pattern, comprising:
coating an array of pens with a precursor solution comprising at least one first perovskite precursor having the formula A′X′, at least one second perovskite precursor having the formula A″X″, at least one third perovskite precursor having the formula BX′₂ dissolved in a solvent, and at least one fourth perovskite precursor having the formula BX″₂ wherein A′ and A″ are each cations and are different cations, B is a metal, and X and X′ are each a halogen and can each be the same or different;
contacting a substrate with the coated pen array to thereby deposit the precursor solution as a pattern of printed indicia on the substrate, wherein:
the printed indicia form nanoreactors on the substrate and a mixed halide perovskite crystal nucleates and grows within each nanoreactor in two stages, the first stage being a A′-X′-rich perovskite phase and the second stage being a A″-X″-rich perovskite phase partially surrounding the A′-X′-rich perovskite phase to thereby form the mixed halide perovskite having a lateral heterostructure and being of formula I
A′₁₋ₓA″ₓBX₃,
wherein
A′ is a first cation
A″ is a second cation, wherein A′ and A″ are different cations,
B is a metal
X is at least one halogen defined by selection of X′, X″, and X′″,
0<x<1.

37. The method of claim 35 or 36, wherein X′, X″, and X′″ are the same halogen.

38. The method of claim 35 or 36, wherein X′. X″, X′″ are different halogens and the at least one third precursor comprises a precursor of formula BX′, a precursor of formula BX″ and a precursor of formular BX′″.

39. The method of any one of claims 35 to 38, wherein the solvent comprises one or more of dimethyformamide (DMF), dimethyl sulfoxide (DMSO), y-butyrolactone (GBL), and sulfolane.

40. The method of claim 39, wherein the solvent comprises dimethyl sulfoxide (DMSO) and sulfolane.

41. A combinatorial library of mixed halide perovskite crystals, comprising a patterned array of a plurality of the mixed halide perovskite crystals of claim 19.

42. The combinatorial library of claim 41, wherein the single crystal halide perovskite heterostructure crystals have a crystal size of about 60 nm to about 5000 nm.

43. The combinatorial library of claim 41 or 42, wherein the plurality of mixed halide perovskite crystals has a gradient of crystal size, wherein the gradient is present in a defined gradient pattern across the patterned array.

44. The combinatorial library of any one of claims 41 to 43, wherein the plurality of mixed halide perovskite crystals comprises at least first and second mixed halide perovskite crystals, wherein the first and second halide perovskite crystals are arranged in a defined pattern with respect to one another.

45. The combinatorial library of claim 44, wherein the first and second mixed halide perovskite crystals differ in one or more of size, geometry, and composition.

46. The combinatorial library of any one of claims 41 to 44, wherein the plurality of mixed halide perovskite crystals comprises at least first, second, and third mixed halide perovskite crystals arranged in a defined pattern with respect to one another.
